(19) United States
(12) Patent Application Publication
(10) Pub. No.: US 2025/0261652 A1
(43) Pub. Date: Aug. 21, 2025

(54) TURF GRASS TREATMENT COMPOSITIONS AND METHODS OF PROMOTING OR ENHANCING BIOENZYME ACTIVITY AND BIOENZYME PRODUCTION IN TURF GRASS, AND ENHANCING QUALITY OF TURF GRASS

(71) Applicant: AQUATROLS CORPORATION OF AMERICA, PAULSBORO, NJ (US)

(72) Inventors: Casey Edward McDonald, Delaware, OH (US); Arianna Lubomyra Watters, Philadelphia, PA (US); Emma Catherine Beggs, Merseyside (GB); Darryl Ramoutar, Delaware, OH (US)

(73) Assignee: AQUATROLS CORPORATION OF AMERICA, PAULSBORO, NJ (US)

(21) Appl. No.: 19/056,889

(22) Filed: Feb. 19, 2025

Related U.S. Application Data
(60) Provisional application No. 63/555,564, filed on Feb. 20, 2024.

(51) Int. Cl. A01N 65/03; A01N 25/02; A01N 25/30; A01P 21/00

(52) U.S. Cl. CPC A01N 65/03; A01N 25/02; A01N 25/30; A01P 21/00

(57) ABSTRACT

This disclosure provides turf grass treatment compositions having at least one biosurfactant; or at least two biosurfactants; or at least one biosurfactant and at least one plant health component; or at least one biosurfactant and at least one synthetic surfactant; or at least one biosurfactant, at least one plant health component, and at least one synthetic surfactant. The turf grass treatment compositions, when applied to turf grass, or to roots of the turf grass, or to soil in which the turf grass grows, are effective for promoting or enhancing at least one of bioenzyme activity and bioenzyme production in the turf grass, and/or are effective for enhancing quality of the turf grass. This disclosure also provides synergistic turf grass treatment compositions. This disclosure further provides methods of promoting and/or enhancing bioenzyme activity and bioenzyme production in turf grass, and/or enhancing quality of turf grass, by applying to the turf grass, or to roots of the turf grass, or to soil in which the turf grass grows, the turf grass treatment composition or synergistic turf grass treatment composition.

### RELATED APPLICATION

This application claims the benefit of copending U.S. Application No. 63/555,564, filed Feb. 20, 2024, which is incorporated herein by reference in its entirety.

### BACKGROUND OF THE DISCLOSURE

### 1. Field of the Disclosure

This disclosure relates to turf grass treatment compositions, including synergistic turf grass treatment compositions, having at least one biosurfactant; or at least two biosurfactants; or at least one biosurfactant and at least one plant health component; or at least one biosurfactant and at least one synthetic surfactant; or at least one biosurfactant, at least one plant health component, and at least one synthetic surfactant. This disclosure also relates to methods of promoting and/or enhancing bioenzyme activity and bioenzyme production in turf grass, and/or enhancing quality of turf grass, by applying to the turf grass, or to roots of the turf grass, or to soil in which the turf grass grows, the turf grass treatment composition.

### 2. Description of the Related Art

A wide variety of athletic, recreational, entertainment, commercial and residential venues utilize fields planted with turf grasses. Turf grasses, such as Kentucky bluegrass, Bent grass and Bermuda grass, are narrow-leaved grass species that grow and form a uniform ground cover. These species can typically tolerate being treaded on and being pruned or mowed to heights of, for example, a few inches or less.

The structure of turf grasses makes them ideal plants for athletics and recreation. The plants form horizontal stems, called stolons and rhizomes, that creep laterally above and below the ground, sprouting new plants and roots as they grow. Additionally, the lateral growth allows for cutting the grass as sod and rolling or stacking it so that it can be transported with ease.

An important turf grass quality is the ability of turf grass to withstand the negative effects of stress factors (e.g., droughts). Other important turf grass qualities include, for example, dense root structure and growth, nutrient use efficiency, water use efficiency, stress tolerance, and disease tolerance. Initial water uptake or wetting, rewetting and water retention over time are important qualities for a healthy turf grass.

Agricultural and horticultural compositions are typically used by farmers, gardeners, groundskeepers, etc. to maintain or improve plant health. The agricultural and horticultural compositions typically include active chemical ingredients and surfactants. Surfactants enable formulations to adhere to target surfaces and spread over a large area, facilitating wetting and movement of water. In spite of the known roles of surfactants in agricultural and horticultural formulations, fundamental surfactant studies in formulation preparation and optimization of biological efficacy are, to date, far from satisfactory.

In agricultural and horticultural formulations, a surfactant is crucial to enhance and optimize biological efficacy. However, such is an oversimplification. Selection of surfactant in an agricultural or horticultural formulation is critical because of the number of functions that must be performed. Moreover, due to the complex nature and lack of understanding of the mode of action of the active chemical, surfactant selection is often made by a trial and error procedures from an infinite number of possibilities, without predictability.

In agricultural and horticultural formulations, the vast majority of commercially available surfactants are synthetic products. There is a need for an eco-friendly biosurfactant product for agricultural and horticultural formulations that is comparable or better in performance to synthetic counterpart products, and to current organic options.

Bioenzymes are proteins with catalytic capabilities crucial to perform different processes in plants. Metabolic processes and other chemical reactions in the plant cell are carried out by a set of bioenzymes that are necessary to sustain life. Stress factors can disrupt metabolic processes and other chemical reactions in the plant cell. Bioenzymes in plant cells are crucial for enhancing and optimizing biological efficacy.

There is a need for eco-friendly biosurfactant-containing compositions that can enhance turf grass quality, especially stress tolerance or the ability of turf grass to withstand the negative effects of stress factors. In particular, there is a need for eco-friendly biosurfactant-containing compositions that are capable of promoting or enhancing bioenzyme activity and bioenzyme production in turf grass, thereby enhancing and optimizing biological efficacy in turf grass, and quality of turf grass, and withstand the negative effects of stress factors.

The present disclosure provides many advantages, including access to novel and exciting turf grass treatment compositions, which shall become apparent as described below.

### SUMMARY OF THE DISCLOSURE

This disclosure relates to turf grass treatment compositions having at least one biosurfactant; or at least two biosurfactants; or at least one biosurfactant and at least one plant health component; or at least one biosurfactant and at least one synthetic surfactant; or at least one biosurfactant, at least one plant health component, and at least one synthetic surfactant. The turf grass treatment compositions, when applied to turf grass, or to roots of the turf grass, or to soil in which the turf grass grows, are effective for promoting and/or enhancing at least one of bioenzyme activity and bioenzyme production in the turf grass, and are effective for enhancing quality of the turf grass. This disclosure also relates to synergistic turf grass treatment compositions. This disclosure further relates to methods of promoting and/or enhancing bioenzyme activity and bioenzyme production in turf grass, and enhancing quality of turf grass, by applying to the turf grass, or to roots of the turf grass, or to soil in which the turf grass grows, the turf grass treatment composition or synergistic turf grass treatment composition.

This disclosure also relates in part to a turf grass treatment composition having at least one biosurfactant. The turf grass treatment composition, when applied to turf grass, or to roots of the turf grass, or to soil in which the turf grass grows, is effective for promoting or enhancing at least one of bioenzyme activity and bioenzyme production in the turf grass.

This disclosure further relates in part to a method of promoting or enhancing at least one of bioenzyme activity and bioenzyme production in turf grass. The method involves applying to the turf grass, or to roots of the turf grass, or to soil in which the turf grass grows, a composition having at least one biosurfactant. The composition, when applied to turf grass, or to roots of the turf grass, or to soil in which the turf grass grows, is effective for promoting or enhancing at least one of bioenzyme activity and bioenzyme production in the turf grass.

This disclosure yet further relates in part to a turf grass treatment composition having at least two biosurfactants. The turf grass treatment composition, when applied to turf grass, or to roots of the turf grass, or to soil in which the turf grass grows, is effective for promoting or enhancing quality of the turf grass. In a preferred embodiment, the turf grass treatment composition, when applied to turf grass, or to roots of the turf grass, or to soil in which the turf grass grows, is effective for promoting or enhancing at least one of bioenzyme activity and bioenzyme production in the turf grass.

This disclosure also relates in part to a synergistic turf grass treatment composition having a synergistic combination of two or more biosurfactants. The synergistic combination of two or more biosurfactants, when applied to turf grass, or to roots of the turf grass, or to soil in which the turf grass grows, produces a combined promoting or enhancing effect of at least one of bioenzyme activity and bioenzyme production in the turf grass, greater than the sum of the separate promoting or enhancing effects of at least one of bioenzyme activity and bioenzyme production in the turf grass, at essentially the same concentrations.

This disclosure further relates in part to a method of promoting or enhancing quality of turf grass, said method comprising: applying to the turf grass, or to roots of the turf grass, or to soil in which the turf grass grows, a composition having at least two biosurfactants. The composition, when applied to turf grass, or to roots of the turf grass, or to soil in which the turf grass grows, is effective for promoting or enhancing quality of the turf grass. In a preferred embodiment, the composition, when applied to turf grass, or to roots of the turf grass, or to soil in which the turf grass grows, is effective for promoting or enhancing at least one of bioenzyme activity and bioenzyme production in the turf grass.

This disclosure yet further relates in part to a turf grass treatment composition having at least one biosurfactant and at least one plant health component. The turf grass treatment composition, when applied to turf grass, or to roots of the turf grass, or to soil in which the turf grass grows, is effective for promoting or enhancing quality of the turf grass. In a preferred embodiment, the turf grass treatment composition, when applied to turf grass, or to roots of the turf grass, or to soil in which the turf grass grows, is effective for promoting or enhancing at least one of bioenzyme activity and bioenzyme production in the turf grass.

This disclosure also relates in part to a synergistic turf grass treatment composition having a synergistic combination of at least one biosurfactant and at least one plant health component. The synergistic combination of at least one biosurfactant and at least one plant health component, when applied to turf grass, or to roots of the turf grass, or to soil in which the turf grass grows, produces a combined turf grass quality effect, greater than the sum of the separate turf grass quality effects, at essentially the same concentrations. The turf grass quality effects include, for example, enhancing root structure and growth, nutrient use efficiency, water use efficiency, stress tolerance, disease tolerance, and/or inducing systemic resistance. In a preferred embodiment, the synergistic combination of at least one biosurfactant and at least one plant health component, when applied to turf grass, or to roots of the turf grass, or to soil in which the turf grass grows, produces a combined promoting or enhancing effect of at least one of bioenzyme activity and bioenzyme production in the turf grass, greater than the sum of the separate promoting or enhancing effects of at least one of bioenzyme activity and bioenzyme production in the turf grass, at essentially the same concentrations.

This disclosure further relates in part to a method of promoting or enhancing quality of turf grass. The method involves applying to the turf grass, or to roots of the turf grass, or to soil in which the turf grass grows, a composition having at least one biosurfactant and at least one plant health component. The composition, when applied to turf grass, or to roots of the turf grass, or to soil in which the turf grass grows, is effective for promoting or enhancing quality of the turf grass. In a preferred embodiment, the composition, when applied to turf grass, or to roots of the turf grass, or to soil in which the turf grass grows, is effective for promoting or enhancing at least one of bioenzyme activity and bioenzyme production in the turf grass.

This disclosure yet further relates in part to a turf grass treatment composition having at least one biosurfactant and at least one synthetic surfactant. The turf grass treatment composition, when applied to turf grass, or to roots of the turf grass, or to soil in which the turf grass grows, is effective for promoting or enhancing quality of the turf grass. In a preferred embodiment, the turf grass treatment composition, when applied to turf grass, or to roots of the turf grass, or to soil in which the turf grass grows, is effective for promoting or enhancing at least one of bioenzyme activity and bioenzyme production in the turf grass.

This disclosure also relates in part to a synergistic turf grass treatment composition having a synergistic combination of at least one biosurfactant and at least one synthetic surfactant. The synergistic combination of at least one biosurfactant and at least one synthetic surfactant, when applied to turf grass, or to roots of the turf grass, or to soil in which the turf grass grows, produces a combined turf grass quality effect, greater than the sum of the separate turf grass quality effects, at essentially the same concentrations. The turf grass quality effects include, for example, enhancing root structure and growth, nutrient use efficiency, water use efficiency, stress tolerance, disease tolerance, and/or inducing systemic resistance. In a preferred embodiment, the synergistic combination of at least one biosurfactant and at least one synthetic surfactant, when applied to turf grass, or to roots of the turf grass, or to soil in which the turf grass grows, produces a combined promoting or enhancing effect of at least one of bioenzyme activity and bioenzyme production in the turf grass, greater than the sum of the separate promoting or enhancing effects of at least one of bioenzyme activity and bioenzyme production in the turf grass, at essentially the same concentrations.

This disclosure further relates in part to a method of promoting or enhancing quality of turf grass. The method involves applying to the turf grass, or to roots of the turf grass, or to soil in which the turf grass grows, a composition having at least one biosurfactant and at least one synthetic surfactant. The composition, when applied to turf grass, or to roots of the turf grass, or to soil in which the turf grass grows, is effective for promoting or enhancing quality of the turf grass. In a preferred embodiment, the composition, when applied to turf grass, or to roots of the turf grass, or to soil in which the turf grass grows, is effective for promoting or enhancing at least one of bioenzyme activity and bioenzyme production in the turf grass.

This disclosure yet further relates in part to a turf grass treatment composition having at least one biosurfactant, at least one plant health component, and at least one synthetic surfactant. The turf grass treatment composition, when applied to turf grass, or to roots of the turf grass, or to soil in which the turf grass grows, is effective for promoting or enhancing quality of the turf grass. In a preferred embodiment, the turf grass treatment composition, when applied to turf grass, or to roots of the turf grass, or to soil in which the turf grass grows, is effective for promoting or enhancing at least one of bioenzyme activity and bioenzyme production in the turf grass.

This disclosure also relates in part to a synergistic turf grass treatment composition having a synergistic combination of at least one biosurfactant, at least one plant health component, and at least one synthetic surfactant. The synergistic combination of at least one biosurfactant, at least one plant health component, and at least one synthetic surfactant, when applied to turf grass, or to roots of the turf grass, or to soil in which the turf grass grows, produces a combined turf grass quality effect, greater than the sum of the separate turf grass quality effects, at essentially the same concentrations. The turf grass quality effects include, for example, enhancing root structure and growth, nutrient use efficiency, water use efficiency, stress tolerance, disease tolerance, and/or inducing systemic resistance. In a preferred embodiment, the synergistic combination of at least one biosurfactant, at least one plant health component, and at least one synthetic surfactant, when applied to turf grass, or to roots of the turf grass, or to soil in which the turf grass grows, produces a combined promoting or enhancing effect of at least one of bioenzyme activity and bioenzyme production in the turf grass, greater than the sum of the separate promoting or enhancing effects of at least one of bioenzyme activity and bioenzyme production in the turf grass, at essentially the same concentrations.

This disclosure further relates in part to a method of promoting or enhancing quality of turf grass. The method involves applying to the turf grass, or to roots of the turf grass, or to soil in which the turf grass grows, a composition having at least one biosurfactant, at least one plant health component, and at least one synthetic surfactant. The composition, when applied to turf grass, or to roots of the turf grass, or to soil in which the turf grass grows, is effective for promoting or enhancing quality of the turf grass. In a preferred embodiment, the composition, when applied to turf grass, or to roots of the turf grass, or to soil in which the turf grass grows, is effective for promoting or enhancing at least one of bioenzyme activity and bioenzyme production in the turf grass.

Further objects, features and advantages of the present disclosure will be understood by reference to the following detailed description.

### BRIEF DESCRIPTION OF THE DRAWINGS

FIG. 1 graphically depicts the effects of formulations on turf quality in creeping bentgrass under drought stress and post-drought recovery conditions, in accordance with the Examples.

FIG. 2 graphically depicts the effects of formulations on turf quality in creeping bentgrass under drought stress and post-drought recovery conditions, in accordance with the Examples.

FIG. 3 graphically depicts the effects of formulations on leaf color in creeping bentgrass under drought stress and post-drought recovery conditions, in accordance with the Examples.

FIG. 4 graphically depicts the effects of formulations on leaf color in creeping bentgrass under drought stress and post-drought recovery conditions, in accordance with the Examples.

FIG. 5 graphically depicts the effects of formulations on normalized difference vegetation index (NDVI) in creeping bentgrass under drought stress and post-drought recovery conditions, in accordance with the Examples.

FIG. 6 graphically depicts the effects of formulations on normalized difference vegetation index (NDVI) in creeping bentgrass under drought stress and post-drought recovery conditions, in accordance with the Examples.

FIG. 7 graphically depicts the effects of formulations on leaf antioxidant superoxide dismutase activity (SOD) in creeping bentgrass under drought stress and post-drought recovery conditions, in accordance with the Examples.

FIG. 8 graphically depicts the effects of formulations on leaf antioxidant superoxide dismutase activity (SOD) in creeping bentgrass under drought stress and post-drought recovery conditions, in accordance with the Examples.

FIG. 9 graphically depicts the effects of formulations on volumetric water content (VWC) in creeping bentgrass under drought stress and post-drought recovery conditions, in accordance with the Examples.

FIG. 10 graphically depicts the effects of formulations on volumetric water content (VWC) in creeping bentgrass under drought stress and post-drought recovery conditions, in accordance with the Examples.

FIG. 11 graphically depicts the effects of formulations on leaf abscisic acid in creeping bentgrass under drought stress and post-drought recovery conditions, in accordance with the Examples.

FIG. 12 graphically depicts the effects of formulations on leaf abscisic acid in creeping bentgrass under drought stress and post-drought recovery conditions, in accordance with the Examples.

FIG. 13 graphically depicts the effects of formulations on leaf cytokinin (cis-zeatin riboside) in creeping bentgrass under drought stress and post-drought recovery conditions, in accordance with the Examples.

FIG. 14 graphically depicts the effects of formulations on leaf cytokinin (cis-zeatin riboside) in creeping bentgrass under drought stress and post-drought recovery conditions, in accordance with the Examples.

### DESCRIPTION OF THE PREFERRED EMBODIMENTS

The turf grass treatment compositions of this disclosure are microbe-based compositions.

As used herein, a “microbe-based composition,” means a composition that comprises components that were produced as the result of the growth of microorganisms or other cell cultures. A microbe-based composition may comprise the microbes themselves and/or byproducts of microbial growth. The microbes may be in a vegetative state, in spore or conidia form, in hyphae form, in any other form of propagule, or a mixture of these. The microbes may be planktonic or in a biofilm form, or a mixture of both. The byproducts of growth may be, for example, metabolites, cell membrane components, expressed proteins, and/or other cellular components. The microbes may be intact or lysed. In an embodiment, the microbes are present, with growth medium in which they were grown, in the microbe-based composition. The microbes may be present at, for example, a concentration of at least 1×10⁴, 1×10⁵, 1×10⁶, 1×10⁷, 1×10⁸, 1×10⁹, 1×10¹⁰, 1×10¹¹, 1×10¹² or 1×10¹³ or more CFU per gram or per ml of the composition. In an embodiment, the turf grass treatment compositions of this disclosure can include about 0.1 to about 20% of the total composition by weight, or about 0.5 to 15%, or about 1 to about 12%.

This disclosure relates to turf grass treatment compositions which, when applied to turf grass, or to roots of the turf grass, or to soil in which the turf grass grows, are effective for promoting or enhancing quality of the turf grass, including promoting or enhancing bioenzyme activity and/or bioenzyme production in the turf grass.

In an embodiment, this disclosure relates to quality, care, and maintenance of turf grasses in, for example, athletics and recreational settings. More specifically, this disclosure provides methods for enhancing the quality of turf grass, and promoting or enhancing bioenzyme activity and/or bioenzyme production in the turf grass. Advantageously, the methods are low-cost, utilize non-toxic substances, and can be implemented with ease by grounds-keeping employees with minimal additional training.

Turf grass treatment compositional features and benefits include, for example, promotion or enhancement of bioenzyme activity and bioenzyme production in the turf grass, dual-action surfactant blend engineered to improve water infiltration and balanced hydration, turf grass health benefits, improved stress tolerance and turf grass quality, excellent localized dry spot (LDS) prevention, low spray volume ideal for broad acre applications, and/or outstanding dew suppression.

The concentration and ratio of ingredients in the turf grass treatment composition can be determined according to, for example, the species of turf grass being treated, the soil type where the turf grass is growing, the health of the turf grass at the time of treatment, as well as other factors. Thus, the turf grass treatment composition can be customizable for any given turf grass field.

### Bioenzyme(s)

The turf grass treatment compositions of this disclosure, when applied to turf grass, or to roots of the turf grass, or to soil in which the turf grass grows, are effective for promoting or enhancing bioenzyme activity and/or bioenzyme production in the turf grass. The majority of bioenzymes are proteins with catalytic capabilities crucial to perform different processes in plants including turf grass. Metabolic processes and other chemical reactions in the plant cell are carried out by a set of bioenzymes that are necessary to sustain life. Bioenzymes in plant cells are crucial for enhancing and optimizing biological efficacy.

Bioenzymes can be classified based on the type of reaction in which they are used to catalyze. Illustrative classes of bioenzymes include hydrolases, oxidoreductases, lyases, transferases, ligases, isomerases, and the like.

Oxidoreductases catalyze the oxidation reaction where the electrons tend to travel from one form of a molecule to the other. Oxidoreductases catalyze oxidation and reduction reactions, e.g. pyruvate dehydrogenase, catalyzing the oxidation of pyruvate to acetyl coenzyme A. The enzyme protochlorophyllide oxidoreductase has a key role in plant and turf grass development. It catalyzes one of the later steps in chlorophyll synthesis, the light-induced reduction of protochlorophyllide into chlorophyllide in the presence of NADPH.

Transferases help in the transportation of the functional group among acceptors and donor molecules. Transferases catalyze transferring of the chemical group from one to another compound. An example is a transaminase, which transfers an amino group from one molecule to another. The glutathione transferases (GSTs; also known as glutathione S-transferases) are major phase II detoxification enzymes found mainly in the cytosol. In addition to their role in catalyzing the conjugation of electrophilic substrates to glutathione (GSH), these enzymes also carry out a range of other functions.

Hydrolases are hydrolytic enzymes, which catalyze the hydrolysis reaction by adding water to cleave the bond and hydrolyze it. Hydrolases catalyze the hydrolysis of a bond. For example, the enzyme pepsin hydrolyzes peptide bonds in proteins. Plant glycoside hydrolases are involved in cell wall polysaccharide metabolism. Other functions include their participation in the biosynthesis and remodulation of glycans, mobilization of energy, defense, symbiosis, signaling, secondary plant metabolism and metabolism of glycolipids.

Lyases add water, carbon dioxide or ammonia across double bonds or eliminate these to create double bonds. Lyases catalyze the breakage of bonds without catalysis, e.g. aldolase (an enzyme in glycolysis) catalyzes the splitting of fructose-1, 6-bisphosphate to glyceraldehyde-3-phosphate and dihydroxyacetone phosphate. They are a major contributor to the properties of plant, including turf grass, structure and act as barriers against pathogens. The primary cell walls of plants are composed of polysaccharides and proteins.

Isomerases catalyze the structural shifts present in a molecule, thus causing the change in the shape of the molecule. Isomerases catalyze the formation of an isomer of a compound. For example, phosphoglucomutase catalyzes the conversion of glucose-1-phosphate to glucose-6-phosphate (phosphate group is transferred from one to another position in the same compound) in glycogenolysis (glycogen is converted to glucose for energy to be released quickly). As an enzyme, chalcone isomerase acts as a catalyst to accelerate chemical reactions in plants including turf grass. It also helps to ensure the chemicals that are made in the plant are the proper form, since molecules with the same chemical formula can take two different variations that are mirror images of each other (called isomers).

Ligases are known to charge the catalysis of a ligation process. Ligases catalyze the association of two molecules. For example, DNA ligase catalyzes the joining of two fragments of DNA by forming a phosphodiester bond. In plants, E3 ubiquitin ligases are well-known to fulfill unique roles as central regulators of phytohormone signaling, including hormone perception and regulation of hormone biosynthesis. In plants, the E3 ligases can be classified into four main types: HECT (homologous to the E6-AP carboxyl terminus); RING; U-box; and cullin-RING ligases (CRLs). The HECT, RING and U-box E3 ligases are single polypeptides, whereas the CRLs consist of multiple subunits.

Cofactors are non-proteinous substances that associate with bioenzymes. A cofactor can be important for the functioning of a bioenzyme. There are three kinds of cofactors present in enzymes, namely, prosthetic groups, coenzymes, and metal ions. Prosthetic groups are cofactors tightly bound to an enzyme at all times. FAD (flavin adenine dinucleotide) is a prosthetic group present in many enzymes. Coenzymes bind to an enzyme only during catalysis. At all other times, it is detached from the enzyme. For the catalysis of certain enzymes, a metal ion is required at the active site to form coordinate bonds. Zinc is a metal ion cofactor used by a number of enzymes. An adequate supply of cofactors in plants including turf grass directly affects their development, metabolism, and stress responses.

### Biosurfactant(s)

The turf grass treatment compositions of this disclosure includes at least one biosurfactant, or at least two biosurfactants. The biosurfactant is a growth byproduct of a microorganism. The microorganism can be a genetically-modified (GM) microorganism or a non-genetically (non-GM) modified microorganism. The microorganism is selected from bacteria, yeast, and fungi.

The biosurfactant is a growth byproduct of a microorganism. Illustrative microorganisms include, for example, Starmerella sp., Pichia sp., Pseudomonas sp. (P. aeruginosa, P. putida, P. florescens, P. Tragi, P. syringae); Flavobacterium spp.; Bacillus spp. (B. subtilis, B. pumillus, B. cereus, B. licheniformis); Candida species (C. albicans, C. rugosa, C. tropicalis, C. lipolytica, C. torulopsis); Rhodococcus sp.; Arthrobacter spp.; campylobacter spp.; and cornybacterium spp.; and combinations thereof. The microorganism can be a genetically-modified (GM) microorganism or a non-genetically (non-GM) modified microorganism.

The microorganisms can be produced by a production or cultivation process selected from the group consisting of submerged cultivation/fermentation, surface cultivation, solid state fermentation, and combinations thereof. The production or cultivation process can be carried out under aerobic or anaerobic conditions. The production or cultivation process utilizes food/energy source(s) for microorganism growth.

Illustrative food/energy source(s) include, for example, carbon sources including carbohydrates, alcohols, organic acids, fats, and oils; and combinations thereof; agro-industrial wastes, vegetable oil mill effluents including coconut oil, canola oil, olive oil, grape seed oil, palm oil, rapeseed oil, sunflower oil, soybean oil; dairy and sugar industry byproducts including buttermilk, whey, molasses; starch industry extract and wastes including corn, potatoes, tapioca, wheat. The food/energy source(s) can be genetically-modified (GM) or non-genetically (non-GM) modified.

The microorganism is selected from bacteria, yeast, and fungi. Illustrative bacteria include, for example, Pseudomonas sp., Pseudomonas guguanensis, Pseudomonas putida, Pseudomonas aeruginosa, Pseudomonas fluorescens, Pseudomonas aeruginosa, Pseudomonas aeruginosa, Pseudomonas stutzeri; and combinations thereof. The bacteria can be a genetically-modified (GM) bacteria or a non-genetically (non-GM) modified bacteria.

Other illustrative bacteria include, for example, Bacillus sp., Bacillus subtilis,; Bacillus sphaericus, Bacillus azotoformans,; Bacillus subtilis, Bacillus sp., Bacillus subtilis, Bacillus licheniformis, Bacillus subtilis,; Bacillus subtilis; and combinations thereof. The bacteria can be a genetically-modified (GM) bacteria or a non-genetically (non-GM) modified bacteria.

Still other illustrative bacteria include, for example, Bordetella hinzii; Klebsiella pneumoniae; Ochrobactrum anthropi, Citrobacter freundii; Pseudoxanthomonas sp., Nocardia otitidiscaviarum; Serratia marcescens, Stenotrophomonas maltophilia; Virgibacillus salarius, Stenotrophomonas sp., Aeromonas salmonicida; Gordonia polyisoprenivorans; Burkholderia thailandensis, Pseudoxanthomonas sp., Ralstonia pickettii, Alcaligenes piechaudii; Gordonia sp.; and combinations thereof. The bacteria can be a genetically-modified (GM) bacteria or a non-genetically (non-GM) modified bacteria.

Illustrative yeast include, for example, Cryptococcus curvatus; Pichia anomala, Starmerella bombicola, Candida bombicola, Candida lipolytica; Candida lipolytica; Candida antarctica, Ustilago scitaminea, Pseudozyma tsukubaensis, Pseudozyma fusifornata, Pseudozyma parantarctica, Pseudozyma aphidis, Kluyveromyces marxianus, Kurtzmanomyces sp., Pseudozyma siamensis,; Wickerhamomyces anomalus, Candida antarctica, Candida apicola; and combinations thereof. The yeast can be a genetically-modified (GM) yeast or a non-genetically (non-GM) modified yeast.

Illustrative fungi include, for example, filamentous fungi such as Penicillium citrinum; Aspergillus flavus; Penicillium chrysogenum, Fusarium sp.; Fusarium oxysporum; Cunninghamella echinulate; and combinations thereof. The fungi arecan be genetically-modified (GM) fungi or non-genetically (non-GM) modified fungi.

In accordance with this disclosure, a biosurfactant is a generally low molecular weight microbial product having effective surface activity. This includes lowering the surface and interfacial tension between different phases. For example, the phases include between two liquids, between a gas and a liquid, or between a liquid and a solid.

Advantageously, bacteria, yeasts, and fungi can be induced to produce biosurfactants. The bacteria, yeasts, and fungi can be genetically-modified (GM) or non-genetically-modified (non-GM).

As used herein, “biosurfactant” means a surfactant that exists in nature, or is produced by biological processes without any external inputs, or is produced by genetically-modified (GM) biological processes or non-genetically-modified (non-GM) biological processes. The biosurfactants used in the turf grass treatment compositions of this disclosure can be genetically-modified (GM) or non-genetically-modified (non-GM).

In an embodiment, the biosurfactant is selected from glycolipids, lipopeptides, phospholipids, fatty acids, polymeric surfactants, particulate surfactants, and combinations thereof. Preferred biosurfactants are glycolipids.

Glycolipids are lipids with a carbohydrate attached by a glycosidic bond. Illustrative glycolipids include rhamnolipid, sophorolipid, mannosylerythritol lipid, and trehalose lipid. A preferred glycolipid is rhamnolipid.

Rhamnolipid biosurfactants are naturally occurring extracellular glycolipids that are found in soil and on plants. Rhamnolipid biosurfactants contain rhamnose as the sugar moiety (hydrophilic) linked to beta-hydroxylated fatty acid chains (hydrophobic).

Rhamnolipid biosurfactants can be produced through microbial fermentation process of soy. Pseudomonas aeruginosa is the most competent microbe that can be induced to produce rhamnolipids. Rhamnolipid biosurfactant is recovered from the fermentation broth after sterilization and centrifugation, then purified to various levels to fit intended applications.

Sophorolipid biosurfactants are surface-active glycolipids that contain glucose-derived di-saccharide sophorose (hydrophilic) linked to fatty acid tail chain (hydrophobic).

Sophorolipid biosurfactants can be produced by a fermentation process of a number of non-pathogenic yeasts species, a gravity separation process, and an optional purification process.

The choice of yeast can influence distribution of lactone vs acidic forms of final molecule, and subsequently, performance. An example non-pathogenic yeast is candida apicola, among others.

Polymeric surfactants are defined by the repeating units in the chemical structure, considered a high-mass biosurfactants. Non-limiting examples of polymeric biosurfactants include Emulsan, Liposan, Lipomanan, Alasan, Biodispersan and the like.

Lipopeptides are molecules having a lipid and a peptide, and have the unique ability to self-assemble into various structures. Non-limiting examples of lipopeptides biosurfactants include Surfactin, Lichenysin, and the like.

Surfactin is a bacterial cyclic lipopeptide. Surfactin biosurfactant has seven amino acids bonded to the carboxyl and hydroxy groups of the 14th-carbon fatty acid.

Surfactin biosurfactant can be produced by a bacterial cyclic lipopeptide and is recognized as one of the most effective biosurfactants, decreasing surface tension of water at rates as low as <0.01%.

Surfactin biosurfactant can be produced by submerged or solid-state fermentation processes followed by purification processes including membrane-based techniques, foam fractionation, extraction, adsorption, liquid membrane extraction, and combinations thereof.

Microorganisms bacillus, Pseudomonas, or candida can be induced to produce Surfactin. Advantageously, microorganisms can be paired with reaction type to optimize Surfactin output.

Fatty acids are carboxylic acids with long aliphatic, or carbon-hydrogen chains. Most fatty acids that are naturally occurring have an aliphatic chain containing an even number of carbon atoms, usually less than or equal to 30 carbon atoms. Fatty acid type is defined by the number of carbon atoms, even vs. odd number of carbon atoms, and saturation. Unsaturated fatty acids contain a minimum of one carbon-carbon double bond, hence influencing the molecule's properties.

Particulate surfactants are produced by Acinetobactor calcoaceticus, cyanobacteria, or Pseudomonas marginalis, among others. Particulate biosurfactants are another example of a high-mass biosurfactant due to their membrane vesicle or whole-cell structure.

Phospholipids are molecules that contain a hydrophilic phosphate head attached to two hydrophobic lipid tails, and are naturally produced by Acinetobactor sp., Aspergillus, and Corynebacterium lepus, among others. Phospholipids are most commonly known to be a primary component of biological membranes.

In an embodiment, the biosurfactant is produced by mechanical and biological processes without any chemical reaction that alters a molecule of the biosurfactant. Alternatively, the biosurfactant is produced from genetically-modified (GM) microorganisms or non-genetically-modified (non-GM) microorganisms.

In an embodiment, the microorganisms and biosurfactants useful according to this disclosure can be, for example, non-plant-pathogenic strains of bacteria, yeast and/or fungi. These microorganisms may be natural or non-genetically modified, or genetically modified. The biosurfactants may be derived from natural or non-genetically modified, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In one embodiment, the microorganisms are capable of producing a biosurfactant. In another embodiment, biosurfactants can be produced separately by other microorganisms and added to the turf grass treatment composition, either in purified form or in crude form. Crude form biosurfactants can comprise, for example, biosurfactants and other products of cellular growth in the leftover fermentation medium resulting from cultivation of a biosurfactant-producing microbe. This crude form biosurfactant composition can comprise from about 0.001% to about 90%, about 25% to about 75%, about 30% to about 70%, about 35% to about 65%, about 40% to about 60%, about 45% to about 55%, or about 50% pure biosurfactant.

As amphiphilic molecules, microbial biosurfactants reduce the surface and interfacial tensions between the molecules of liquids, solids, and gases. Furthermore, the biosurfactants are biodegradable, have low toxicity, are effective in solubilizing and degrading insoluble compounds in turf grass and can be produced using low cost and renewable resources. They can inhibit adhesion of undesirable microorganisms to a variety of surfaces, prevent the formation of biofilms, and can have powerful emulsifying and demulsifying properties. Furthermore, the biosurfactants can be used to improve wettability and to achieve even solubilization and/or distribution of fertilizers, nutrients, and water in the turf grass.

The microorganisms useful in the turf grass treatment compositions may be in an active or inactive form, or in the form of vegetative cells, reproductive spores, mycelia, hyphae, conidia, or any other form of microbial propagule. The turf grass treatment composition may also contain a combination of any of these microbial forms.

While synthetic surfactants decrease surface tension, synthetic surfactants exhibit poor water uptake and water retention, particularly in turf grass treatment compositions as compared to biosurfactants in the turf grass treatment compositions of this disclosure.

In accordance with this disclosure, microbial biosurfactants, including glycolipids, polymeric surfactants, lipopeptides, fatty acids, particulate surfactants, phospholipids, and/or combinations thereof, exhibit superior performance in wettability and/or water retention, and other properties. These biosurfactants are readily soluble in water.

The biosurfactant can be in the form of a solid or a liquid.

In embodiments in which the biosurfactant is a solid, the solid optionally can be ground to a powder and directly mixed with the growing media at a selected application rate.

For example, the biosurfactant can be 100% glycolipid at 90% purity. The glycolipid can be rhamnolipid.

Additionally, the biosurfactant has a purity of at least 80%, at least 91%, at least 92%, at least 93%, and at least 95%. In yet other embodiments, glycolipid biosurfactant purity levels range from about 80% to about 98%, about 85 to about 96%, and about 92 to about 94%, including subranges therebetween. The glycolipid can be rhamnolipid.

The glycolipid can be solid rhamnolipid, which is a chunky dark red to brown material with irregular shaped granules up to approximately 5 mm diameter in size. By pulverization, a more uniform dispersion can be obtained.

In embodiments in which the biosurfactant is a liquid, the biosurfactant is prepared in a solution with water.

The liquid is at least about 18%, at least about 20%, at least about 22%, or at least about 24% glycolipid in solution with at least about 85%, about 90%, or about 95% purity. The glycolipid can be rhamnolipid.

The liquid can be between about 0.5% to about 50% biosurfactant in solution, preferably between about 10% to about 40%, and most preferably between about 18% to about 33%. In yet other embodiments, the liquid is between about 23% to about 27% biosurfactant in solution. The purity can be at least 80%, 81%, 82%, 83%, 84%, 85%, 86%, 87%, 88%, 89%, 90%, 91%, 92%, 93%, 94% or 95% purity.

The biosurfactant preferably has a purity of at least about 80% to about 95%. In yet other embodiments, glycolipid biosurfactant purity levels range between about 80% to 98%, preferably between about 85 to about 96%, and more preferably between about 92 to about 94%, including subranges therebetween. The glycolipid can be rhamnolipid.

Preferably, the concentration of biosurfactant in water is from about 0.1% by volume to about 50% by volume, more preferably from about 0.2% by volume to about 10% by volume, and most preferably from about 0.2% by volume to about 5% by volume.

The one or more biosurfactants are present in the turf grass treatment composition in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

### Plant Health Component(s)

The turf grass treatment compositions of this disclosure can include at least one plant health component.

In an embodiment, the plant health component is selected from biostimulants, bioenzymes, nutrient(s) for microorganism growth, nutrient(s) for plant growth, fertilizers, pesticides, herbicides, other microorganism based composition(s); and combinations thereof.

Illustrative biostimulants include, for example, plant hormones, microbes selected from bacteria, yeast, and fungi; humic substances, seaweed extracts, protein hydrolysates, chitosan, inorganic compounds, and metabolites.

Other illustrative biostimulants include, for example, humic substances, humins, fulvic acids, fatty acids/lipids, peptides, amino acids, organic acids, carboxyls, B vitamins, protein hydrolysates, plant growth promoting bacteria (PGPR), cytokinins, rhizobium, mycorrhizae, trichoderma, fungi, microbial complex communities/consortia, phytohormones, seaweed/kelp, laminarin, alginates, polysaccharides, polyphenols, botanicals, allelochemicals, organic matter extracts, chitin, chitosan, betaines, polyamines, inorganic salts, proteins, elements selected from silicon (Si), sodium (Na) and cobalt (Co), phosphites, nitrogeneous compounds, and enzymatic extracts.

Illustrative yeast or fungi include Aureobasidium (e.g., A. pullulans), Blakeslea, Candida (e.g., C. apicola, C. bombicola, C. nodaensis), Cryptococcus, Debaryomyces (e.g., D. hansenii), Entomophthora, Hanseniaspora, (e.g., H. uvarum), Hansenula, Issatchenkia, Kluyveromyces (e.g., K. phaffii), Mortierella, mycorrhizal fungi, Penicillium, Phycomyces, Pichia (e.g., P. anomala, P. guilliermondii, P. occidentalis, P. kudriavzevii), Pleurotus spp. (e.g., P. ostreatus), Pseudozyma (e.g., P. aphidis), Saccharomyces (e.g., S. boulardii sequela, S. cerevisiae, S. torula), Starmerella (e.g., S. bombicola), Torulopsis, Trichoderma (e.g., T. reesei, T. harzianum, T. hamatum, T. viride), Ustilago (e.g., U. maydis), Wickerhamomyces (e.g., W. anomalus), Williopsis (e.g., W. mrakii), and Zygosaccharomyces (e.g., Z. bailii).

Illustrative bacteria include Gram-positive and Gram-negative bacteria, rhizobacteria, Agrobacterium (e.g., A. radiobacter), Azotobacter (A. vinelandii, A. chroococcum), Azospirillum (e.g., A. brasiliensis), Bacillus (e.g., B. amyloliquifaciens, B. circulans, B. firmus, B. laterosporus, B. licheniformis, B. megaterium, Bacillus mucilaginosus, B. subtilis), Frateuria (e.g., F. aurantia), Microbacterium (e.g., M. laevaniformans), myxobacteria (e.g., Myxococcus xanthus, Stignatella aurantiaca, Sorangium cellulosum, Minicystis rosea), Pantoea (e.g., P. agglomerans), Pseudomonas (e.g., P. aeruginosa, P. chlororaphis subsp. aureofaciens (Kluyver), P. putida), Rhizobium spp., Rhodospirillum (e.g., R. rubrum), Sphingomonas (e.g., S. paucimobilis), and Thiobacillus thiooxidans (Acidothiobacillus thiooxidans).

As used herein, “biostimulants” are naturally-derived compounds that stimulate or accelerate turf grass growth when applied at low rates, and especially under stress conditions. Biostimulants include, but are not limited to, plant hormones, microbes (e.g., bacteria, yeast, and fungi), humic substances, seaweed extracts, protein hydrolysates, chitosan, inorganic compounds, and metabolites. Biostimulants do not include fertilizers, nutrients, or pesticides.

Biostimulants are based on natural raw materials, used in small amounts for the modification of physiological and biochemical plant processes that lead to the realization of genetic productive potential due to triggered hormonal changes, activation of metabolic processes, increase in efficiency of nutrition, stimulation of growth, development and strengthening the ability to withstand the negative effects of stress factors.

Biostimulants obtained from extracts and purified compounds of seaweed include, for example, the polysaccharides laminarin, alginates, and carrageenans, and their beakdown products; micro- and macronutrients; sterols; N-containing compounds such as betaines; and hormones. Seaweed extract hormones include, for example, auxins, cytokinins, gibberelins, abscisic acid, ethylene, elements (sodium (N), potassium (K), phosphorus (P), amino acids, micronutrients (Na, Ca, Fe, Mn, Zn, S, B, Mo, Cu).

The turf grass treatment compositions of this disclosure having at least one plant health component enable the turf grass treatment composition to enhance one or more qualities of turf grass.

Quality benefits of application of turf grass treatment compositions of this disclosure having seaweed extracts to turf grass include, for example, increased or enhanced: photosynthesis; photochemical activity; root enzyme activity; root mass; stress tolerance due to the production of superoxide dismutase enzymes; cytokinin activity under drying conditions to stimulate cell division; leaf moisture; α-tocopherol (vitamin E) and ascorbic acid (vitamin C) antioxidants found in chloroplasts; chlorophyll content; root length; shoot growth; phosphorus uptake; salt tolerance; leaf tissue nitrogen (N), phosphorus (P), potassium (K) and iron (Fe); soil moisture; and microbiome.

Quality benefits of application of turf grass treatment compositions of this disclosure having protein hydrolysates and amino acids to turf grass include, for example, the following: makes the nutrients far more recognizable to the turf grass; limits temperature stress, drought stress, heavy metal stress, and low mowing heights; amino acid proline scavenges hydroxyl radicals by increasing superoxide dismutase (SOD); protein biosynthesis improvement; increased chlorophyll content; increased germination; stimulate carbon and nitrogen metabolism; and stimulate turf grass microbiomes.

Quality benefits of application of turf grass treatment compositions of this disclosure having chitosan to turf grass include, for example, enhanced or increased: leaf count, amino acid proline scavenges hydroxyl radicals by increasing superoxide dismutase (SOD); proline dehydrogenase production/stress adaption; chlorophyll content; germination; and vertical leaf growth.

Quality benefits of application of turf grass treatment compositions of this disclosure having inorganic compounds (e.g., aluminum (Al), cobalt (Co), sodium (Na), selenium (Se), and silicon (Si)) to turf grass include, for example: strengthening of cell walls by silica deposits; promoting turf grass growth; inducing tolerance to abiotic stress (drought, salinity, cold stress); inducing cell wall rigidification, osmoregulation, reduced transpiration; influencing osmotic, pH, and redox homeostasis; influencing hormone signaling and enzymes involved in stress response; and present in soils and turf grass as different inorganic salts.

Quality benefits of application of turf grass treatment compositions of this disclosure having silicon (Si) to turf grass include, for example: defense against abiotic stress; leaf and stem strength through deposition in the cuticle; maintaining cell wall polysaccharide and lignin polymersproline; wear resistance; heat and drought stressed resistance; growth and establishment; water use efficiency; salt stress tolerance; leaf blade stiffness and better ball roll.

Quality benefits of application of turf grass treatment compositions of this disclosure having microbes, bacteria (e.g., rhizobacteria (RB)) and fungi (e.g., mycorrhizal fungi (MF)) to turf grass include, for example, enhanced or increased: uptake of other macro- and micronutrients (RB, MF); root mass and surface area (RB); cytokinin content (RB); drought stress tolerance (MF, RB); arbuscule-forming mycorrhiza fungal may reduce Poa annua on greens (MF); chlorophyll content (MF, RB); absorption of mineral elements such as phosphorus (P), iron (Fe), copper (Cu), magnesium (Mg), potassium (K), boron (B), silicon (Si), sulfur(S), and nitrogen (N) (MF); above ground biomass (MF); water use efficiency (MF); less irrigation in summer (MF); and less artificial fertilizer for the same results (MF).

The one or more plant health components are present in the turf grass treatment composition in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

In an embodiment, the weight ratio of the one or more biosurfactants to the one or more plant health components is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

### Synthetic Surfactant(s)

The turf grass treatment composition of this disclosure can include at least one synthetic surfactant. As used herein, synthetic surfactants include surfactants produced from a naturally-derived source by mechanical and biological processes, and by a chemical reaction that alters a molecule of the naturally-derived source.

Illustrative synthetic surfactants include, for example, anionic surfactants, nonionic surfactants, cationic surfactants, amphoteric or zwitterionic surfactants, and combinations thereof.

Illustrative nonionic surfactant include, for example, polyoxyethylene (POE) surfactants, block copolymer surfactants, straight block copolymer surfactants, reverse block copolymer surfactants, alkyl polyglucoside (APG) surfactants, modified methyl capped block copolymer surfactants, humic substance redistribution molecules, multibranched regenerating wetting agents, and combinations thereof.

In an embodiment, the nonionic surfactant is selected from alkyl polyglucosides (APGs), fatty alcohol ethoxylates, alkyl phenol ethoxylates, fatty acid alkoxylates, and combinations thereof.

In another embodiment, the nonionic surfactant is selected from alcohol ethoxylates, alkanolamides, alkanolamine condensates, carboxylic acid esters, cetostearyl alcohol, cetyl alcohol, cocamide DEA, dodecyldimethylamine oxides, ethanolamides, ethoxylates of glycerol ester and glycol esters, ethylene oxide polymers, ethylene oxide-propylene oxide copolymers, glucoside alkyl ethers, glycerol alkyl ethers, glycerol esters, glycol alkyl ethers (e.g., polyoxyethylene glycol alkyl ethers, polyoxypropylene glycol alkyl ethers), glycol alkylphenol ethers (e.g., polyoxyethylene glycol alkylphenol ethers,), glycol esters, monolaurin, pentaethylene glycol monododecyl ethers, poloxamer, polyamines, polyglycerol polyricinoleate, polysorbate, polyoxyethylenated fatty acids, polyoxyethylenated mercaptans, polyoxyethylenated polyoxyproylene glycols, polyoxyethylene glycol sorbitan alkyl esters, polyethylene glycol-polypropylene glycol copolymers, polyoxyethylene glycol octylphenol ethers, polyvinyl pynolidones, sugar-based alkyl polyglycosides, sulfoanylamides, sorbitan fatty acid alcohol ethoxylates, sorbitan fatty acid ester ethoxylates, sorbitan fatty acid ester, and tertiary acetylenic glycols.

In an embodiment, the anionic surfactant is selected from alkyl carboxylates (e.g., sodium stearate), alkyl sulfates (e.g., alkyl lauryl sulfate, sodium lauryl sulfate), alkyl ether sulfates, alkyl amido ether sulfates, alkyl aryl polyether sulfates, alkyl aryl sulfates, alkyl aryl sulfonates, alkyl sulfonates, alkyl amide sulfonates, alkyl aryl sulfonates, alkyl benzene sulfonates, alkyl diphenyloxide sulfonate, alpha-olefin sulfonates, alkyl naphthalene sulfonates, paraffin sulfonates, alkyl sulfosuccinates, alkyl ether sulfosuccinates, alkylamide sulfosuccinates, alkyl sulfosuccinamates, alkyl sulfoacetates, alkyl phosphates, alkyl ether phosphates, acyl sarconsinates, acyl isethionates, N-acyl taurates, N-acyl-N-alkyltaurates, benzene sulfonates, cumene sulfonates, dioctyl sodium sulfosuccinate, ethoxylated sulfosuccinates, lignin sulfonates, linear alkylbenzene sulfonates, monoglyceride sulfates, perfluorobutanesulfonate, perfluorooctanesulfonate, phosphate ester, styrene acrylic polymers, toluene sulfonates, and xylene sulfonates.

In an embodiment, the cationic surfactant is selected from alkyltrimethylammonium salts (e.g., cetyl trimethylammonium bromide, cetyl trimethylammonium chloride), cetylpyridinium chloride, benzalkonium chloride, benzethonium chloride, 5-bromo-5-nitro-1,3-dioxane, dimethyldioctadecylammonium chloride, cetrimonium bromide, dioctadecyldimethylammonium bromide, and octenidine dihydrochloride.

In an embodiment, the amphoteric or zwitterionic surfactant is selected from the group consisting of 3 [(3-cholamidopropyl)dimethylammonio]-1-propanesulfonate, cocamidopropyl betaine, cocamidopropyl hydroxysultaine, phosphatidylserine, phosphatidylethanolamine, phosphatidylcholine, and sphingomyelins.

In an embodiment, the synthetic surfactant is selected from fatty acid derivatives, saponins, natural extracts, plant derived oils, lauric acid derivatives, and the like.

Illustrative synthetic surfactants include alkyl polyglucoside, yucca extract, palm oil, coconut oil, sodium lauryl sulfate, and sodium coco sulfate. A preferred synthetic surfactant is alkyl polyglucoside.

The one or more synthetic surfactants are present in the turf grass treatment composition in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the turf grass treatment composition.

In an embodiment, the weight ratio of the one or more biosurfactants to the one or more synthetic surfactants is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

In an embodiment, the weight ratio of the one or more plant health components to the one or more synthetic surfactants is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

### Inert Component(s)

The turf grass treatment composition of this disclosure can optionally include at least one inert component.

In an embodiment, the at least one inert component is water.

The one or more inert components are present in the turf grass treatment composition in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the turf grass treatment composition.

In an embodiment, the weight ratio of the one or more biosurfactants to the one or more inert components is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

In another embodiment, the weight ratio of the one or more plant health components to the one or more inert components is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

In yet another embodiment, the weight ratio of the one or more synthetic surfactants to the one or more inert components is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

### Other Additive(s)

In some embodiments, the turf grass treatment compositions of this disclosure can include additional components, such as, for example, herbicides, fertilizers, pesticides, soil amendments, one or more sources of nutrients, and the like. Preferably, the additional components are non-toxic and environmentally-friendly. The exact materials and the quantities thereof can be determined by a groundskeeper or a turf scientist having the benefit of this disclosure.

To improve or stabilize the effects of the turf grass treatment composition, it can be blended with suitable adjuvants and then used as such or after dilution, if necessary. In certain embodiments, the turf grass treatment composition is formulated as a concentrated liquid preparation, or as dry powder or dry granules that can be mixed with water and other components to form a liquid product.

The methods can comprise applying materials to enhance microbe growth during application (e.g., adding nutrients to promote microbial growth). In one embodiment, the nutrient sources can include, for example, sources of magnesium, phosphate, nitrogen, potassium, selenium, calcium, sulfur, iron, copper, zinc, proteins, vitamins and/or carbon.

In some embodiments, the methods of this disclosure comprise applying additional components, such as herbicides, fertilizers, pesticides and/or soil amendments. Preferably, the additional components are non-toxic and environmentally-friendly. The exact materials and the quantities thereof can be determined by a groundskeeper or a turf scientist having the benefit of the subject disclosure, although the following compounds may be compatible with the methods of this disclosure:
antiscalants, such as, e.g., hydroxyethylidene diphosphonic acid;
bactericides, such as, e.g., streptomycin sulfate and/or Galltrol® (A. radiobacier strain K84);
biocides, such as, e.g., chlorine dioxide, didecyldimethyl ammonium chloride, halogenated heterocyclic, and/or hydrogen dioxide/peroxyacetic acid;
fertilizers, such as, e.g., N—P—K fertilizers, calcium ammonium nitrate 17-O-0, potassium thiosulfate, nitrogen (e.g., 10-34-0, Kugler KQ-XRN, Kugler KS-178C, Kugler KS-2075, Kugler LS 6-24-6S, UN 28, UN 32), and/or potassium;
fungicides, such as, e.g., chlorothalonil, manicozeb hexamethylenetetramine, aluminum tris, azoxystrobin, Bacillus spp. (e.g., B. licheniformis strain 3086, B. subtilis, B. subtilis strain QST 713), benomyl, boscalid, pyraclostrobin, captan, carboxin, chloroneb, chlorothalonil, copper culfate, cyazofamid, dicloran, dimethomorph, etridiazole, thiophanate-methyl, fenamidone, fenarimol, fludioxonil, fluopicolide, flutolanil, iprodione, mancozeb, maneb, mefanoxam, fludioxonil, mefenoxam, metalaxyl, myclobutanil, oxathiapiprolin, pentachloronitrobenzene (quintozene), phosphorus acid, propamocarb, propanil, pyraclostrobin, Reynoutria sachalinensis, Streptomyces spp. (e.g., S. griseoviridis strain K61, S. lydicus WYEC 108), sulfur, urea, thiabendazole, thiophanate methyl, thiram, triadimefon, triadimenol, and/or vinclozolin;
growth regulators, such as, e.g., ancymidol, chlormequat chloride, diaminozide, paclobutrazol, and/or uniconazole;
herbicides, such as, e.g., glyphosate, oxyfluorfen, and/or pendimethalin;
insecticides, such as, e.g., acephate, azadirachtin, B. thuringiensis (e.g., subsp. israelensis strain AM 65-52), Beauveria bassiana (e.g., strain GHA), carbaryl, chlorpyrifos, cyantraniliprole, cyromazine, dicofol, diazinon, dinotefuran, imidacloprid, Isaria fumosorosae (e.g., Apopka strain 97), lindane, and/or malathion;
water treatments, such as, e.g., hydrogen peroxide (30-35%), phosphonic acid (5-20%), and/or sodium chlorite;
as well as deet, citronella, essential oils, mineral oils, garlic extract, chili extract, and/or any known commercial and/or homemade additives that are determined to be compatible by the skilled artisan having the benefit of this disclosure.

### Quality of Turf Grass

The turf grass treatment compositions of this disclosure enhance the quality of turf grass. In accordance with this disclosure, the turf grass treatment composition, when applied to turf grass, or to roots of the turf grass, or to soil in which the turf grass grows, is effective for enhancing quality of the turf grass, including promoting or enhancing bioenzyme activity and bioenzyme production in the turf grass.

In an embodiment, the turf grass treatment composition of this disclosure, when applied to turf grass, or to roots of the turf grass, or to soil in which the turf grass grows, is effective for promoting or enhancing at least one of bioenzyme activity and bioenzyme production in the turf grass.

In an embodiment, the turf grass treatment composition of this disclosure, when applied to turf grass, or to roots of the turf grass, or to soil in which the turf grass grows, enhances quality of the turf grass by enhancing initial water uptake or wetting, rewetting and/or water retention over time of the turf grass.

In an embodiment, the turf grass treatment composition of this disclosure, when applied to turf grass, or to roots of the turf grass, or to soil in which the turf grass grows, enhances quality of the turf grass by enhancing surface tension reduction, increasing speed to wet, increasing water retention, and/or increasing time to dry between watering events.

In an embodiment, the turf grass treatment composition of this disclosure, when applied to turf grass, or to roots of the turf grass, or to soil in which the turf grass grows, enhances quality of the turf grass by enhancing root structure and growth, nutrient use efficiency, water use efficiency, stress tolerance, disease tolerance, and/or inducing systemic resistance.

In an embodiment, the turf grass treatment composition of this disclosure, when applied to turf grass, or to roots of the turf grass, or to soil in which the turf grass grows, enhances quality of the turf grass by enhancing strength of the turf grass roots by increasing root density, increasing root diameter, and/or increasing root depth.

In an embodiment, the turf grass treatment composition of this disclosure, when applied to turf grass, or to roots of the turf grass, or to soil in which the turf grass grows, enhances quality of the turf grass by increasing or enhancing photosynthesis; photochemical activity; root enzyme activity; root mass; stress tolerance due to the production of superoxide dismutase enzymes; cytokinin activity under drying conditions to stimulate cell division; leaf moisture; a-tocopherol (vitamin E) and ascorbic acid (vitamin C) antioxidants found in chloroplasts; chlorophyll content; root length; shoot growth; phosphorus uptake; salt tolerance; leaf tissue nitrogen (N), phosphorus (P), potassium (K) and iron (Fe); soil moisture; and/or microbiome.

In an embodiment, the turf grass treatment composition of this disclosure, when applied to turf grass, or to roots of the turf grass, or to soil in which the turf grass grows, enhances quality of the turf grass by making the nutrients far more recognizable to the turf grass; limiting temperature stress, drought stress, heavy metal stress, and low mowing heights; amino acid proline scavenges hydroxyl radicals by increasing superoxide dismutase (SOD); protein biosynthesis improvement; increasing chlorophyll content; increasing germination; stimulating carbon and nitrogen metabolism; and/or stimulating turf grass microbiomes.

In an embodiment, the turf grass treatment composition of this disclosure, when applied to turf grass, or to roots of the turf grass, or to soil in which the turf grass grows, enhances quality of the turf grass by increasing or enhancing leaf count, amino acid proline scavenges hydroxyl radicals by increasing superoxide dismutase (SOD); proline dehydrogenase production/stress adaption; chlorophyll content; germination; and/or vertical leaf growth.

In an embodiment, the turf grass treatment composition of this disclosure, when applied to turf grass, or to roots of the turf grass, or to soil in which the turf grass grows, enhances quality of the turf grass by strengthening cell walls by silica deposits; promoting turf grass growth; inducing tolerance to abiotic stress (drought, salinity, cold stress); inducing cell wall rigidification, osmoregulation, reducing transpiration; influencing osmotic, pH, and redox homeostasis; and/or influencing hormone signaling and enzymes involved in stress response.

In an embodiment, the turf grass treatment composition of this disclosure, when applied to turf grass, or to roots of the turf grass, or to soil in which the turf grass grows, enhances quality of the turf grass by providing defense against abiotic stress; leaf and stem strength through deposition in the cuticle; maintaining cell wall polysaccharide and lignin polymersproline; wear resistance; heat and drought stressed resistance; growth and establishment; water use efficiency; salt stress tolerance; leaf blade stiffness; and/or better ball roll.

In an embodiment, the turf grass treatment composition of this disclosure, when applied to turf grass, or to roots of the turf grass, or to soil in which the turf grass grows, enhances quality of the turf grass by increasing or enhancing uptake of macro- and micronutrients; root mass and surface area; cytokinin content; drought stress tolerance; arbuscule-forming mycorrhiza fungal may reduce Poa annua on golf greens; chlorophyll content; absorption of mineral elements such as phosphorus (P), iron (Fe), copper (Cu), magnesium (Mg), potassium (K), boron (B), silicon (Si), sulfur(S), and nitrogen (N); above ground biomass; water use efficiency; less irrigation in summer; and/or less artificial fertilizer for the same results.

In an embodiment, the turf grass treatment composition of this disclosure, when applied to turf grass, or to roots of the turf grass, or to soil in which the turf grass grows, enhances quality of the turf grass by enhancing health, growth and/or sturdiness of the turf grass.

In an embodiment, the turf grass treatment composition of this disclosure, when applied to turf grass, or to roots of the turf grass, or to soil in which the turf grass grows, enhances quality of the turf grass by enhancing turf grass color, turf grass shoot density, and/or turf grass greenness.

### Turf Grasses

Any species of turf grass is useful in this disclosure. The turf grass treatment composition can be applied to turf grass, or to roots of the turf grass, or to soil in which the turf grass grows.

In an embodiment, the turf grass is in the form of sod comprised of turf grass and a layer of soil held together by the roots of the turf grass and forming a sheet.

In some embodiments, the turf grass is in the form of sod. As used herein, “sod” means sheets of turf grass comprising grass plants, their roots, and any soil that is attached thereto. The sheets can be harvested and transplanted to cover large surface areas of ground.

Illustrative turf grasses useful in this disclosure include, for example, the following: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); zoysia grass (Zoysia spp.); Bahia grass (Paspalum notatum); carpet grass (Axonopus affinis); centipede grass (Eremochloa ophiuroides); kikuyu grass (Pennisetum clandesinum); seashore paspalum (Paspalum vaginatum); floratam (Stenotaphrum secundatum “Floratam”); blue gramma (Bouteloua gracilis); buffalo grass (Buchloe dactyloids); and/or sideoats gramma (Bouteloua curtipendula).

### Application Methods

As used herein, “applying” a turf grass treatment composition refers to contacting the turf grass treatment composition with a target or site such that the composition can have an effect on that target or site. The effect can be due to, for example, the action of the biosurfactant, or other components.

The turf grass treatment compositions of this disclosure can be contacted with a turf grass part. In an embodiment, the turf grass treatment composition is contacted with one or more roots of the turf grass. The turf grass treatment composition can be applied directly to the roots, e.g., by spraying or dunking the roots, and/or indirectly, e.g., by administering the turf grass treatment composition to the soil in which the turf grass grows (e.g., the rhizosphere). The turf grass treatment composition can be applied to the seeds of the turf grass prior to or at the time of planting, or to any other part of the turf grass and/or its surrounding environment.

Turf grass and/or its environments can be treated at any point during the process of cultivating the turf grass. For example, the turf grass treatment composition can be applied to the turf grass prior to, concurrently with, or after the time when seeds are planted. It can also be applied at any point thereafter during the development and growth of the turf grass.

In some embodiments, the methods of this disclosure can be implemented on turf grasses that are already planted and growing in soil, such as in fields, pitches, and pastures, and/or the methods can be implemented on turf grasses that have been, or will be, harvested as sod.

The turf grass treatment compositions of this disclosure can be applied to turf grass using an irrigation system.

In an embodiment, the turf grass treatment compositions of this disclosure can be applied to turf grass using a manual spreader. The spreader can be a broadcast spreader, a drop spreader, a handheld spreader, a handheld sprayer, or the like.

In an embodiment, the turf grass treatment compositions of this disclosure are applied to a field or pitch planted with the turf grass. The field can be used for athletics and/or recreation. The field can have commercial or residential uses.

In an embodiment, the field is a golf course, park, campground, amphitheater, horse track, soccer field, football field, lacrosse field, field hockey field, cricket field, rugby field, polo field, softball field, baseball field, or the like. The field can also be for commercial or residential uses.

In an embodiment, the turf grass treatment composition of this disclosure, when applied to turf grass, or to roots of the turf grass, or to soil in which the turf grass grows, helps prevent the occurrence of holes and/or divots in the field as a result of athletic or recreational use.

In an embodiment, the turf grass treatment composition of this disclosure, when applied to turf grass, or to roots of the turf grass, or to soil in which the turf grass grows, increases safety of participating in athletics or recreation on the field by preventing injuries caused by stepping in a hole and/or divot.

The methods of this disclosure can be implemented on turf grasses that are already growing in soil, such as in fields and pastures, and/or the methods can be implemented on turf grasses that have been, or will be, harvested as sod.

The methods of this disclosure can utilize standard equipment that is used for maintenance of turf grass fields. In one embodiment, the methods can comprise administering the composition into a tank connected to an irrigation system used for supplying water, fertilizers, pesticides, or other liquid compositions to a field. Thus, the turf grass and/or soil surrounding the turf grass can be treated with the composition via, for example, soil injection, soil drenching, or using a center pivot irrigation system, or with a spray over the seed furrow, or with sprinklers or drip irrigators. Advantageously, the method is suitable for treating hundreds of acres at one time.

In one embodiment, the methods can comprise pouring the turf grass treatment composition into the tank of a handheld lawn and garden sprayer and spraying turf grass and/or its surrounding environment with the mixture. The turf grass treatment composition can also be mixed into a standard handheld watering can and poured onto turf grass. Additionally, the turf grass treatment composition can be applied using a standard manual spreader, such as a broadcast spreader, a drop spreader, or a handheld spreader.

In certain embodiments, the turf grass treatment compositions provided herein are applied to the turf grass surface without mechanical incorporation. The beneficial effect of the turf grass application can be activated by rainfall, sprinkler, flood, or drip irrigation, and subsequently delivered to, for example, the roots of turf grass to influence the root microbiome and/or facilitate uptake of nutrients and water.

In one embodiment, the methods enhance the quality of turf grass by enhancing the root structure and growth, nutrient use efficiency, water use efficiency, stress tolerance, disease tolerance, and/or inducing systemic resistance.

In some embodiments, the methods work by, for example, improving the nutrient and moisture retention properties of the rhizosphere in which the turf grass grows. In some embodiments, the methods work by promoting colonization of the roots and/or rhizosphere with nutrient-fixing microbes, such as rhizobia and mycorrhizae.

The turf grass treatment compositions of this disclosure can be applied to the turf grass, or to roots of the turf grass, or to soil in which the turf grass grows, at a treatment rate from about 0.5 oz./1000 sq. ft. monthly to about 12 oz./1000 sq. ft. monthly, or from about 1.0 oz./1000 sq. ft. monthly to about 10 oz./1000 sq. ft. monthly, or from about 2.0 oz./1000 sq. ft. monthly to about 8 oz./1000 sq. ft. monthly.

### Synergistic Turf Grass Treatment Compositions and Methods

In an embodiment, this disclosure relates to synergistic turf grass treatment compositions comprising a synergistic combination of at least two biosurfactants, or at least one biosurfactant and at least one plant health component, or at least one biosurfactant and at least one synthetic surfactant, or at least one biosurfactant, at least one plant health component, and at least one synthetic surfactant. The synergistic turf grass treatment compositions having a synergistic combination of two or more biosurfactants, or at least one biosurfactant and at least one plant health component, or at least one biosurfactant and at least one synthetic surfactant, or at least one biosurfactant, at least one plant health component, and at least one synthetic surfactant, when applied to turf grass, or to roots of the turf grass, or to soil in which the turf grass grows, produces a combined turf grass quality effect, greater than the sum of the separate turf grass quality effects, at essentially the same concentrations; or produces a combined promoting or enhancing effect of at least one of bioenzyme activity and bioenzyme production in the turf grass, greater than the sum of the separate promoting or enhancing effects of at least one of bioenzyme activity and bioenzyme production in the turf grass, at essentially the same concentrations.

In an embodiment, this disclosure provides a method for enhancing quality of turf grass by applying to the turf grass, or to roots of the turf grass, or to soil in which the turf grass grows, a synergistic composition comprising a synergistic combination of two or more biosurfactants, or at least one biosurfactant and at least one plant health component, or at least one biosurfactant and at least one synthetic surfactant, or at least one biosurfactant, at least one plant health component, and at least one synthetic surfactant. The synergistic combination of two or more biosurfactants, or at least one biosurfactant and at least one plant health component, or at least one biosurfactant and at least one synthetic surfactant, or at least one biosurfactant, at least one plant health component, and at least one synthetic surfactant, when applied to turf grass, or to roots of the turf grass, or to soil in which the turf grass grows, produces a combined turf grass quality effect, greater than the sum of the separate turf grass quality effects, at essentially the same concentrations; or produces a combined promoting or enhancing effect of at least one of bioenzyme activity and bioenzyme production in the turf grass, greater than the sum of the separate promoting or enhancing effects of at least one of bioenzyme activity and bioenzyme production in the turf grass, at essentially the same concentrations . . .

In an embodiment, the turf grass quality effect produced by the synergistic turf grass treatment compositions of this disclosure can include, for example, enhanced or increased initial water uptake or wetting, rewetting, and water retention over time of the turf grass.

In an embodiment, the turf grass quality effect produced by the synergistic turf grass treatment compositions of this disclosure can include, for example, surface tension reduction, increased speed to wet, increased water retention, and increased time to dry between watering events.

In an embodiment, the turf grass quality effect produced by the synergistic turf grass treatment compositions of this disclosure can include, for example, enhanced or increased root structure and growth, nutrient use efficiency, water use efficiency, stress tolerance, disease tolerance, and induced systemic resistance.

In an embodiment, the turf grass quality effect produced by the synergistic turf grass treatment compositions of this disclosure can include, for example, enhanced or increased strength of the turf grass roots by increasing root density, increased root diameter, and increased root depth.

In an embodiment, the turf grass quality effect produced by the synergistic turf grass treatment compositions of this disclosure can include, for example, enhanced or increased turf grass color, turf grass shoot density, and turf grass greenness.

### Turf Grass Treatment Compositions Having One Or More Biosurfactant(s)

Preferred embodiments of this disclosure with regard to turf grass treatment compositions having at least one biosurfactant are described in Embodiments 1-69 below.

Embodiment 1. A turf grass treatment composition comprising at least one biosurfactant; wherein the turf grass treatment composition, when applied to turf grass, or to roots of the turf grass, or to soil in which the turf grass grows, is effective for promoting or enhancing at least one of bioenzyme activity and bioenzyme production in the turf grass.

Embodiment 2. The turf grass treatment composition of embodiment 1 wherein the least one biosurfactant is a growth byproduct of a microorganism.

Embodiment 3. The turf grass treatment composition of embodiment 2 wherein the microorganism is a genetically-modified (GM) microorganism or a non-genetically (non-GM) modified microorganism.

Embodiment 4. The turf grass treatment composition of embodiment 2 wherein the microorganism is selected from the group consisting of bacteria, yeast, and fungi.

Embodiment 5. The turf grass treatment composition of embodiment 1 wherein the at least one biosurfactant is selected from the group consisting of glycolipids, lipopeptides, phospholipids, fatty acids, and polymeric surfactants.

Embodiment 6. The turf grass treatment composition of embodiment 1 wherein the at least one biosurfactant is a glycolipid.

Embodiment 7. The turf grass treatment composition of embodiment 1 wherein the at least one biosurfactant is a glycolipid selected from the group consisting of rhamnolipid, sophorolipid, mannosylerythritol lipid, and trehalose lipid.

Embodiment 8. The turf grass treatment composition of embodiment 1 wherein the at least one biosurfactant is rhamnolipid.

Embodiment 9. The turf grass treatment composition of embodiment 2 wherein the microorganism is selected from the group consisting of Starmerella sp., Pichia sp., Pseudomonas sp. (P. aeruginosa, P. putida, P. florescens, P. Tragi, P. syringae); Flavobacterium spp.; Bacillus spp. (B. subtilis, B. pumillus, B. cereus, B. licheniformis); Candida species (C. albicans, C. rugosa, C. tropicalis, C. lipolytica, C. torulopsis); Rhodococcus sp.; Arthrobacter spp.; campylobacter spp.; and cornybacterium spp.; and combinations thereof; wherein the microorganism is a genetically-modified (GM) microorganism or a non-genetically (non-GM) modified microorganism.

Embodiment 10. The turf grass treatment composition of embodiment 4 wherein the bacteria is selected from the group consisting of: Pseudomonas sp., Pseudomonas guguanensis, Pseudomonas putida, Pseudomonas aeruginosa, Pseudomonas fluorescens, Pseudomonas aeruginosa, Pseudomonas aeruginosa, Pseudomonas stutzeri; and combinations thereof; wherein the bacteria is a genetically-modified (GM) bacteria or a non-genetically (non-GM) modified bacteria.

Embodiment 11. The turf grass treatment composition of embodiment 4 wherein the bacteria is selected from the group consisting of: Bacillus sp., Bacillus subtilis,; Bacillus sphaericus, Bacillus azotoformans,; Bacillus subtilis, Bacillus sp., Bacillus subtilis, Bacillus licheniformis, Bacillus subtilis,; Bacillus subtilis; and combinations thereof; wherein the bacteria is a genetically-modified (GM) bacteria or a non-genetically (non-GM) modified bacteria.

Embodiment 12. The turf grass treatment composition of embodiment 4 wherein the bacteria is selected from the group consisting of: Bordetella hinzii; Klebsiella pneumoniae; Ochrobactrum anthropi, Citrobacter freundii; Pseudoxanthomonas sp., Nocardia otitidiscaviarum; Serratia marcescens, Stenotrophomonas maltophilia; Virgibacillus salarius, Stenotrophomonas sp., Aeromonas salmonicida; Gordonia polyisoprenivorans; Burkholderia thailandensis, Pseudoxanthomonas sp., Ralstonia pickettii, Alcaligenes piechaudii; Gordonia sp.; and combinations thereof; wherein the bacteria is a genetically-modified (GM) bacteria or a non-genetically (non-GM) modified bacteria.

Embodiment 13. The turf grass treatment composition of embodiment 4 wherein the fungi is selected from the group consisting of: filamentous fungi such as Penicillium citrinum; Aspergillus flavus; Penicillium chrysogenum, Fusarium sp.; Fusarium oxysporum; Cunninghamella echinulate; and combinations thereof; wherein the fungi are genetically-modified (GM) fungi or non-genetically (non-GM) modified fungi.

Embodiment 14. The turf grass treatment composition of embodiment 4 wherein the yeast is selected from the group consisting of: Cryptococcus curvatus; Pichia anomala, Starmerella bombicola, Candida bombicola, Candida lipolytica; Candida lipolytica; Candida Pseudozyma parantarctica, Pseudozyma aphidis, Kluyveromyces marxianus, Kurtzmanomyces sp., Pseudozyma siamensis,; Wickerhamomyces anomalus, Candida antarctica, Candida apicola; and combinations thereof; wherein the yeast is a genetically-modified (GM) yeast or a non-genetically (non-GM) modified yeast.

Embodiment 15. The turf grass treatment composition of embodiment 2 wherein the microorganism is produced by a production or cultivation process selected from the group consisting of submerged cultivation/fermentation, surface cultivation, solid state fermentation, and combinations thereof; wherein the production or cultivation process is carried out under aerobic or anaerobic conditions.

Embodiment 16. The turf grass treatment composition of embodiment 15 wherein the production or cultivation process utilizes food/energy source(s) for microorganism growth.

Embodiment 17. The turf grass treatment composition of embodiment 16 wherein the food/energy source(s) are selected from the group consisting of: carbon sources including carbohydrates, alcohols, organic acids, fats, and oils; and combinations thereof; agro-industrial wastes, vegetable oil mill effluents including coconut oil, canola oil, olive oil, grape seed oil, palm oil, rapeseed oil, sunflower oil, soybean oil; dairy and sugar industry byproducts including buttermilk, whey, molasses; starch industry extract and wastes including corn, potatoes, tapioca, wheat; wherein the food/energy source(s) are genetically-modified (GM) or non-genetically (non-GM) modified.

Embodiment 18. The turf grass treatment composition of embodiment 1 wherein the at least one biosurfactant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

Embodiment 19. The turf grass treatment composition of embodiment 1 further comprising at least one plant health component.

Embodiment 20. The turf grass treatment composition of embodiment 19 wherein the at least one plant health component is selected from the group consisting of a biostimulant, bioenzyme, nutrient(s) for microorganism growth, nutrient(s) for plant growth, fertilizer, pesticide, herbicide, other microorganism based composition(s); and combinations thereof.

Embodiment 21. The turf grass treatment composition of embodiment 20 wherein the at least one plant health component is at least one biostimulant.

Embodiment 22. The turf grass treatment composition of embodiment 21 wherein the at least one biostimulant is selected from the group consisting of plant hormones, microbes selected from bacteria, yeast, and fungi; humic substances, seaweed extracts, protein hydrolysates, chitosan, inorganic compounds, and metabolites.

Embodiment 23. The turf grass treatment composition of embodiment 21 wherein the at least one biostimulant is selected from the group consisting of humic substances, humins, fulvic acids, fatty acids/lipids, peptides, amino acids, organic acids, carboxyls, B vitamins, protein hydrolysates, plant growth promoting bacteria (PGPR), cytokinins, rhizobium, mycorrhizae, trichoderma, fungi, microbial complex communities/consortia, phytohormones, seaweed/kelp, laminarin, alginates, polysaccharides, polyphenols, botanicals, allelochemicals, organic matter extracts, chitin, chitosan, betaines, polyamines, inorganic salts, proteins, elements selected from silicon (Si), sodium (Na) and cobalt (Co), phosphites, nitrogeneous compounds, and enzymatic extracts.

Embodiment 24. The turf grass treatment composition of embodiment 22 wherein the yeast or fungi are selected from the group consisting of Aureobasidium (e.g., A. pullulans), Blakeslea, Candida (e.g., C. apicola, C. bombicola, C. nodaensis), Cryptococcus, Debaryomyces (e.g., D. hansenii), Entomophthora, Hanseniaspora, (e.g., H. uvarum), Hansenula, Issatchenkia, Kluyveromyces (e.g., K. phaffii), Mortierella, mycorrhizal fungi, Penicillium, Phycomyces, Pichia (e.g., P. anomala, P. guilliermondii, P. occidentalis, P. kudriavzevii), Pleurotus spp. (e.g., P. ostreatus), Pseudozyma (e.g., P. aphidis), Saccharomyces (e.g., S. boulardii sequela, S. cerevisiae, S. torula), Starmerella (e.g., S. bombicola), Torulopsis, Trichoderma (e.g., T. reesei, T. harzianum, T. hamatum, T. viride), Ustilago (e.g., U. maydis), Wickerhamomyces (e.g., W. anomalus), Williopsis (e.g., W. mrakii), and Zygosaccharomyces (e.g., Z. bailii).

Embodiment 25. The turf grass treatment composition of embodiment 22 wherein the bacteria are selected from the group consisting of Gram-positive and Gram-negative bacteria, rhizobacteria, Agrobacterium (e.g., A. radiobacter), Azotobacter (A. vinelandii, A. chroococcum), Azospirillum (e.g., A. brasiliensis), Bacillus (e.g., B. amyloliquifaciens, B. circulans, B. firmus, B. laterosporus, B. licheniformis, B. megaterium, Bacillus mucilaginosus, B. subtilis), Frateuria (e.g., F. aurantia), Microbacterium (e.g., M. laevaniformans), myxobacteria (e.g., Myxococcus xanthus, Stignatella aurantiaca, Sorangium cellulosum, Minicystis rosea), Pantoea (e.g., P. agglomerans), Pseudomonas (e.g., P. aeruginosa, P. chlororaphis subsp. aureofaciens (Kluyver), P. putida), Rhizobium spp., Rhodospirillum (e.g., R. rubrum), Sphingomonas (e.g., S. paucimobilis), and Thiobacillus thiooxidans (Acidothiobacillus thiooxidans).

Embodiment 26. The turf grass treatment composition of embodiment 19 wherein the at least one plant health component is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

Embodiment 27. The turf grass treatment composition of embodiment 19 wherein the weight ratio of the at least one biosurfactant to the at least one plant health component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 28. The turf grass treatment composition of embodiment 1 further comprising at least one synthetic surfactant.

Embodiment 29. The turf grass treatment composition of embodiment 28 wherein the at least one synthetic surfactant is selected from the group consisting of anionic surfactants, nonionic surfactants, cationic surfactants, amphoteric or zwitterionic surfactants, and combinations thereof.

Embodiment 30. The turf grass treatment composition of embodiment 29 wherein the nonionic surfactant is selected from the group consisting of polyoxyethylene (POE) surfactants, block copolymer surfactants, straight block copolymer surfactants, reverse block copolymer surfactants, alkyl polyglucoside (APG) surfactants, modified methyl capped block copolymer surfactants, humic substance redistribution molecules, and multibranched regenerating wetting agents.

Embodiment 31. The turf grass treatment composition of embodiment 29 wherein the nonionic surfactant is selected from the group consisting of alkyl polyglucosides (APGs), fatty alcohol ethoxylates, alkyl phenol ethoxylates, fatty acid alkoxylates, and combinations thereof.

Embodiment 32. The turf grass treatment composition of embodiment 29 wherein the nonionic surfactant is selected from the group consisting of alcohol ethoxylates, alkanolamides, alkanolamine condensates, carboxylic acid esters, cetostearyl alcohol, cetyl alcohol, cocamide DEA, dodecyldimethylamine oxides, ethanolamides, ethoxylates of glycerol ester and glycol esters, ethylene oxide polymers, ethylene oxide-propylene oxide copolymers, glucoside alkyl ethers, glycerol alkyl ethers, glycerol esters, glycol alkyl ethers (e.g., polyoxyethylene glycol alkyl ethers, polyoxypropylene glycol alkyl ethers), glycol alkylphenol ethers (e.g., polyoxyethylene glycol alkylphenol ethers,), glycol esters, monolaurin, pentaethylene glycol monododecyl ethers, poloxamer, polyamines, polyglycerol polyricinoleate, polysorbate, polyoxyethylenated fatty acids, polyoxyethylenated mercaptans, polyoxyethylenated polyoxyproylene glycols, polyoxyethylene glycol sorbitan alkyl esters, polyethylene glycol-polypropylene glycol copolymers, polyoxyethylene glycol octylphenol ethers, polyvinyl pynolidones, sugar-based alkyl polyglycosides, sulfoanylamides, sorbitan fatty acid alcohol ethoxylates, sorbitan fatty acid ester ethoxylates, sorbitan fatty acid ester, and tertiary acetylenic glycols.

Embodiment 33. The turf grass treatment composition of embodiment 29 wherein the anionic surfactant is selected from the group consisting of alkyl carboxylates (e.g., sodium stearate), alkyl sulfates (e.g., alkyl lauryl sulfate, sodium lauryl sulfate), alkyl ether sulfates, alkyl amido ether sulfates, alkyl aryl polyether sulfates, alkyl aryl sulfates, alkyl aryl sulfonates, alkyl sulfonates, alkyl amide sulfonates, alkyl aryl sulfonates, alkyl benzene sulfonates, alkyl diphenyloxide sulfonate, alpha-olefin sulfonates, alkyl naphthalene sulfonates, paraffin sulfonates, alkyl sulfosuccinates, alkyl ether sulfosuccinates, alkylamide sulfosuccinates, alkyl sulfosuccinamates, alkyl sulfoacetates, alkyl phosphates, alkyl ether phosphates, acyl sarconsinates, acyl isethionates, N-acyl taurates, N-acyl-N-alkyltaurates, benzene sulfonates, cumene sulfonates, dioctyl sodium sulfosuccinate, ethoxylated sulfosuccinates, lignin sulfonates, linear alkylbenzene sulfonates, monoglyceride sulfates, perfluorobutanesulfonate, perfluorooctanesulfonate, phosphate ester, styrene acrylic polymers, toluene sulfonates, and xylene sulfonates.

Embodiment 34. The turf grass treatment composition of embodiment 29 wherein the cationic surfactant is selected from the group consisting of alkyltrimethylammonium salts (e.g., cetyl trimethylammonium bromide, cetyl trimethylammonium chloride), cetylpyridinium chloride, benzalkonium chloride, benzethonium chloride, 5-bromo-5-nitro-1,3-dioxane, dimethyldioctadecylammonium chloride, cetrimonium bromide, dioctadecyldimethylammonium bromide, and octenidine dihydrochloride.

Embodiment 35. The turf grass treatment composition of embodiment 29 wherein the amphoteric or zwitterionic surfactant is selected from the group consisting of 3 [(3-cholamidopropyl)dimethylammonio]-1-propanesulfonate, cocamidopropyl betaine, cocamidopropyl hydroxysultaine, phosphatidylserine, phosphatidylethanolamine, phosphatidylcholine, and sphingomyelins.

Embodiment 36. The turf grass treatment composition of embodiment 28 wherein the at least one synthetic surfactant is from a naturally-derived source.

Embodiment 37. The turf grass treatment composition of embodiment 28 wherein the at least one synthetic surfactant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the turf grass treatment composition.

Embodiment 38. The turf grass treatment composition of embodiment 28 wherein the weight ratio of the at least one biosurfactant to the at least one synthetic surfactant is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 39. The turf grass treatment composition of embodiment 28 wherein the weight ratio of the at least one plant health component to the at least one synthetic surfactant is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 40. The turf grass treatment composition of embodiment 1 further comprising at least one inert component.

Embodiment 41. The turf grass treatment composition of embodiment 40 wherein the at least one inert component comprises water.

Embodiment 42. The turf grass treatment composition of embodiment 40 wherein the at least one inert component is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the turf grass treatment composition.

Embodiment 43. The turf grass treatment composition of embodiment 40 wherein the weight ratio of the at least one biosurfactant to the at least one inert component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 44. The turf grass treatment composition of embodiment 40 wherein the weight ratio of the at least one synthetic surfactant to the at least one inert component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 45. The turf grass treatment composition of embodiment 40 wherein the weight ratio of the at least one plant health component to the at least one inert component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 46. The turf grass treatment composition of embodiment 1 which is a synergistic turf grass treatment composition.

Embodiment 47. The turf grass treatment composition of embodiment 46 wherein the synergistic turf grass treatment composition comprising at least two biosurfactants, or at least one biosurfactant and at least one plant health component, or at least one biosurfactant and at least one synthetic surfactant, or at least one biosurfactant, at least one plant health component, and at least one synthetic surfactant, produces, when applied to turf grass, or to roots of the turf grass, or to soil in which the turf grass grows, a combined promoting or enhancing effect of at least one of bioenzyme activity and bioenzyme production in the turf grass, greater than the sum of the separate promoting or enhancing effects of at least one of bioenzyme activity and bioenzyme production in the turf grass, at essentially the same concentrations.

Embodiment 48. The turf grass treatment composition of embodiment 1 wherein the turf grass is selected from the group consisting of: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); zoysia grass (Zoysia spp.); Bahia grass (Paspalum notatum); carpet grass (Axonopus affinis); centipede grass (Eremochloa ophiuroides); kikuyu grass (Pennisetum clandesinum); seashore paspalum (Paspalum vaginatum); floratam (Stenotaphrum secundatum “Floratam”); blue gramma (Bouteloua gracilis); buffalo grass (Buchloe dactyloids); and/or sideoats gramma (Bouteloua curtipendula).

Embodiment 49. The turf grass treatment composition of embodiment 20 wherein the bioenzyme is selected from the group consisting of hydrolases, oxidoreductases, lyases, transferases, ligases, isomerases, and combinations thereof.

Embodiment 50. The turf grass treatment composition of embodiment 49 wherein a cofactor is associated with the bioenzyme.

Embodiment 51. The turf grass treatment composition of embodiment 50 wherein the cofactor is selected from the group consisting of prosthetic groups, coenzymes, metal ions, and combinations thereof.

Embodiment 52. The turf grass treatment composition of embodiment 1 which is applied to turf grass using an irrigation system.

Embodiment 53. The turf grass treatment composition of embodiment 1 which is applied to turf grass using a manual spreader, said spreader comprising a broadcast spreader, a drop spreader, a handheld spreader, or a handheld sprayer.

Embodiment 54. The turf grass treatment composition of embodiment 1 wherein the turf grass is in the form of sod comprising turf grass and a layer of soil held together by the roots of the turf grass and forming a sheet.

Embodiment 55. The turf grass treatment composition of embodiment 1 which is applied to a field or pitch planted with the turf grass.

Embodiment 56. The turf grass treatment composition of embodiment 55 wherein the field is used for athletics and/or recreation.

Embodiment 57. The turf grass treatment composition of embodiment 55 wherein the field is a park, campground, amphitheater, golf course, horse track, soccer field, football field, lacrosse field, field hockey field, cricket field, rugby field, polo field, softball field or baseball field.

Embodiment 58. The turf grass treatment composition of embodiment 1 which, when applied to turf grass, or to roots of the turf grass, or to soil in which the turf grass grows, helps prevent the occurrence of holes and/or divots in the field as a result of athletic or recreational use.

Embodiment 59. The turf grass treatment composition of embodiment 1 which, when applied to turf grass, or to roots of the turf grass, or to soil in which the turf grass grows, increases safety of participating in athletics or recreation on the field by preventing injuries caused by stepping in a hole and/or divot.

Embodiment 60. The turf grass treatment composition of embodiment 1 which is a microbe-based composition.

Embodiment 61. A turf grass treatment composition comprising at least one biosurfactant, at least one plant health component, at least one synthetic surfactant, and at least one inert component.

Embodiment 62. The turf grass treatment composition of embodiment 61 wherein the at least one plant health component is a biostimulant.

Embodiment 63. The turf grass treatment composition of embodiment 61 wherein the at least one biosurfactant is rhamnolipid, the at least one biostimulant is seaweed/kelp, the at least one synthetic surfactant is alkyl polyglucoside (APG), and at least one inert component is water.

Embodiment 64. The turf grass treatment composition of embodiment 61 which is a synergistic turf grass treatment composition.

Embodiment 65. The turf grass treatment composition of embodiment 64 wherein the synergistic turf grass treatment composition comprising at least two biosurfactants, or at least one biosurfactant and at least one plant health component, or at least one biosurfactant and at least one synthetic surfactant, or at least one biosurfactant, at least one plant health component, and at least one synthetic surfactant, produces, when applied to turf grass, or to roots of the turf grass, or to soil in which the turf grass grows, a combined promoting or enhancing effect of at least one of bioenzyme activity and bioenzyme production in the turf grass, greater than the sum of the separate promoting or enhancing effects of at least one of bioenzyme activity and bioenzyme production in the turf grass, at essentially the same concentrations.

Embodiment 66. The turf grass treatment composition of embodiment 1 which is applied to the turf grass, or to roots of the turf grass, or to soil in which the turf grass grows, at a treatment rate from about 0.5 oz./1000 sq. ft. monthly to about 12 oz./1000 sq. ft. monthly, or from about 1.0 oz./1000 sq. ft. monthly to about 10 oz./1000 sq. ft. monthly, or from about 2.0 oz./1000 sq. ft. monthly to about 8 oz./1000 sq. ft. monthly.

Embodiment 67. The turf grass treatment composition of embodiment 1 wherein promoting or enhancing at least one of bioenzyme activity and bioenzyme production in the turf grass is measured by high-performance liquid chromatography-mass spectrometry (HPLC-MS).

Embodiment 68. A method of promoting or enhancing at least one of bioenzyme activity and bioenzyme production in turf grass, said method comprising: applying to the turf grass, or to roots of the turf grass, or to soil in which the turf grass grows, a composition comprising at least one biosurfactant; wherein the composition, when applied to turf grass, or to roots of the turf grass, or to soil in which the turf grass grows, is effective for promoting or enhancing at least one of bioenzyme activity and bioenzyme production in the turf grass.

Embodiment 69. The method of embodiment 68 wherein the composition is a synergistic composition comprising at least two biosurfactants, or at least one biosurfactant and at least one plant health component, or at least one biosurfactant and at least one synthetic surfactant, or at least one biosurfactant, at least one plant health component, and at least one synthetic surfactant, that produces, when applied to turf grass, or to roots of the turf grass, or to soil in which the turf grass grows, a combined promoting or enhancing effect of at least one of bioenzyme activity and bioenzyme production in the turf grass, greater than the sum of the separate promoting or enhancing effects of at least one of bioenzyme activity and bioenzyme production in the turf grass, at essentially the same concentrations.

### Turf Grass Treatment Compositions Having Two Or More Biosurfactants

Preferred embodiments of this disclosure with regard to turf grass treatment compositions having at least two biosurfactants are described in Embodiments 1-85 below.

Embodiment 1. A turf grass treatment composition comprising at least two biosurfactants; wherein the turf grass treatment composition, when applied to turf grass, or to roots of the turf grass, or to soil in which the turf grass grows, is effective for promoting or enhancing quality of the turf grass.

Embodiment 2. The turf grass treatment composition of embodiment 1 wherein the at least two biosurfactants are a growth byproduct of a microorganism.

Embodiment 3. The turf grass treatment composition of embodiment 2 wherein the microorganism is a genetically-modified (GM) microorganism or a non-genetically (non-GM) modified microorganism.

Embodiment 4. The turf grass treatment composition of embodiment 3 wherein the microorganism is selected from the group consisting of bacteria, yeast, and fungi.

Embodiment 5. The turf grass treatment composition of embodiment 1 wherein the at least two biosurfactants are selected from the group consisting of glycolipids, lipopeptides, phospholipids, fatty acids, and polymeric surfactants.

Embodiment 6. The turf grass treatment composition of embodiment 1 wherein the at least two biosurfactants are glycolipids.

Embodiment 7. The turf grass treatment composition of embodiment 1 wherein the at least two biosurfactants are glycolipids selected from the group consisting of rhamnolipid, sophorolipid, mannosylerythritol lipid, and trehalose lipid.

Embodiment 8. The turf grass treatment composition of embodiment 1 wherein the at least two biosurfactants are rhamnolipid and sophorolipid.

Embodiment 9. The turf grass treatment composition of embodiment 2 wherein the microorganism is selected from the group consisting of Starmerella sp., Pichia sp., Pseudomonas sp. (P. aeruginosa, P. putida, P. florescens, P. Tragi, P. syringae); Flavobacterium spp.; Bacillus spp. (B. subtilis, B. pumillus, B. cereus, B. licheniformis); Candida species (C. albicans, C. rugosa, C. tropicalis, C. lipolytica, C. torulopsis); Rhodococcus sp.; Arthrobacter spp.; campylobacter spp.; and cornybacterium spp.; and combinations thereof; wherein the microorganism is a genetically-modified (GM) microorganism or a non-genetically (non-GM) modified microorganism.

Embodiment 10. The turf grass treatment composition of embodiment 4 wherein the bacteria is selected from the group consisting of: Pseudomonas sp., Pseudomonas guguanensis, Pseudomonas putida, Pseudomonas aeruginosa, Pseudomonas fluorescens, Pseudomonas aeruginosa, Pseudomonas aeruginosa, Pseudomonas stutzeri; and combinations thereof; wherein the bacteria is a genetically-modified (GM) bacteria or a non-genetically (non-GM) modified bacteria.

Embodiment 11. The turf grass treatment composition of embodiment 4 wherein the bacteria is selected from the group consisting of: Bacillus sp., Bacillus subtilis,; Bacillus sphaericus, Bacillus azotoformans,; Bacillus subtilis, Bacillus sp., Bacillus subtilis, Bacillus licheniformis, Bacillus subtilis,; Bacillus subtilis; and combinations thereof; wherein the bacteria is a genetically-modified (GM) bacteria or a non-genetically (non-GM) modified bacteria.

Embodiment 12. The turf grass treatment composition of embodiment 4 wherein the bacteria is selected from the group consisting of: Bordetella hinzii; Klebsiella pneumoniae; Ochrobactrum anthropi, Citrobacter freundii; Pseudoxanthomonas sp., Nocardia otitidiscaviarum; Serratia marcescens, Stenotrophomonas maltophilia; Virgibacillus salarius, Stenotrophomonas sp., Aeromonas salmonicida; Gordonia polyisoprenivorans; Burkholderia thailandensis, Pseudoxanthomonas sp., Ralstonia pickettii, Alcaligenes piechaudii; Gordonia sp.; and combinations thereof; wherein the bacteria is a genetically-modified (GM) bacteria or a non-genetically (non-GM) modified bacteria.

Embodiment 13. The turf grass treatment composition of embodiment 4 wherein the fungi is selected from the group consisting of: filamentous fungi such as Penicillium citrinum; Aspergillus flavus; Penicillium chrysogenum, Fusarium sp.; Fusarium oxysporum; Cunninghamella echinulate; and combinations thereof; wherein the fungi are genetically-modified (GM) fungi or non-genetically (non-GM) modified fungi.

Embodiment 14. The turf grass treatment composition of embodiment 4 wherein the yeast is selected from the group consisting of: Cryptococcus curvatus; Pichia anomala, Starmerella bombicola, Candida bombicola, Candida lipolytica; Candida lipolytica; Candida antarctica, Ustilago scitaminea, Pseudozyma tsukubaensis, Pseudozyma fusifornata, Pseudozyma parantarctica, Pseudozyma aphidis, Kluyveromyces marxianus, Kurtzmanomyces sp., Pseudozyma siamensis,; Wickerhamomyces anomalus, Candida antarctica, Candida apicola; and combinations thereof; wherein the yeast is a genetically-modified (GM) yeast or a non-genetically (non-GM) modified yeast.

Embodiment 15. The turf grass treatment composition of embodiment 2 wherein the microorganism is produced by a production or cultivation process selected from the group consisting of submerged cultivation/fermentation, surface cultivation, solid state fermentation, and combinations thereof; wherein the production or cultivation process is carried out under aerobic or anaerobic conditions.

Embodiment 16. The turf grass treatment composition of embodiment 15 wherein the production or cultivation process utilizes food/energy source(s) for microorganism growth.

Embodiment 17. The turf grass treatment composition of embodiment 16 wherein the food/energy source(s) are selected from the group consisting of: carbon sources including carbohydrates, alcohols, organic acids, fats, and oils; and combinations thereof; agro-industrial wastes, vegetable oil mill effluents including coconut oil, canola oil, olive oil, grape seed oil, palm oil, rapeseed oil, sunflower oil, soybean oil; dairy and sugar industry byproducts including buttermilk, whey, molasses; starch industry extract and wastes including corn, potatoes, tapioca, wheat; wherein the food/energy source(s) are genetically-modified (GM) or non-genetically (non-GM) modified.

Embodiment 18. The turf grass treatment composition of embodiment 1 wherein the at least two biosurfactants are present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

Embodiment 19. The turf grass treatment composition of embodiment 1 further comprising at least one plant health component.

Embodiment 20. The turf grass treatment composition of embodiment 19 wherein the at least one plant health component is selected from the group consisting of a biostimulant, bioenzyme, nutrient(s) for microorganism growth, nutrient(s) for plant growth, fertilizer, pesticide, herbicide, other microorganism based composition(s); and combinations thereof.

Embodiment 21. The turf grass treatment composition of embodiment 20 wherein the at least one plant health component is at least one biostimulant.

Embodiment 22. The turf grass treatment composition of embodiment 21 wherein the at least one biostimulant is selected from the group consisting of plant hormones, microbes selected from bacteria, yeast, and fungi; humic substances, seaweed extracts, protein hydrolysates, chitosan, inorganic compounds, and metabolites.

Embodiment 23. The turf grass treatment composition of embodiment 21 wherein the at least one biostimulant is selected from the group consisting of humic substances, humins, fulvic acids, fatty acids/lipids, peptides, amino acids, organic acids, carboxyls, B vitamins, protein hydrolysates, plant growth promoting bacteria (PGPR), cytokinins, rhizobium, mycorrhizae, trichoderma, fungi, microbial complex communities/consortia, phytohormones, seaweed/kelp, laminarin, alginates, polysaccharides, polyphenols, botanicals, allelochemicals, organic matter extracts, chitin, chitosan, betaines, polyamines, inorganic salts, proteins, elements selected from silicon (Si), sodium (Na) and cobalt (Co), phosphites, nitrogeneous compounds, and enzymatic extracts.

Embodiment 24. The turf grass treatment composition of embodiment 22 wherein the yeast or fungi are selected from the group consisting of Aureobasidium (e.g., A. pullulans), Blakeslea, Candida (e.g., C. apicola, C. bombicola, C. nodaensis), Cryptococcus, Debaryomyces (e.g., D. hansenii), Entomophthora, Hanseniaspora, (e.g., H. uvarum), Hansenula, Issatchenkia, Kluyveromyces (e.g., K. phaffii), Mortierella, mycorrhizal fungi, Penicillium, Phycomyces, Pichia (e.g., P. anomala, P. guilliermondii, P. occidentalis, P. kudriavzevii), Pleurotus spp. (e.g., P. ostreatus), Pseudozyma (e.g., P. aphidis), Saccharomyces (e.g., S. boulardii sequela, S. cerevisiae, S. torula), Starmerella (e.g., S. bombicola), Torulopsis, Trichoderma (e.g., T. reesei, T. harzianum, T. hamatum, T. viride), Ustilago (e.g., U. maydis), Wickerhamomyces (e.g., W. anomalus), Williopsis (e.g., W. mrakii), and Zygosaccharomyces (e.g., Z. bailii).

Embodiment 25. The turf grass treatment composition of embodiment 22 wherein the bacteria are selected from the group consisting of Gram-positive and Gram-negative bacteria, rhizobacteria, Agrobacterium (e.g., A. radiobacter), Azotobacter (A. vinelandii, A. chroococcum), Azospirillum (e.g., A. brasiliensis), Bacillus (e.g., B. amyloliquifaciens, B. circulans, B. firmus, B. laterosporus, B. licheniformis, B. megaterium, Bacillus mucilaginosus, B. subtilis), Frateuria (e.g., F. aurantia), Microbacterium (e.g., M. laevaniformans), myxobacteria (e.g., Myxococcus xanthus, Stignatella aurantiaca, Sorangium cellulosum, Minicystis rosea), Pantoea (e.g., P. agglomerans), Pseudomonas (e.g., P. aeruginosa, P. chlororaphis subsp. aureofaciens (Kluyver), P. putida), Rhizobium spp., Rhodospirillum (e.g., R. rubrum), Sphingomonas (e.g., S. paucimobilis), and Thiobacillus thiooxidans (Acidothiobacillus thiooxidans).

Embodiment 26. The turf grass treatment composition of embodiment 21 wherein the at least one plant health component is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

Embodiment 27. The turf grass treatment composition of embodiment 21 wherein the weight ratio of the at least two biosurfactants to the at least one plant health component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 28. The turf grass treatment composition of embodiment 1 further comprising at least one synthetic surfactant.

Embodiment 29. The turf grass treatment composition of embodiment 28 wherein the at least one synthetic surfactant is selected from the group consisting of anionic surfactants, nonionic surfactants, cationic surfactants, amphoteric or zwitterionic surfactants, and combinations thereof.

Embodiment 30. The turf grass treatment composition of embodiment 29 wherein the nonionic surfactant is selected from the group consisting of polyoxyethylene (POE) surfactants, block copolymer surfactants, straight block copolymer surfactants, reverse block copolymer surfactants, alkyl polyglucoside (APG) surfactants, modified methyl capped block copolymer surfactants, humic substance redistribution molecules, and multibranched regenerating wetting agents.

Embodiment 31. The turf grass treatment composition of embodiment 29 wherein the nonionic surfactant is selected from the group consisting of alkyl polyglucosides (APGs), fatty alcohol ethoxylates, alkyl phenol ethoxylates, fatty acid alkoxylates, and combinations thereof.

Embodiment 32. The turf grass treatment composition of embodiment 29 wherein the nonionic surfactant is selected from the group consisting of alcohol ethoxylates, alkanolamides, alkanolamine condensates, carboxylic acid esters, cetostearyl alcohol, cetyl alcohol, cocamide DEA, dodecyldimethylamine oxides, ethanolamides, ethoxylates of glycerol ester and glycol esters, ethylene oxide polymers, ethylene oxide-propylene oxide copolymers, glucoside alkyl ethers, glycerol alkyl ethers, glycerol esters, glycol alkyl ethers (e.g., polyoxyethylene glycol alkyl ethers, polyoxypropylene glycol alkyl ethers), glycol alkylphenol ethers (e.g., polyoxyethylene glycol alkylphenol ethers,), glycol esters, monolaurin, pentaethylene glycol monododecyl ethers, poloxamer, polyamines, polyglycerol polyricinoleate, polysorbate, polyoxyethylenated fatty acids, polyoxyethylenated mercaptans, polyoxyethylenated polyoxyproylene glycols, polyoxyethylene glycol sorbitan alkyl esters, polyethylene glycol-polypropylene glycol copolymers, polyoxyethylene glycol octylphenol ethers, polyvinyl pynolidones, sugar-based alkyl polyglycosides, sulfoanylamides, sorbitan fatty acid alcohol ethoxylates, sorbitan fatty acid ester ethoxylates, sorbitan fatty acid ester, and tertiary acetylenic glycols.

Embodiment 33. The turf grass treatment composition of embodiment 29 wherein the anionic surfactant is selected from the group consisting of alkyl carboxylates (e.g., sodium stearate), alkyl sulfates (e.g., alkyl lauryl sulfate, sodium lauryl sulfate), alkyl ether sulfates, alkyl amido ether sulfates, alkyl aryl polyether sulfates, alkyl aryl sulfates, alkyl aryl sulfonates, alkyl sulfonates, alkyl amide sulfonates, alkyl aryl sulfonates, alkyl benzene sulfonates, alkyl diphenyloxide sulfonate, alpha-olefin sulfonates, alkyl naphthalene sulfonates, paraffin sulfonates, alkyl sulfosuccinates, alkyl ether sulfosuccinates, alkylamide sulfosuccinates, alkyl sulfosuccinamates, alkyl sulfoacetates, alkyl phosphates, alkyl ether phosphates, acyl sarconsinates, acyl isethionates, N-acyl taurates, N-acyl-N-alkyltaurates, benzene sulfonates, cumene sulfonates, dioctyl sodium sulfosuccinate, ethoxylated sulfosuccinates, lignin sulfonates, linear alkylbenzene sulfonates, monoglyceride sulfates, perfluorobutanesulfonate, perfluorooctanesulfonate, phosphate ester, styrene acrylic polymers, toluene sulfonates, and xylene sulfonates.

Embodiment 34. The turf grass treatment composition of embodiment 29 wherein the cationic surfactant is selected from the group consisting of alkyltrimethylammonium salts (e.g., cetyl trimethylammonium bromide, cetyl trimethylammonium chloride), cetylpyridinium chloride, benzalkonium chloride, benzethonium chloride, 5-bromo-5-nitro-1,3-dioxane, dimethyldioctadecylammonium chloride, cetrimonium bromide, dioctadecyldimethylammonium bromide, and octenidine dihydrochloride.

Embodiment 35. The turf grass treatment composition of embodiment 29 wherein the amphoteric or zwitterionic surfactant is selected from the group consisting of 3 [(3-cholamidopropyl)dimethylammonio]-1-propanesulfonate, cocamidopropyl betaine, cocamidopropyl hydroxysultaine, phosphatidylserine, phosphatidylethanolamine, phosphatidylcholine, and sphingomyelins.

Embodiment 36. The turf grass treatment composition of embodiment 28 wherein the at least one synthetic surfactant is from a naturally-derived source.

Embodiment 37. The turf grass treatment composition of embodiment 28 wherein the at least one synthetic surfactant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the turf grass treatment composition.

Embodiment 38. The turf grass treatment composition of embodiment 28 wherein the weight ratio of the at least two biosurfactants to the at least one synthetic surfactant is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 39. The turf grass treatment composition of embodiment 28 wherein the weight ratio of the at least one plant health component to the at least one synthetic surfactant is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 40. The turf grass treatment composition of embodiment 1 further comprising at least one inert component.

Embodiment 41. The turf grass treatment composition of embodiment 40 wherein the at least one inert component comprises water.

Embodiment 42. The turf grass treatment composition of embodiment 40 wherein the at least one inert component is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the turf grass treatment composition.

Embodiment 43. The turf grass treatment composition of embodiment 40 wherein the weight ratio of the at least two biosurfactants to the at least one inert component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 44. The turf grass treatment composition of embodiment 40 wherein the weight ratio of the at least one synthetic surfactant to the at least one inert component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 45. The turf grass treatment composition of embodiment 40 wherein the weight ratio of the at least one plant health component to the at least one inert component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 46. The turf grass treatment composition of embodiment 20 wherein the bioenzyme is selected from the group consisting of hydrolases, oxidoreductases, lyases, transferases, ligases, isomerases, and combinations thereof.

Embodiment 47. The turf grass treatment composition of embodiment 46 wherein a cofactor is associated with the bioenzyme.

Embodiment 48. The turf grass treatment composition of embodiment 47 wherein the cofactor is selected from the group consisting of prosthetic groups, coenzymes, metal ions, and combinations thereof.

Embodiment 49. The turf grass treatment of embodiment 1, which when applied to turf grass, or to roots of the turf grass, or to soil in which the turf grass grows, is effective for promoting or enhancing at least one of bioenzyme activity and bioenzyme production in the turf grass.

Embodiment 50. The turf grass treatment composition of embodiment 1 which, when applied to turf grass, or to roots of the turf grass, or to soil in which the turf grass grows, enhances quality of the turf grass by enhancing initial water uptake or wetting, rewetting and/or water retention over time of said turf grass.

Embodiment 51. The turf grass treatment composition of embodiment 1 which, when applied to turf grass, or to roots of the turf grass, or to soil in which the turf grass grows, enhances quality of the turf grass by enhancing surface tension reduction, increasing speed to wet, increasing water retention, and/or increasing time to dry between watering events.

Embodiment 52. The turf grass treatment composition of embodiment 1 which, when applied to turf grass, or to roots of the turf grass, or to soil in which the turf grass grows, enhances quality of the turf grass by enhancing root structure and growth, nutrient use efficiency, water use efficiency, stress tolerance, disease tolerance, and/or inducing systemic resistance.

Embodiment 53. The turf grass treatment composition of embodiment 1 which, when applied to turf grass, or to roots of the turf grass, or to soil in which the turf grass grows, enhances quality of the turf grass by enhancing strength of the turf grass roots by increasing root density, increasing root diameter, and/or increasing root depth.

Embodiment 54. The turf grass treatment composition of embodiment 1 which, when applied to turf grass, or to roots of the turf grass, or to soil in which the turf grass grows, enhances quality of the turf grass by increasing or enhancing photosynthesis; photochemical activity; root enzyme activity; root mass; stress tolerance due to the production of superoxide dismutase enzymes; cytokinin activity under drying conditions to stimulate cell division; leaf moisture; a-tocopherol (vitamin E) and ascorbic acid (vitamin C) antioxidants found in chloroplasts; chlorophyll content; root length; shoot growth; phosphorus uptake; salt tolerance; leaf tissue nitrogen (N), phosphorus (P), potassium (K) and iron (Fe); soil moisture; and/or microbiome.

Embodiment 55. The turf grass treatment composition of embodiment 1 which, when applied to turf grass, or to roots of the turf grass, or to soil in which the turf grass grows, enhances quality of the turf grass by making the nutrients far more recognizable to the turf grass; limiting temperature stress, drought stress, heavy metal stress, and low mowing heights; amino acid proline scavenges hydroxyl radicals by increasing superoxide dismutase (SOD); protein biosynthesis improvement; increasing chlorophyll content; increasing germination; stimulating carbon and nitrogen metabolism; and/or stimulating turf grass microbiomes.

Embodiment 56. The turf grass treatment composition of embodiment 1 which, when applied to turf grass, or to roots of the turf grass, or to soil in which the turf grass grows, enhances quality of the turf grass by increasing or enhancing leaf count, amino acid proline scavenges hydroxyl radicals by increasing superoxide dismutase (SOD); proline dehydrogenase production/stress adaption; chlorophyll content; germination; and/or vertical leaf growth.

Embodiment 57. The turf grass treatment composition of embodiment 1 which, when applied to turf grass, or to roots of the turf grass, or to soil in which the turf grass grows, enhances quality of the turf grass by strengthening cell walls by silica deposits; promoting turf grass growth; inducing tolerance to abiotic stress (drought, salinity, cold stress); inducing cell wall rigidification, osmoregulation, reducing transpiration; influencing osmotic, pH, and redox homeostasis; and/or influencing hormone signaling and enzymes involved in stress response.

Embodiment 58. The turf grass treatment composition of embodiment 1 which, when applied to turf grass, or to roots of the turf grass, or to soil in which the turf grass grows, enhances quality of the turf grass by providing defense against abiotic stress; leaf and stem strength through deposition in the cuticle; maintaining cell wall polysaccharide and lignin polymersproline; wear resistance; heat and drought stressed resistance; growth and establishment; water use efficiency; salt stress tolerance; leaf blade stiffness; and/or better ball roll.

Embodiment 59. The turf grass treatment composition of embodiment 1 which, when applied to turf grass, or to roots of the turf grass, or to soil in which the turf grass grows, enhances quality of the turf grass by increasing or enhancing uptake of macro- and micronutrients; root mass and surface area; cytokinin content; drought stress tolerance; arbuscule-forming mycorrhiza fungal may reduce Poa annua on golf greens; chlorophyll content; absorption of mineral elements such as phosphorus (P), iron (Fe), copper (Cu), magnesium (Mg), potassium (K), boron (B), silicon (Si), sulfur(S), and nitrogen (N); above ground biomass; water use efficiency; less irrigation in summer; and/or less artificial fertilizer for the same results.

Embodiment 60. The turf grass treatment composition of embodiment 1 which, when applied to turf grass, or to roots of the turf grass, or to soil in which the turf grass grows, enhances quality of the turf grass by enhancing health, growth and/or sturdiness of the turf grass.

Embodiment 61. The turf grass treatment composition of embodiment 1 which, when applied to turf grass, or to roots of the turf grass, or to soil in which the turf grass grows, enhances quality of the turf grass by enhancing turf grass color, turf grass shoot density, and/or turf grass greenness.

Embodiment 62. The turf grass treatment composition of embodiment 1 which is a synergistic turf grass treatment composition.

Embodiment 63. The turf grass treatment composition of embodiment 62 wherein the synergistic turf grass treatment composition comprising at least two biosurfactants, produces, when applied to turf grass, or to roots of the turf grass, or to soil in which the turf grass grows, a combined turf grass quality effect, greater than the sum of the separate turf grass quality effects, at essentially the same concentrations.

Embodiment 64. The turf grass treatment composition of embodiment 62 wherein the synergistic turf grass treatment composition comprising at least two biosurfactants, produces, when applied to turf grass, or to roots of the turf grass, or to soil in which the turf grass grows, a combined promoting or enhancing effect of at least one of bioenzyme activity and bioenzyme production in the turf grass, greater than the sum of the separate promoting or enhancing effects of at least one of bioenzyme activity and bioenzyme production in the turf grass, at essentially the same concentrations.

Embodiment 65. The turf grass treatment composition of embodiment 1 wherein the turf grass is selected from the group consisting of: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); zoysia grass (Zoysia spp.); Bahia grass (Paspalum notatum); carpet grass (Axonopus affinis); centipede grass (Eremochloa ophiuroides); kikuyu grass (Pennisetum clandesinum); seashore paspalum (Paspalum vaginatum); floratam (Stenotaphrum secundatum “Floratam”); blue gramma (Bouteloua gracilis); buffalo grass (Buchloe dactyloids); and/or sideoats gramma (Bouteloua curtipendula).

Embodiment 66. The turf grass treatment composition of embodiment 1 which is applied to turf grass using an irrigation system.

Embodiment 67. The turf grass treatment composition of embodiment 1 which is applied to turf grass using a manual spreader, said spreader comprising a broadcast spreader, a drop spreader, a handheld spreader, or a handheld sprayer.

Embodiment 68. The turf grass treatment composition of embodiment 1 wherein the turf grass is in the form of sod comprising turf grass and a layer of soil held together by the roots of the turf grass and forming a sheet.

Embodiment 69. The turf grass treatment composition of embodiment 1 wherein the composition is applied to a field or pitch planted with the turf grass.

Embodiment 70. The turf grass treatment composition of embodiment 69 wherein the field is used for athletics and/or recreation.

Embodiment 71. The turf grass treatment composition of embodiment 69 wherein the field is a park, campground, amphitheater, golf course, horse track, soccer field, football field, lacrosse field, field hockey field, cricket field, rugby field, polo field, softball field or baseball field.

Embodiment 72. The turf grass treatment composition of embodiment 69 which, when applied to turf grass, or to roots of the turf grass, or to soil in which the turf grass grows, helps prevent the occurrence of holes and/or divots in the field as a result of athletic or recreational use.

Embodiment 73. The turf grass treatment composition of embodiment 1 which, when applied to turf grass, or to roots of the turf grass, or to soil in which the turf grass grows, increases safety of participating in athletics or recreation on the field by preventing injuries caused by stepping in a hole and/or divot.

Embodiment 74. The turf grass treatment composition of embodiment 1 which is a microbe-based composition.

Embodiment 75. A turf grass treatment composition comprising at least two biosurfactants, at least one plant health component, at least one synthetic surfactant, and at least one inert component.

Embodiment 76. The turf grass treatment composition of embodiment 75 wherein the at least one plant health component is a biostimulant.

Embodiment 77. The turf grass treatment composition of embodiment 76 wherein the at least two biosurfactants are rhamnolipid and sophorolipid, the at least one biostimulant is seaweed/kelp, the at least one synthetic surfactant is alkyl polyglucoside (APG), and at least one inert component is water.

Embodiment 78. The turf grass treatment composition of embodiment 75 which is a synergistic turf grass treatment composition.

Embodiment 79. The turf grass treatment composition of embodiment 78 wherein the synergistic turf grass treatment composition comprising at least two biosurfactants, produces, when applied to turf grass, or to roots of the turf grass, or to soil in which the turf grass grows, a combined turf grass quality effect, greater than the sum of the separate turf grass quality effects, at essentially the same concentrations.

Embodiment 80. The turf grass treatment composition of embodiment 78 wherein the synergistic turf grass treatment composition comprising at least two biosurfactants, produces, when applied to turf grass, or to roots of the turf grass, or to soil in which the turf grass grows, a combined promoting or enhancing effect of at least one of bioenzyme activity and bioenzyme production in the turf grass, greater than the sum of the separate promoting or enhancing effects of at least one of bioenzyme activity and bioenzyme production in the turf grass, at essentially the same concentrations.

Embodiment 81. The turf grass treatment composition of embodiment 1 which is applied to the turf grass, or to roots of the turf grass, or to soil in which the turf grass grows, at a treatment rate from about 0.5 oz./1000 sq. ft. monthly to about 12 oz./1000 sq. ft. monthly, or from about 1.0 oz./1000 sq. ft. monthly to about 10 oz./1000 sq. ft. monthly, or from about 2.0 oz./1000 sq. ft. monthly to about 8 oz./1000 sq. ft. monthly.

Embodiment 82. The turf grass treatment composition of embodiment 49 wherein promoting or enhancing at least one of bioenzyme activity and bioenzyme production in the turf grass is measured by high-performance liquid chromatography-mass spectrometry (HPLC-MS).

Embodiment 83. A method of promoting or enhancing quality of turf grass, said method comprising: applying to the turf grass, or to roots of the turf grass, or to soil in which the turf grass grows, a composition comprising at least two biosurfactants; wherein the composition, when applied to turf grass, or to roots of the turf grass, or to soil in which the turf grass grows, is effective for promoting or enhancing quality of the turf grass.

Embodiment 84. The method of embodiment 83 wherein the composition is a synergistic turf grass treatment composition comprising at least two biosurfactants, that produces, when applied to turf grass, or to roots of the turf grass, or to soil in which the turf grass grows, a combined turf grass quality effect, greater than the sum of the separate turf grass quality effects, at essentially the same concentrations.

Embodiment 85. The method of embodiment 83 wherein the composition, when applied to turf grass, or to roots of the turf grass, or to soil in which the turf grass grows, is effective for promoting or enhancing at least one of bioenzyme activity and bioenzyme production in the turf grass.

### Turf Grass Treatment Compositions Having One Or More Biosurfactant(s)+One Or More Plant Health Component(s)

Preferred embodiments of this disclosure with regard to turf grass treatment compositions having at least one biosurfactant and at least one plant health component are described in Embodiments 1-84 below.

Embodiment 1. A turf grass treatment composition comprising at least one biosurfactant and at least one plant health component; wherein the turf grass treatment composition, when applied to turf grass, or to roots of the turf grass, or to soil in which the turf grass grows, is effective for promoting or enhancing quality of the turf grass.

Embodiment 2. The turf grass treatment composition of embodiment 1 wherein the at least one biosurfactant is a growth byproduct of a microorganism.

Embodiment 3. The turf grass treatment composition of embodiment 2 wherein the microorganism is a genetically-modified (GM) microorganism or a non-genetically (non-GM) modified microorganism.

Embodiment 4. The turf grass treatment composition of embodiment 2 wherein the microorganism is selected from the group consisting of bacteria, yeast, and fungi.

Embodiment 5. The turf grass treatment composition of embodiment 1 wherein the at least one biosurfactant is selected from the group consisting of glycolipids, lipopeptides, phospholipids, fatty acids, and polymeric surfactants.

Embodiment 6. The turf grass treatment composition of embodiment 1 wherein the at least one biosurfactant is a glycolipid.

Embodiment 7. The turf grass treatment composition of embodiment 1 wherein the at least one biosurfactant is a glycolipid selected from the group consisting of rhamnolipid, sophorolipid, mannosylerythritol lipid, and trehalose lipid.

Embodiment 8. The turf grass treatment composition of embodiment 1 wherein the at least one biosurfactant is rhamnolipid.

Embodiment 9. The turf grass treatment composition of embodiment 2 wherein the microorganism is selected from the group consisting of Starmerella sp., Pichia sp., Pseudomonas sp. (P. aeruginosa, P. putida, P. florescens, P. Tragi, P. syringae); Flavobacterium spp.; Bacillus spp. (B. subtilis, B. pumillus, B. cereus, B. licheniformis); Candida species (C. albicans, C. rugosa, C. tropicalis, C. lipolytica, C. torulopsis); Rhodococcus sp.; Arthrobacter spp.; campylobacter spp.; and cornybacterium spp.; and combinations thereof; wherein the microorganism is a genetically-modified (GM) microorganism or a non-genetically (non-GM) modified microorganism.

Embodiment 10. The turf grass treatment composition of embodiment 4 wherein the bacteria is selected from the group consisting of: Pseudomonas sp., Pseudomonas guguanensis, Pseudomonas putida, Pseudomonas aeruginosa, Pseudomonas fluorescens, Pseudomonas aeruginosa, Pseudomonas aeruginosa, Pseudomonas stutzeri; and combinations thereof; wherein the bacteria is a genetically-modified (GM) bacteria or a non-genetically (non-GM) modified bacteria.

Embodiment 11. The turf grass treatment composition of embodiment 4 wherein the bacteria is selected from the group consisting of: Bacillus sp., Bacillus subtilis,; Bacillus sphaericus, Bacillus azotoformans,; Bacillus subtilis, Bacillus sp., Bacillus subtilis, Bacillus licheniformis, Bacillus subtilis,; Bacillus subtilis; and combinations thereof; wherein the bacteria is a genetically-modified (GM) bacteria or a non-genetically (non-GM) modified bacteria.

Embodiment 12. The turf grass treatment composition of embodiment 4 wherein the bacteria is selected from the group consisting of: Bordetella hinzii; Klebsiella pneumoniae; Ochrobactrum anthropi, Citrobacter freundii; Pseudoxanthomonas sp., Nocardia otitidiscaviarum; Serratia marcescens, Stenotrophomonas maltophilia; Virgibacillus salarius, Stenotrophomonas sp., Aeromonas salmonicida; Gordonia polyisoprenivorans; Burkholderia thailandensis, Pseudoxanthomonas sp., Ralstonia pickettii, Alcaligenes piechaudii; Gordonia sp.; and combinations thereof; wherein the bacteria is a genetically-modified (GM) bacteria or a non-genetically (non-GM) modified bacteria.

Embodiment 13. The turf grass treatment composition of embodiment 4 wherein the fungi is selected from the group consisting of: filamentous fungi such as Penicillium citrinum; Aspergillus flavus; Penicillium chrysogenum, Fusarium sp.; Fusarium oxysporum; Cunninghamella echinulate; and combinations thereof; wherein the fungi are genetically-modified (GM) fungi or non-genetically (non-GM) modified fungi.

Embodiment 14. The turf grass treatment composition of embodiment 4 wherein the yeast is selected from the group consisting of: Cryptococcus curvatus; Pichia anomala, Starmerella bombicola, Candida bombicola, Candida lipolytica; Candida lipolytica; Candida antarctica, Ustilago scitaminea, Pseudozyma tsukubaensis, Pseudozyma fusifornata, Pseudozyma parantarctica, Pseudozyma aphidis, Kluyveromyces marxianus, Kurtzmanomyces sp., Pseudozyma siamensis,; Wickerhamomyces anomalus, Candida antarctica, Candida apicola; and combinations thereof; wherein the yeast is a genetically-modified (GM) yeast or a non-genetically (non-GM) modified yeast.

Embodiment 15. The turf grass treatment composition of embodiment 2 wherein the microorganism is produced by a production or cultivation process selected from the group consisting of submerged cultivation/fermentation, surface cultivation, solid state fermentation, and combinations thereof; wherein the production or cultivation process is carried out under aerobic or anaerobic conditions.

Embodiment 16. The turf grass treatment composition of embodiment 15 wherein the production or cultivation process utilizes food/energy source(s) for microorganism growth.

Embodiment 17. The turf grass treatment composition of embodiment 16 wherein the food/energy source(s) are selected from the group consisting of: carbon sources including carbohydrates, alcohols, organic acids, fats, and oils; and combinations thereof; agro-industrial wastes, vegetable oil mill effluents including coconut oil, canola oil, olive oil, grape seed oil, palm oil, rapeseed oil, sunflower oil, soybean oil; dairy and sugar industry byproducts including buttermilk, whey, molasses; starch industry extract and wastes including corn, potatoes, tapioca, wheat; wherein the food/energy source(s) are genetically-modified (GM) or non-genetically (non-GM) modified.

Embodiment 18. The turf grass treatment composition of embodiment 1 wherein the at least one biosurfactant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

Embodiment 19. The turf grass treatment composition of embodiment 1 wherein the at least one plant health component is selected from the group consisting of a biostimulant, bioenzyme, nutrient(s) for microorganism growth, nutrient(s) for plant growth, fertilizer, pesticide, herbicide, other microorganism based composition(s); and combinations thereof.

Embodiment 20. The turf grass treatment composition of embodiment 1 wherein the at least one plant health component is a biostimulant.

Embodiment 21. The turf grass treatment composition of embodiment 20 wherein the at least one biostimulant is selected from the group consisting of plant hormones, microbes selected from bacteria, yeast, and fungi; humic substances, seaweed extracts, protein hydrolysates, chitosan, inorganic compounds, and metabolites.

Embodiment 22. The turf grass treatment composition of embodiment 20 wherein the at least one biostimulant is selected from the group consisting of humic substances, humins, fulvic acids, fatty acids/lipids, peptides, amino acids, organic acids, carboxyls, B vitamins, protein hydrolysates, plant growth promoting bacteria (PGPR), cytokinins, rhizobium, mycorrhizae, trichoderma, fungi, microbial complex communities/consortia, phytohormones, seaweed/kelp, laminarin, alginates, polysaccharides, polyphenols, botanicals, allelochemicals, organic matter extracts, chitin, chitosan, betaines, polyamines, inorganic salts, proteins, elements selected from silicon (Si), sodium (Na) and cobalt (Co), phosphites, nitrogeneous compounds, and enzymatic extracts.

Embodiment 23. The turf grass treatment composition of embodiment 21 wherein the yeast or fungi are selected from the group consisting of Aureobasidium (e.g., A. pullulans), Blakeslea, Candida (e.g., C. apicola, C. bombicola, C. nodaensis), Cryptococcus, Debaryomyces (e.g., D. hansenii), Entomophthora, Hanseniaspora, (e.g., H. uvarum), Hansenula, Issatchenkia, Kluyveromyces (e.g., K. phaffii), Mortierella, mycorrhizal fungi, Penicillium, Phycomyces, Pichia (e.g., P. anomala, P. guilliermondii, P. occidentalis, P. kudriavzevii), Pleurotus spp. (e.g., P. ostreatus), Pseudozyma (e.g., P. aphidis), Saccharomyces (e.g., S. boulardii sequela, S. cerevisiae, S. torula), Starmerella (e.g., S. bombicola), Torulopsis, Trichoderma (e.g., T. reesei, T. harzianum, T. hamatum, T. viride), Ustilago (e.g., U. maydis), Wickerhamomyces (e.g., W. anomalus), Williopsis (e.g., W. mrakii), and Zygosaccharomyces (e.g., Z. bailii).

Embodiment 24. The turf grass treatment composition of embodiment 21 wherein the bacteria are selected from the group consisting of Gram-positive and Gram-negative bacteria, rhizobacteria, Agrobacterium (e.g., A. radiobacter), Azotobacter (A. vinelandii, A. chroococcum), Azospirillum (e.g., A. brasiliensis), Bacillus (e.g., B. amyloliquifaciens, B. circulans, B. firmus, B. laterosporus, B. licheniformis, B. megaterium, Bacillus mucilaginosus, B. subtilis), Frateuria (e.g., F. aurantia), Microbacterium (e.g., M. laevaniformans), myxobacteria (e.g., Myxococcus xanthus, Stignatella aurantiaca, Sorangium cellulosum, Minicystis rosea), Pantoea (e.g., P. agglomerans), Pseudomonas (e.g., P. aeruginosa, P. chlororaphis subsp. aureofaciens (Kluyver), P. putida), Rhizobium spp., Rhodospirillum (e.g., R. rubrum), Sphingomonas (e.g., S. paucimobilis), and Thiobacillus thiooxidans (Acidothiobacillus thiooxidans).

Embodiment 25. The turf grass treatment composition of embodiment 1 wherein the at least one plant health component is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

Embodiment 26. The turf grass treatment composition of embodiment 1 wherein the weight ratio of the at least one biosurfactant to the at least one plant health component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 27. The turf grass treatment composition of embodiment 1 further comprising at least one synthetic surfactant.

Embodiment 28. The turf grass treatment composition of embodiment 27 wherein the at least one synthetic surfactant is selected from the group consisting of anionic surfactants, nonionic surfactants, cationic surfactants, amphoteric or zwitterionic surfactants, and combinations thereof.

Embodiment 29. The turf grass treatment composition of embodiment 28 wherein the nonionic surfactant is selected from the group consisting of polyoxyethylene (POE) surfactants, block copolymer surfactants, straight block copolymer surfactants, reverse block copolymer surfactants, alkyl polyglucoside (APG) surfactants, modified methyl capped block copolymer surfactants, humic substance redistribution molecules, and multibranched regenerating wetting agents.

Embodiment 30. The turf grass treatment composition of embodiment 28 wherein the nonionic surfactant is selected from the group consisting of alkyl polyglucosides (APGs), fatty alcohol ethoxylates, alkyl phenol ethoxylates, fatty acid alkoxylates, and combinations thereof.

Embodiment 31. The turf grass treatment composition of embodiment 28 wherein the nonionic surfactant is selected from the group consisting of alcohol ethoxylates, alkanolamides, alkanolamine condensates, carboxylic acid esters, cetostearyl alcohol, cetyl alcohol, cocamide DEA, dodecyldimethylamine oxides, ethanolamides, ethoxylates of glycerol ester and glycol esters, ethylene oxide polymers, ethylene oxide-propylene oxide copolymers, glucoside alkyl ethers, glycerol alkyl ethers, glycerol esters, glycol alkyl ethers (e.g., polyoxyethylene glycol alkyl ethers, polyoxypropylene glycol alkyl ethers), glycol alkylphenol ethers (e.g., polyoxyethylene glycol alkylphenol ethers,), glycol esters, monolaurin, pentacthylene glycol monododecyl ethers, poloxamer, polyamines, polyglycerol polyricinoleate, polysorbate, polyoxyethylenated fatty acids, polyoxyethylenated mercaptans, polyoxyethylenated polyoxyproylene glycols, polyoxyethylene glycol sorbitan alkyl esters, polyethylene glycol-polypropylene glycol copolymers, polyoxyethylene glycol octylphenol ethers, polyvinyl pynolidones, sugar-based alkyl polyglycosides, sulfoanylamides, sorbitan fatty acid alcohol ethoxylates, sorbitan fatty acid ester ethoxylates, sorbitan fatty acid ester, and tertiary acetylenic glycols.

Embodiment 32. The turf grass treatment composition of embodiment 28 wherein the anionic surfactant is selected from the group consisting of alkyl carboxylates (e.g., sodium stearate), alkyl sulfates (e.g., alkyl lauryl sulfate, sodium lauryl sulfate), alkyl ether sulfates, alkyl amido ether sulfates, alkyl aryl polyether sulfates, alkyl aryl sulfates, alkyl aryl sulfonates, alkyl sulfonates, alkyl amide sulfonates, alkyl aryl sulfonates, alkyl benzene sulfonates, alkyl diphenyloxide sulfonate, alpha-olefin sulfonates, alkyl naphthalene sulfonates, paraffin sulfonates, alkyl sulfosuccinates, alkyl ether sulfosuccinates, alkylamide sulfosuccinates, alkyl sulfosuccinamates, alkyl sulfoacetates, alkyl phosphates, alkyl ether phosphates, acyl sarconsinates, acyl isethionates, N-acyl taurates, N-acyl-N-alkyltaurates, benzene sulfonates, cumene sulfonates, dioctyl sodium sulfosuccinate, ethoxylated sulfosuccinates, lignin sulfonates, linear alkylbenzene sulfonates, monoglyceride sulfates, perfluorobutanesulfonate, perfluorooctanesulfonate, phosphate ester, styrene acrylic polymers, toluene sulfonates, and xylene sulfonates.

Embodiment 33. The turf grass treatment composition of embodiment 28 wherein the cationic surfactant is selected from the group consisting of alkyltrimethylammonium salts (e.g., cetyl trimethylammonium bromide, cetyl trimethylammonium chloride), cetylpyridinium chloride, benzalkonium chloride, benzethonium chloride, 5-bromo-5-nitro-1,3-dioxane, dimethyldioctadecylammonium chloride, cetrimonium bromide, dioctadecyldimethylammonium bromide, and octenidine dihydrochloride.

Embodiment 34. The turf grass treatment composition of embodiment 28 wherein the amphoteric or zwitterionic surfactant is selected from the group consisting of 3 [(3-cholamidopropyl)dimethylammonio]-1-propanesulfonate, cocamidopropyl betaine, cocamidopropyl hydroxysultaine, phosphatidylserine, phosphatidylethanolamine, phosphatidylcholine, and sphingomyelins.

Embodiment 35. The turf grass treatment composition of embodiment 27 wherein the at least one synthetic surfactant is from a naturally-derived source.

Embodiment 36. The turf grass treatment composition of embodiment 27 wherein the at least one synthetic surfactant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the turf grass treatment composition.

Embodiment 37. The turf grass treatment composition of embodiment 27 wherein the weight ratio of the at least one biosurfactant to the at least one synthetic surfactant is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 38. The turf grass treatment composition of embodiment 27 wherein the weight ratio of the at least one plant health component to the at least one synthetic surfactant is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 39. The turf grass treatment composition of embodiment 1 further comprising at least one inert component.

Embodiment 40. The turf grass treatment composition of embodiment 39 wherein the at least one inert component comprises water.

Embodiment 41. The turf grass treatment composition of embodiment 39 wherein the at least one inert component is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the turf grass treatment composition.

Embodiment 42. The turf grass treatment composition of embodiment 39 wherein the weight ratio of the at least one biosurfactant to the at least one inert component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 43. The turf grass treatment composition of embodiment 39 wherein the weight ratio of the at least one synthetic surfactant to the at least one inert component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 44. The turf grass treatment composition of embodiment 39 wherein the weight ratio of the at least one plant health component to the at least one inert component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 45. The turf grass treatment composition of embodiment 19 wherein the bioenzyme is selected from the group consisting of hydrolases, oxidoreductases, lyases, transferases, ligases, isomerases, and combinations thereof.

Embodiment 46. The turf grass treatment composition of embodiment 45 wherein a cofactor is associated with the bioenzyme.

Embodiment 47. The turf grass treatment composition of embodiment 46 wherein the cofactor is selected from the group consisting of prosthetic groups, coenzymes, metal ions, and combinations thereof.

Embodiment 48. The turf grass treatment of embodiment 1, which when applied to turf grass, or to roots of the turf grass, or to soil in which the turf grass grows, is effective for promoting or enhancing at least one of bioenzyme activity and bioenzyme production in the turf grass.

Embodiment 49. The turf grass treatment composition of embodiment 1 which, when applied to turf grass, or to roots of the turf grass, or to soil in which the turf grass grows, enhances quality of the turf grass by enhancing initial water uptake or wetting, rewetting and/or water retention over time of said turf grass.

Embodiment 50. The turf grass treatment composition of embodiment 1 which, when applied to turf grass, or to roots of the turf grass, or to soil in which the turf grass grows, enhances quality of the turf grass by enhancing surface tension reduction, increasing speed to wet, increasing water retention, and/or increasing time to dry between watering events.

Embodiment 51. The turf grass treatment composition of embodiment 1 which, when applied to turf grass, or to roots of the turf grass, or to soil in which the turf grass grows, enhances quality of the turf grass by enhancing root structure and growth, nutrient use efficiency, water use efficiency, stress tolerance, disease tolerance, and/or inducing systemic resistance.

Embodiment 52. The turf grass treatment composition of embodiment 1 which, when applied to turf grass, or to roots of the turf grass, or to soil in which the turf grass grows, enhances quality of the turf grass by enhancing strength of the turf grass roots by increasing root density, increasing root diameter, and/or increasing root depth.

Embodiment 53. The turf grass treatment composition of embodiment 1 which, when applied to turf grass, or to roots of the turf grass, or to soil in which the turf grass grows, enhances quality of the turf grass by increasing or enhancing photosynthesis; photochemical activity; root enzyme activity; root mass; stress tolerance due to the production of superoxide dismutase enzymes; cytokinin activity under drying conditions to stimulate cell division; leaf moisture; a-tocopherol (vitamin E) and ascorbic acid (vitamin C) antioxidants found in chloroplasts; chlorophyll content; root length; shoot growth; phosphorus uptake; salt tolerance; leaf tissue nitrogen (N), phosphorus (P), potassium (K) and iron (Fe); soil moisture; and/or microbiome.

Embodiment 54. The turf grass treatment composition of embodiment 1 which, when applied to turf grass, or to roots of the turf grass, or to soil in which the turf grass grows, enhances quality of the turf grass by making the nutrients far more recognizable to the turf grass; limiting temperature stress, drought stress, heavy metal stress, and low mowing heights; amino acid proline scavenges hydroxyl radicals by increasing superoxide dismutase (SOD); protein biosynthesis improvement; increasing chlorophyll content; increasing germination; stimulating carbon and nitrogen metabolism; and/or stimulating turf grass microbiomes.

Embodiment 55. The turf grass treatment composition of embodiment 1 which, when applied to turf grass, or to roots of the turf grass, or to soil in which the turf grass grows, enhances quality of the turf grass by increasing or enhancing leaf count, amino acid proline scavenges hydroxyl radicals by increasing superoxide dismutase (SOD); proline dehydrogenase production/stress adaption; chlorophyll content; germination; and/or vertical leaf growth.

Embodiment 56. The turf grass treatment composition of embodiment 1 which, when applied to turf grass, or to roots of the turf grass, or to soil in which the turf grass grows, enhances quality of the turf grass by strengthening cell walls by silica deposits; promoting turf grass growth; inducing tolerance to abiotic stress (drought, salinity, cold stress); inducing cell wall rigidification, osmoregulation, reducing transpiration; influencing osmotic, pH, and redox homeostasis; and/or influencing hormone signaling and enzymes involved in stress response.

Embodiment 57. The turf grass treatment composition of embodiment 1 which, when applied to turf grass, or to roots of the turf grass, or to soil in which the turf grass grows, enhances quality of the turf grass by providing defense against abiotic stress; leaf and stem strength through deposition in the cuticle; maintaining cell wall polysaccharide and lignin polymersproline; wear resistance; heat and drought stressed resistance; growth and establishment; water use efficiency; salt stress tolerance; leaf blade stiffness; and/or better ball roll.

Embodiment 58. The turf grass treatment composition of embodiment 1 which, when applied to turf grass, or to roots of the turf grass, or to soil in which the turf grass grows, enhances quality of the turf grass by increasing or enhancing uptake of macro- and micronutrients; root mass and surface area; cytokinin content; drought stress tolerance; arbuscule-forming mycorrhiza fungal may reduce Poa annua on golf greens; chlorophyll content; absorption of mineral elements such as phosphorus (P), iron (Fe), copper (Cu), magnesium (Mg), potassium (K), boron (B), silicon (Si), sulfur (S), and nitrogen (N); above ground biomass; water use efficiency; less irrigation in summer; and/or less artificial fertilizer for the same results.

Embodiment 59. The turf grass treatment composition of embodiment 1 which, when applied to turf grass, or to roots of the turf grass, or to soil in which the turf grass grows, enhances quality of the turf grass by enhancing health, growth and/or sturdiness of the turf grass.

Embodiment 60. The turf grass treatment composition of embodiment 1 which, when applied to turf grass, or to roots of the turf grass, or to soil in which the turf grass grows, enhances quality of the turf grass by enhancing turf grass color, turf grass shoot density, and/or turf grass greenness.

Embodiment 61. The turf grass treatment composition of embodiment 1 which is a synergistic turf grass treatment composition.

Embodiment 62. The turf grass treatment composition of embodiment 61 wherein the synergistic turf grass treatment composition comprising at least one biosurfactant and at least one plant health component, produces, when applied to turf grass, or to roots of the turf grass, or to soil in which the turf grass grows, a combined turf grass quality effect, greater than the sum of the separate turf grass quality effects, at essentially the same concentrations.

Embodiment 63. The turf grass treatment composition of embodiment 61 wherein the synergistic turf grass treatment composition comprising at least one biosurfactant and at least one plant health component, produces, when applied to turf grass, or to roots of the turf grass, or to soil in which the turf grass grows, a combined promoting or enhancing effect of at least one of bioenzyme activity and bioenzyme production in the turf grass, greater than the sum of the separate promoting or enhancing effects of at least one of bioenzyme activity and bioenzyme production in the turf grass, at essentially the same concentrations.

Embodiment 64. The turf grass treatment composition of embodiment 1 wherein the turf grass is selected from the group consisting of: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); zoysia grass (Zoysia spp.); Bahia grass (Paspalum notatum); carpet grass (Axonopus affinis); centipede grass (Eremochloa ophiuroides); kikuyu grass (Pennisetum clandesinum); seashore paspalum (Paspalum vaginatum); floratam (Stenotaphrum secundatum “Floratam”); blue gramma (Bouteloua gracilis); buffalo grass (Buchloe dactyloids); and/or sideoats gramma (Bouteloua curtipendula).

Embodiment 65. The turf grass treatment composition of embodiment 1 which is applied to turf grass using an irrigation system.

Embodiment 66. The turf grass treatment composition of embodiment 1 which is applied to turf grass using a manual spreader, said spreader comprising a broadcast spreader, a drop spreader, a handheld spreader, or a handheld sprayer.

Embodiment 67. The turf grass treatment composition of embodiment 1 wherein the turf grass is in the form of sod comprising turf grass and a layer of soil held together by the roots of the turf grass and forming a sheet.

Embodiment 68. The turf grass treatment composition of embodiment 1 wherein the composition is applied to a field or pitch planted with the turf grass.

Embodiment 69. The turf grass treatment composition of embodiment 68 wherein the field is used for athletics and/or recreation.

Embodiment 70. The turf grass treatment composition of embodiment 68 wherein the field is a park, campground, amphitheater, golf course, horse track, soccer field, football field, lacrosse field, field hockey field, cricket field, rugby field, polo field, softball field or baseball field.

Embodiment 71. The turf grass treatment composition of embodiment 68 which, when applied to turf grass, or to roots of the turf grass, or to soil in which the turf grass grows, helps prevent the occurrence of holes and/or divots in the field as a result of athletic or recreational use.

Embodiment 72. The turf grass treatment composition of embodiment 1 which, when applied to turf grass, or to roots of the turf grass, or to soil in which the turf grass grows, increases safety of participating in athletics or recreation on the field by preventing injuries caused by stepping in a hole and/or divot.

Embodiment 73. The turf grass treatment composition of embodiment 1 which is a microbe-based composition.

Embodiment 74. A turf grass treatment composition comprising at least one biosurfactant, at least one plant health component, at least one synthetic surfactant, and at least one inert component.

Embodiment 75. The turf grass treatment composition of embodiment 74 wherein the at least one plant health component is a biostimulant.

Embodiment 76. The turf grass treatment composition of embodiment 75 wherein the at least one biosurfactant is rhamnolipid, the at least one biostimulant is seaweed/kelp, the at least one synthetic surfactant is alkyl polyglucoside (APG), and at least one inert component is water.

Embodiment 77. The turf grass treatment composition of embodiment 74 which is a synergistic turf grass treatment composition.

Embodiment 78. The turf grass treatment composition of embodiment 77 wherein the synergistic turf grass treatment composition comprising at least one biosurfactant and at least one plant health component, produces, when applied to turf grass, or to roots of the turf grass, or to soil in which the turf grass grows, a combined turf grass quality effect, greater than the sum of the separate turf grass quality effects, at essentially the same concentrations.

Embodiment 79. The turf grass treatment composition of embodiment 77 wherein the synergistic turf grass treatment composition comprising at least one biosurfactant and at least one plant health component, produces, when applied to turf grass, or to roots of the turf grass, or to soil in which the turf grass grows, a combined promoting or enhancing effect of at least one of bioenzyme activity and bioenzyme production in the turf grass, greater than the sum of the separate promoting or enhancing effects of at least one of bioenzyme activity and bioenzyme production in the turf grass, at essentially the same concentrations.

Embodiment 80. The turf grass treatment composition of embodiment 1 which is applied to the turf grass, or to roots of the turf grass, or to soil in which the turf grass grows, at a treatment rate from about 0.5 oz./1000 sq. ft. monthly to about 12 oz./1000 sq. ft. monthly, or from about 1.0 oz./1000 sq. ft. monthly to about 10 oz./1000 sq. ft. monthly, or from about 2.0 oz./1000 sq. ft. monthly to about 8 oz./1000 sq. ft. monthly.

Embodiment 81. The turf grass treatment composition of embodiment 48 wherein promoting or enhancing at least one of bioenzyme activity and bioenzyme production in the turf grass is measured by high-performance liquid chromatography-mass spectrometry (HPLC-MS).

Embodiment 82. A method of promoting or enhancing quality of turf grass, said method comprising: applying to the turf grass, or to roots of the turf grass, or to soil in which the turf grass grows, a composition comprising at least one biosurfactant and at least one plant health component, wherein the composition, when applied to turf grass, or to roots of the turf grass, or to soil in which the turf grass grows, is effective for promoting or enhancing quality of the turf grass.

Embodiment 83. The method of embodiment 82 wherein the composition is a synergistic turf grass treatment composition comprising at least one biosurfactant and at least one plant health component, that produces, when applied to turf grass, or to roots of the turf grass, or to soil in which the turf grass grows, a combined turf grass quality effect, greater than the sum of the separate turf grass quality effects, at essentially the same concentrations.

Embodiment 84. The method of embodiment 82 wherein the composition, when applied to turf grass, or to roots of the turf grass, or to soil in which the turf grass grows, is effective for promoting or enhancing at least one of bioenzyme activity and bioenzyme production in the turf grass.

### Turf Grass Treatment Compositions Having One Or More Biosurfactant(s)+One Or More Synthetic Surfactant(s)

Preferred embodiments of this disclosure with regard to turf grass treatment compositions having at least one biosurfactant and at least one synthetic surfactant are described in Embodiments 1-84 below.

Embodiment 1. A turf grass treatment composition comprising at least one biosurfactant and at least one synthetic surfactant; wherein the turf grass treatment composition, when applied to turf grass, or to roots of the turf grass, or to soil in which the turf grass grows, is effective for promoting or enhancing quality of the turf grass.

Embodiment 2. The turf grass treatment composition of embodiment 1 wherein the at least one biosurfactant is a growth byproduct of a microorganism.

Embodiment 3. The turf grass treatment composition of embodiment 2 wherein the microorganism is a genetically-modified (GM) microorganism or a non-genetically (non-GM) modified microorganism.

Embodiment 4. The turf grass treatment composition of embodiment 2 wherein the microorganism is selected from the group consisting of bacteria, yeast, and fungi.

Embodiment 5. The turf grass treatment composition of embodiment 1 wherein the at least one biosurfactant is selected from the group consisting of glycolipids, lipopeptides, phospholipids, fatty acids, and polymeric surfactants.

Embodiment 6. The turf grass treatment composition of embodiment 1 wherein the at least one biosurfactant is a glycolipid.

Embodiment 7. The turf grass treatment composition of embodiment 1 wherein the at least one biosurfactant is a glycolipid selected from the group consisting of rhamnolipid, sophorolipid, mannosylerythritol lipid, and trehalose lipid.

Embodiment 8. The turf grass treatment composition of embodiment 1 wherein the at least one biosurfactant is rhamnolipid.

Embodiment 9. The turf grass treatment composition of embodiment 2 wherein the microorganism is selected from the group consisting of Starmerella sp., Pichia sp., Pseudomonas sp. (P. aeruginosa, P. putida, P. florescens, P. Tragi, P. syringae); Flavobacterium spp.; Bacillus spp. (B. subtilis, B. pumillus, B. cereus, B. licheniformis); Candida species (C. albicans, C. rugosa, C. tropicalis, C. lipolytica, C. torulopsis); Rhodococcus sp.; Arthrobacter spp.; campylobacter spp.; and cornybacterium spp.; and combinations thereof; wherein the microorganism is a genetically-modified (GM) microorganism or a non-genetically (non-GM) modified microorganism.

Embodiment 10. The turf grass treatment composition of embodiment 4 wherein the bacteria is selected from the group consisting of: Pseudomonas sp., Pseudomonas guguanensis, Pseudomonas putida, Pseudomonas aeruginosa, Pseudomonas fluorescens, Pseudomonas aeruginosa, Pseudomonas aeruginosa, Pseudomonas stutzeri; and combinations thereof; wherein the bacteria is a genetically-modified (GM) bacteria or a non-genetically (non-GM) modified bacteria.

Embodiment 11. The turf grass treatment composition of embodiment 4 wherein the bacteria is selected from the group consisting of: Bacillus sp., Bacillus subtilis,; Bacillus sphaericus, Bacillus azotoformans,; Bacillus subtilis, Bacillus sp., Bacillus subtilis, Bacillus licheniformis, Bacillus subtilis,; Bacillus subtilis; and combinations thereof; wherein the bacteria is a genetically-modified (GM) bacteria or a non-genetically (non-GM) modified bacteria.

Embodiment 12. The turf grass treatment composition of embodiment 4 wherein the bacteria is selected from the group consisting of: Bordetella hinzii; Klebsiella pneumoniae; Ochrobactrum anthropi, Citrobacter freundii; Pseudoxanthomonas sp., Nocardia otitidiscaviarum; Serratia marcescens, Stenotrophomonas maltophilia; Virgibacillus salarius, Stenotrophomonas sp., Aeromonas salmonicida; Gordonia polyisoprenivorans; Burkholderia thailandensis, Pseudoxanthomonas sp., Ralstonia pickettii, Alcaligenes piechaudii; Gordonia sp.; and combinations thereof; wherein the bacteria is a genetically-modified (GM) bacteria or a non-genetically (non-GM) modified bacteria.

Embodiment 13. The turf grass treatment composition of embodiment 4 wherein the fungi is selected from the group consisting of: filamentous fungi such as Penicillium citrinum; Aspergillus flavus; Penicillium chrysogenum, Fusarium sp.; Fusarium oxysporum; Cunninghamella echinulate; and combinations thereof; wherein the fungi are genetically-modified (GM) fungi or non-genetically (non-GM) modified fungi.

Embodiment 14. The turf grass treatment composition of embodiment 4 wherein the yeast is selected from the group consisting of: Cryptococcus curvatus; Pichia anomala, Starmerella bombicola, Candida bombicola, Candida lipolytica; Candida lipolytica; Candida antarctica, Ustilago scitaminea, Pseudozyma tsukubaensis, Pseudozyma fusifornata, Pseudozyma parantarctica, Pseudozyma aphidis, Kluyveromyces marxianus, Kurtzmanomyces sp., Pseudozyma siamensis,; Wickerhamomyces anomalus, Candida antarctica, Candida apicola; and combinations thereof; wherein the yeast is a genetically-modified (GM) yeast or a non-genetically (non-GM) modified yeast.

Embodiment 15. The turf grass treatment composition of embodiment 2 wherein the microorganism is produced by a production or cultivation process selected from the group consisting of submerged cultivation/fermentation, surface cultivation, solid state fermentation, and combinations thereof; wherein the production or cultivation process is carried out under aerobic or anaerobic conditions.

Embodiment 16. The turf grass treatment composition of embodiment 15 wherein the production or cultivation process utilizes food/energy source(s) for microorganism growth.

Embodiment 17. The turf grass treatment composition of embodiment 16 wherein the food/energy source(s) are selected from the group consisting of: carbon sources including carbohydrates, alcohols, organic acids, fats, and oils; and combinations thereof; agro-industrial wastes, vegetable oil mill effluents including coconut oil, canola oil, olive oil, grape seed oil, palm oil, rapeseed oil, sunflower oil, soybean oil; dairy and sugar industry byproducts including buttermilk, whey, molasses; starch industry extract and wastes including corn, potatoes, tapioca, wheat; wherein the food/energy source(s) are genetically-modified (GM) or non-genetically (non-GM) modified.

Embodiment 18. The turf grass treatment composition of embodiment 1 wherein the at least one biosurfactant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

Embodiment 19. The turf grass treatment composition of embodiment 1 wherein the at least one synthetic surfactant is selected from the group consisting of anionic surfactants, nonionic surfactants, cationic surfactants, amphoteric or zwitterionic surfactants, and combinations thereof.

Embodiment 20. The turf grass treatment composition of embodiment 19 wherein the nonionic surfactant is selected from the group consisting of polyoxyethylene (POE) surfactants, block copolymer surfactants, straight block copolymer surfactants, reverse block copolymer surfactants, alkyl polyglucoside (APG) surfactants, modified methyl capped block copolymer surfactants, humic substance redistribution molecules, and multibranched regenerating wetting agents.

Embodiment 21. The turf grass treatment composition of embodiment 19 wherein the nonionic surfactant is selected from the group consisting of alkyl polyglucosides (APGs), fatty alcohol ethoxylates, alkyl phenol ethoxylates, fatty acid alkoxylates, and combinations thereof.

Embodiment 22. The turf grass treatment composition of embodiment 19 wherein the nonionic surfactant is selected from the group consisting of alcohol ethoxylates, alkanolamides, alkanolamine condensates, carboxylic acid esters, cetostearyl alcohol, cetyl alcohol, cocamide DEA, dodecyldimethylamine oxides, ethanolamides, ethoxylates of glycerol ester and glycol esters, ethylene oxide polymers, ethylene oxide-propylene oxide copolymers, glucoside alkyl ethers, glycerol alkyl ethers, glycerol esters, glycol alkyl ethers (e.g., polyoxyethylene glycol alkyl ethers, polyoxypropylene glycol alkyl ethers), glycol alkylphenol ethers (e.g., polyoxyethylene glycol alkylphenol ethers,), glycol esters, monolaurin, pentaethylene glycol monododecyl ethers, poloxamer, polyamines, polyglycerol polyricinoleate, polysorbate, polyoxyethylenated fatty acids, polyoxyethylenated mercaptans, polyoxyethylenated polyoxyproylene glycols, polyoxyethylene glycol sorbitan alkyl esters, polyethylene glycol-polypropylene glycol copolymers, polyoxyethylene glycol octylphenol ethers, polyvinyl pynolidones, sugar-based alkyl polyglycosides, sulfoanylamides, sorbitan fatty acid alcohol ethoxylates, sorbitan fatty acid ester ethoxylates, sorbitan fatty acid ester, and tertiary acetylenic glycols.

Embodiment 23. The turf grass treatment composition of embodiment 19 wherein the anionic surfactant is selected from the group consisting of alkyl carboxylates (e.g., sodium stearate), alkyl sulfates (e.g., alkyl lauryl sulfate, sodium lauryl sulfate), alkyl ether sulfates, alkyl amido ether sulfates, alkyl aryl polyether sulfates, alkyl aryl sulfates, alkyl aryl sulfonates, alkyl sulfonates, alkyl amide sulfonates, alkyl aryl sulfonates, alkyl benzene sulfonates, alkyl diphenyloxide sulfonate, alpha-olefin sulfonates, alkyl naphthalene sulfonates, paraffin sulfonates, alkyl sulfosuccinates, alkyl ether sulfosuccinates, alkylamide sulfosuccinates, alkyl sulfosuccinamates, alkyl sulfoacetates, alkyl phosphates, alkyl ether phosphates, acyl sarconsinates, acyl isethionates, N-acyl taurates, N-acyl-N-alkyltaurates, benzene sulfonates, cumene sulfonates, dioctyl sodium sulfosuccinate, ethoxylated sulfosuccinates, lignin sulfonates, linear alkylbenzene sulfonates, monoglyceride sulfates, perfluorobutanesulfonate, perfluorooctanesulfonate, phosphate ester, styrene acrylic polymers, toluene sulfonates, and xylene sulfonates.

Embodiment 24. The turf grass treatment composition of embodiment 19 wherein the cationic surfactant is selected from the group consisting of alkyltrimethylammonium salts (e.g., cetyl trimethylammonium bromide, cetyl trimethylammonium chloride), cetylpyridinium chloride, benzalkonium chloride, benzethonium chloride, 5-bromo-5-nitro-1,3-dioxane, dimethyldioctadecylammonium chloride, cetrimonium bromide, dioctadecyldimethylammonium bromide, and octenidine dihydrochloride.

Embodiment 25. The turf grass treatment composition of embodiment 19 wherein the amphoteric or zwitterionic surfactant is selected from the group consisting of 3 [(3-cholamidopropyl)dimethylammonio]-1-propanesulfonate, cocamidopropyl betaine, cocamidopropyl hydroxysultaine, phosphatidylserine, phosphatidylethanolamine, phosphatidylcholine, and sphingomyelins.

Embodiment 26. The turf grass treatment composition of embodiment 1 wherein the at least one synthetic surfactant is from a naturally-derived source.

Embodiment 27. The turf grass treatment composition of embodiment 1 wherein the at least one synthetic surfactant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the turf grass treatment composition.

Embodiment 28. The turf grass treatment composition of embodiment 1 wherein the weight ratio of the at least one biosurfactant to the at least one synthetic surfactant is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 29. The turf grass treatment composition of embodiment 1 further comprising at least one plant health component.

Embodiment 30. The turf grass treatment composition of embodiment 29 wherein the at least one plant health component is selected from the group consisting of a biostimulant, bioenzyme, nutrient(s) for microorganism growth, nutrient(s) for plant growth, fertilizer, pesticide, herbicide, other microorganism based composition(s); and combinations thereof.

Embodiment 31. The turf grass treatment composition of embodiment 30 wherein the at least one plant health component is a biostimulant.

Embodiment 32. The turf grass treatment composition of embodiment 31 wherein the at least one biostimulant is selected from the group consisting of plant hormones, microbes selected from bacteria, yeast, and fungi; humic substances, seaweed extracts, protein hydrolysates, chitosan, inorganic compounds, and metabolites.

Embodiment 33. The turf grass treatment composition of embodiment 31 wherein the at least one biostimulant is selected from the group consisting of humic substances, humins, fulvic acids, fatty acids/lipids, peptides, amino acids, organic acids, carboxyls, B vitamins, protein hydrolysates, plant growth promoting bacteria (PGPR), cytokinins, rhizobium, mycorrhizae, trichoderma, fungi, microbial complex communities/consortia, phytohormones, seaweed/kelp, laminarin, alginates, polysaccharides, polyphenols, botanicals, allelochemicals, organic matter extracts, chitin, chitosan, betaines, polyamines, inorganic salts, proteins, elements selected from silicon (Si), sodium (Na) and cobalt (Co), phosphites, nitrogeneous compounds, and enzymatic extracts.

Embodiment 34. The turf grass treatment composition of embodiment 32 wherein the yeast or fungi are selected from the group consisting of Aureobasidium (e.g., A. pullulans), Blakeslea, Candida (e.g., C. apicola, C. bombicola, C. nodaensis), Cryptococcus, Debaryomyces (e.g., D. hansenii), Entomophthora, Hanseniaspora, (e.g., H. uvarum), Hansenula, Issatchenkia, Kluyveromyces (e.g., K. phaffii), Mortierella, mycorrhizal fungi, Penicillium, Phycomyces, Pichia (e.g., P. anomala, P. guilliermondii, P. occidentalis, P. kudriavzevii), Pleurotus spp. (e.g., P. ostreatus), Pseudozyma (e.g., P. aphidis), Saccharomyces (e.g., S. boulardii sequela, S. cerevisiae, S. torula), Starmerella (e.g., S. bombicola), Torulopsis, Trichoderma (e.g., T. reesei, T. harzianum, T. hamatum, T. viride), Ustilago (e.g., U. maydis), Wickerhamomyces (e.g., W. anomalus), Williopsis (e.g., W. mrakii), and Zygosaccharomyces (e.g., Z. bailii).

Embodiment 35. The turf grass treatment composition of embodiment 32 wherein the bacteria are selected from the group consisting of Gram-positive and Gram-negative bacteria, rhizobacteria, Agrobacterium (e.g., A. radiobacter), Azotobacter (A. vinelandii, A. chroococcum), Azospirillum (e.g., A. brasiliensis), Bacillus (e.g., B. amyloliquifaciens, B. circulans, B. firmus, B. laterosporus, B. licheniformis, B. megaterium, Bacillus mucilaginosus, B. subtilis), Frateuria (e.g., F. aurantia), Microbacterium (e.g., M. laevaniformans), myxobacteria (e.g., Myxococcus xanthus, Stignatella aurantiaca, Sorangium cellulosum, Minicystis rosea), Pantoea (e.g., P. agglomerans), Pseudomonas (e.g., P. aeruginosa, P. chlororaphis subsp. aureofaciens (Kluyver), P. putida), Rhizobium spp., Rhodospirillum (e.g., R. rubrum), Sphingomonas (e.g., S. paucimobilis), and Thiobacillus thiooxidans (Acidothiobacillus thiooxidans).

Embodiment 36. The turf grass treatment composition of embodiment 29 wherein the at least one plant health component is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

Embodiment 37. The turf grass treatment composition of embodiment 29 wherein the weight ratio of the at least one biosurfactant to the at least one plant health component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 38. The turf grass treatment composition of embodiment 29 wherein the weight ratio of the at least one plant health component to the at least one synthetic surfactant is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 39. The turf grass treatment composition of embodiment 1 further comprising at least one inert component.

Embodiment 40. The turf grass treatment composition of embodiment 39 wherein the at least one inert component comprises water.

Embodiment 41. The turf grass treatment composition of embodiment 39 wherein the at least one inert component is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the turf grass treatment composition.

Embodiment 42. The turf grass treatment composition of embodiment 39 wherein the weight ratio of the at least one biosurfactant to the at least one inert component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 43. The turf grass treatment composition of embodiment 39 wherein the weight ratio of the at least one synthetic surfactant to the at least one inert component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 44. The turf grass treatment composition of embodiment 39 wherein the weight ratio of the at least one plant health component to the at least one inert component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 45. The turf grass treatment composition of embodiment 30 wherein the bioenzyme is selected from the group consisting of hydrolases, oxidoreductases, lyases, transferases, ligases, isomerases, and combinations thereof.

Embodiment 46. The turf grass treatment composition of embodiment 45 wherein a cofactor is associated with the bioenzyme.

Embodiment 47. The turf grass treatment composition of embodiment 46 wherein the cofactor is selected from the group consisting of prosthetic groups, coenzymes, metal ions, and combinations thereof.

Embodiment 48. The turf grass treatment of embodiment 1, which when applied to turf grass, or to roots of the turf grass, or to soil in which the turf grass grows, is effective for promoting or enhancing at least one of bioenzyme activity and bioenzyme production in the turf grass.

Embodiment 49. The turf grass treatment composition of embodiment 1 which, when applied to turf grass, or to roots of the turf grass, or to soil in which the turf grass grows, enhances quality of the turf grass by enhancing initial water uptake or wetting, rewetting and/or water retention over time of said turf grass.

Embodiment 50. The turf grass treatment composition of embodiment 1 which, when applied to turf grass, or to roots of the turf grass, or to soil in which the turf grass grows, enhances quality of the turf grass by enhancing surface tension reduction, increasing speed to wet, increasing water retention, and/or increasing time to dry between watering events.

Embodiment 51. The turf grass treatment composition of embodiment 1 which, when applied to turf grass, or to roots of the turf grass, or to soil in which the turf grass grows, enhances quality of the turf grass by enhancing root structure and growth, nutrient use efficiency, water use efficiency, stress tolerance, disease tolerance, and/or inducing systemic resistance.

Embodiment 52. The turf grass treatment composition of embodiment 1 which, when applied to turf grass, or to roots of the turf grass, or to soil in which the turf grass grows, enhances quality of the turf grass by enhancing strength of the turf grass roots by increasing root density, increasing root diameter, and/or increasing root depth.

Embodiment 53. The turf grass treatment composition of embodiment 1 which, when applied to turf grass, or to roots of the turf grass, or to soil in which the turf grass grows, enhances quality of the turf grass by increasing or enhancing photosynthesis; photochemical activity; root enzyme activity; root mass; stress tolerance due to the production of superoxide dismutase enzymes; cytokinin activity under drying conditions to stimulate cell division; leaf moisture; a-tocopherol (vitamin E) and ascorbic acid (vitamin C) antioxidants found in chloroplasts; chlorophyll content; root length; shoot growth; phosphorus uptake; salt tolerance; leaf tissue nitrogen (N), phosphorus (P), potassium (K) and iron (Fe); soil moisture; and/or microbiome.

Embodiment 54. The turf grass treatment composition of embodiment 1 which, when applied to turf grass, or to roots of the turf grass, or to soil in which the turf grass grows, enhances quality of the turf grass by making the nutrients far more recognizable to the turf grass; limiting temperature stress, drought stress, heavy metal stress, and low mowing heights; amino acid proline scavenges hydroxyl radicals by increasing superoxide dismutase (SOD); protein biosynthesis improvement; increasing chlorophyll content; increasing germination; stimulating carbon and nitrogen metabolism; and/or stimulating turf grass microbiomes.

Embodiment 55. The turf grass treatment composition of embodiment 1 which, when applied to turf grass, or to roots of the turf grass, or to soil in which the turf grass grows, enhances quality of the turf grass by increasing or enhancing leaf count, amino acid proline scavenges hydroxyl radicals by increasing superoxide dismutase (SOD); proline dehydrogenase production/stress adaption; chlorophyll content; germination; and/or vertical leaf growth.

Embodiment 56. The turf grass treatment composition of embodiment 1 which, when applied to turf grass, or to roots of the turf grass, or to soil in which the turf grass grows, enhances quality of the turf grass by strengthening cell walls by silica deposits; promoting turf grass growth; inducing tolerance to abiotic stress (drought, salinity, cold stress); inducing cell wall rigidification, osmoregulation, reducing transpiration; influencing osmotic, pH, and redox homeostasis; and/or influencing hormone signaling and enzymes involved in stress response.

Embodiment 57. The turf grass treatment composition of embodiment 1 which, when applied to turf grass, or to roots of the turf grass, or to soil in which the turf grass grows, enhances quality of the turf grass by providing defense against abiotic stress; leaf and stem strength through deposition in the cuticle; maintaining cell wall polysaccharide and lignin polymersproline; wear resistance; heat and drought stressed resistance; growth and establishment; water use efficiency; salt stress tolerance; leaf blade stiffness; and/or better ball roll.

Embodiment 58. The turf grass treatment composition of embodiment 1 which, when applied to turf grass, or to roots of the turf grass, or to soil in which the turf grass grows, enhances quality of the turf grass by increasing or enhancing uptake of macro- and micronutrients; root mass and surface area; cytokinin content; drought stress tolerance; arbuscule-forming mycorrhiza fungal may reduce Poa annua on golf greens; chlorophyll content; absorption of mineral elements such as phosphorus (P), iron (Fe), copper (Cu), magnesium (Mg), potassium (K), boron (B), silicon (Si), sulfur(S), and nitrogen (N); above ground biomass; water use efficiency; less irrigation in summer; and/or less artificial fertilizer for the same results.

Embodiment 59. The turf grass treatment composition of embodiment 1 which, when applied to turf grass, or to roots of the turf grass, or to soil in which the turf grass grows, enhances quality of the turf grass by enhancing health, growth and/or sturdiness of the turf grass.

Embodiment 60. The turf grass treatment composition of embodiment 1 which, when applied to turf grass, or to roots of the turf grass, or to soil in which the turf grass grows, enhances quality of the turf grass by enhancing turf grass color, turf grass shoot density, and/or turf grass greenness.

Embodiment 61. The turf grass treatment composition of embodiment 1 which is a synergistic turf grass treatment composition.

Embodiment 62. The turf grass treatment composition of embodiment 61 wherein the synergistic turf grass treatment composition comprising at least one biosurfactant and at least one synthetic surfactant, produces, when applied to turf grass, or to roots of the turf grass, or to soil in which the turf grass grows, a combined turf grass quality effect, greater than the sum of the separate turf grass quality effects, at essentially the same concentrations.

Embodiment 63. The turf grass treatment composition of embodiment 61 wherein the synergistic turf grass treatment composition comprising at least one biosurfactant and at least one synthetic surfactant produces, when applied to turf grass, or to roots of the turf grass, or to soil in which the turf grass grows, a combined promoting or enhancing effect of at least one of bioenzyme activity and bioenzyme production in the turf grass, greater than the sum of the separate promoting or enhancing effects of at least one of bioenzyme activity and bioenzyme production in the turf grass, at essentially the same concentrations.

Embodiment 64. The turf grass treatment composition of embodiment 1 wherein the turf grass is selected from the group consisting of: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); zoysia grass (Zoysia spp.); Bahia grass (Paspalum notatum); carpet grass (Axonopus affinis); centipede grass (Eremochloa ophiuroides); kikuyu grass (Pennisetum clandesinum); seashore paspalum (Paspalum vaginatum); floratam (Stenotaphrum secundatum “Floratam”); blue gramma (Bouteloua gracilis); buffalo grass (Buchloe dactyloids); and/or sideoats gramma (Bouteloua curtipendula).

Embodiment 65. The turf grass treatment composition of embodiment 1 which is applied to turf grass using an irrigation system.

Embodiment 66. The turf grass treatment composition of embodiment 1 which is applied to turf grass using a manual spreader, said spreader comprising a broadcast spreader, a drop spreader, a handheld spreader, or a handheld sprayer.

Embodiment 67. The turf grass treatment composition of embodiment 1 wherein the turf grass is in the form of sod comprising turf grass and a layer of soil held together by the roots of the turf grass and forming a sheet.

Embodiment 68. The turf grass treatment composition of embodiment 1 wherein the composition is applied to a field or pitch planted with the turf grass.

Embodiment 69. The turf grass treatment composition of embodiment 68 wherein the field is used for athletics and/or recreation.

Embodiment 70. The turf grass treatment composition of embodiment 68 wherein the field is a park, campground, amphitheater, golf course, horse track, soccer field, football field, lacrosse field, field hockey field, cricket field, rugby field, polo field, softball field or baseball field.

Embodiment 71. The turf grass treatment composition of embodiment 68 which, when applied to turf grass, or to roots of the turf grass, or to soil in which the turf grass grows, helps prevent the occurrence of holes and/or divots in the field as a result of athletic or recreational use.

Embodiment 72. The turf grass treatment composition of embodiment 1 which, when applied to turf grass, or to roots of the turf grass, or to soil in which the turf grass grows, increases safety of participating in athletics or recreation on the field by preventing injuries caused by stepping in a hole and/or divot.

Embodiment 73. The turf grass treatment composition of embodiment 1 which is a microbe-based composition.

Embodiment 74. A turf grass treatment composition comprising at least one biosurfactant, at least one plant health component, at least one synthetic surfactant, and at least one inert component.

Embodiment 75. The turf grass treatment composition of embodiment 74 wherein the at least one plant health component is a biostimulant.

Embodiment 76. The turf grass treatment composition of embodiment 75 wherein the at least one biosurfactant is rhamnolipid, the at least one biostimulant is seaweed/kelp, the at least one synthetic surfactant is alkyl polyglucoside (APG), and at least one inert component is water.

Embodiment 77. The turf grass treatment composition of embodiment 74 which is a synergistic turf grass treatment composition.

Embodiment 78. The turf grass treatment composition of embodiment 77 wherein the synergistic turf grass treatment composition comprising at least one biosurfactant and at least one synthetic surfactant, produces, when applied to turf grass, or to roots of the turf grass, or to soil in which the turf grass grows, a combined turf grass quality effect, greater than the sum of the separate turf grass quality effects, at essentially the same concentrations.

Embodiment 79. The turf grass treatment composition of embodiment 77 wherein the synergistic turf grass treatment composition comprising at least one biosurfactant and at least one synthetic surfactant, produces, when applied to turf grass, or to roots of the turf grass, or to soil in which the turf grass grows, a combined promoting or enhancing effect of at least one of bioenzyme activity and bioenzyme production in the turf grass, greater than the sum of the separate promoting or enhancing effects of at least one of bioenzyme activity and bioenzyme production in the turf grass, at essentially the same concentrations.

Embodiment 80. The turf grass treatment composition of embodiment 1 which is applied to the turf grass, or to roots of the turf grass, or to soil in which the turf grass grows, at a treatment rate from about 0.5 oz./1000 sq. ft. monthly to about 12 oz./1000 sq. ft. monthly, or from about 1.0 oz./1000 sq. ft. monthly to about 10 oz./1000 sq. ft. monthly, or from about 2.0 oz./1000 sq. ft. monthly to about 8 oz./1000 sq. ft. monthly.

Embodiment 81. The turf grass treatment composition of embodiment 48 wherein promoting or enhancing at least one of bioenzyme activity and bioenzyme production in the turf grass is measured by high-performance liquid chromatography-mass spectrometry (HPLC-MS).

Embodiment 82. A method of promoting or enhancing quality of turf grass, said method comprising: applying to the turf grass, or to roots of the turf grass, or to soil in which the turf grass grows, a composition comprising at least one biosurfactant and at least one synthetic surfactant; wherein the composition, when applied to turf grass, or to roots of the turf grass, or to soil in which the turf grass grows, is effective for promoting or enhancing quality of the turf grass.

Embodiment 83. The method of embodiment 82 wherein the composition is a synergistic turf grass treatment composition comprising at least one biosurfactant and at least one synthetic surfactant, that produces, when applied to turf grass, or to roots of the turf grass, or to soil in which the turf grass grows, a combined turf grass quality effect, greater than the sum of the separate turf grass quality effects, at essentially the same concentrations.

Embodiment 84. The method of embodiment 82 wherein the composition, when applied to turf grass, or to roots of the turf grass, or to soil in which the turf grass grows, is effective for promoting or enhancing at least one of bioenzyme activity and bioenzyme production in the turf grass.

### Turf Grass Treatment Compositions Having One Or More Biosurfactant(s)+One Or More Plant Health Component(s)+One Or More Synthetic Surfactant(s)

Preferred embodiments of this disclosure with regard to turf grass treatment compositions having at least one biosurfactant, at least one plant health component, and at least one synthetic surfactant are described in Embodiments 1-83 below.

Embodiment 1. A turf grass treatment composition comprising at least one biosurfactant, at least one plant health component, and at least one synthetic surfactant; wherein the turf grass treatment composition, when applied to turf grass, or to roots of the turf grass, or to soil in which the turf grass grows, is effective for promoting or enhancing quality of the turf grass.

Embodiment 2. The turf grass treatment composition of embodiment 1 wherein the at least one biosurfactant is a growth byproduct of a microorganism.

Embodiment 3. The turf grass treatment composition of embodiment 2 wherein the microorganism is a genetically-modified (GM) microorganism or a non-genetically (non-GM) modified microorganism.

Embodiment 4. The turf grass treatment composition of embodiment 2 wherein the microorganism is selected from the group consisting of bacteria, yeast, and fungi.

Embodiment 5. The turf grass treatment composition of embodiment 1 wherein the at least one biosurfactant is selected from the group consisting of glycolipids, lipopeptides, phospholipids, fatty acids, and polymeric surfactants.

Embodiment 6. The turf grass treatment composition of embodiment 1 wherein the at least one biosurfactant is a glycolipid.

Embodiment 7. The turf grass treatment composition of embodiment 1 wherein the at least one biosurfactant is a glycolipid selected from the group consisting of rhamnolipid, sophorolipid, mannosylerythritol lipid, and trehalose lipid.

Embodiment 8. The turf grass treatment composition of embodiment 1 wherein the at least one biosurfactant is rhamnolipid.

Embodiment 9. The turf grass treatment composition of embodiment 2 wherein the microorganism is selected from the group consisting of Starmerella sp., Pichia sp., Pseudomonas sp. (P. aeruginosa, P. putida, P. florescens, P. Tragi, P. syringae); Flavobacterium spp.; Bacillus spp. (B. subtilis, B. pumillus, B. cereus, B. licheniformis); Candida species (C. albicans, C. rugosa, C. tropicalis, C. lipolytica, C. torulopsis); Rhodococcus sp.; Arthrobacter spp.; campylobacter spp.; and cornybacterium spp.; and combinations thereof; wherein the microorganism is a genetically-modified (GM) microorganism or a non-genetically (non-GM) modified microorganism.

Embodiment 10. The turf grass treatment composition of embodiment 4 wherein the bacteria is selected from the group consisting of: Pseudomonas sp., Pseudomonas guguanensis, Pseudomonas putida, Pseudomonas aeruginosa, Pseudomonas fluorescens, Pseudomonas aeruginosa, Pseudomonas aeruginosa, Pseudomonas stutzeri; and combinations thereof; wherein the bacteria is a genetically-modified (GM) bacteria or a non-genetically (non-GM) modified bacteria.

Embodiment 11. The turf grass treatment composition of embodiment 4 wherein the bacteria is selected from the group consisting of: Bacillus sp., Bacillus subtilis,; Bacillus sphaericus, Bacillus azotoformans,; Bacillus subtilis, Bacillus sp., Bacillus subtilis, Bacillus licheniformis, Bacillus subtilis,; Bacillus subtilis; and combinations thereof; wherein the bacteria is a genetically-modified (GM) bacteria or a non-genetically (non-GM) modified bacteria.

Embodiment 12. The turf grass treatment composition of embodiment 4 wherein the bacteria is selected from the group consisting of: Bordetella hinzii; Klebsiella pneumoniae; Ochrobactrum anthropi, Citrobacter freundii; Pseudoxanthomonas sp., Nocardia otitidiscaviarum; Serratia marcescens, Stenotrophomonas maltophilia; Virgibacillus salarius, Stenotrophomonas sp., Aeromonas salmonicida; Gordonia polyisoprenivorans; Burkholderia thailandensis, Pseudoxanthomonas sp., Ralstonia pickettii, Alcaligenes piechaudii; Gordonia sp.; and combinations thereof; wherein the bacteria is a genetically-modified (GM) bacteria or a non-genetically (non-GM) modified bacteria.

Embodiment 13. The turf grass treatment composition of embodiment 4 wherein the fungi is selected from the group consisting of: filamentous fungi such as Penicillium citrinum; Aspergillus flavus; Penicillium chrysogenum, Fusarium sp.; Fusarium oxysporum; Cunninghamella echinulate; and combinations thereof; wherein the fungi are genetically-modified (GM) fungi or non-genetically (non-GM) modified fungi.

Embodiment 14. The turf grass treatment composition of embodiment 4 wherein the yeast is selected from the group consisting of: Cryptococcus curvatus; Pichia anomala, Starmerella bombicola, Candida bombicola, Candida lipolytica; Candida lipolytica; Candida Pseudozyma parantarctica, Pseudozyma aphidis, Kluyveromyces marxianus, Kurtzmanomyces sp., Pseudozyma siamensis,; Wickerhamomyces anomalus, Candida antarctica, Candida apicola; and combinations thereof; wherein the yeast is a genetically-modified (GM) yeast or a non-genetically (non-GM) modified yeast.

Embodiment 15. The turf grass treatment composition of embodiment 2 wherein the microorganism is produced by a production or cultivation process selected from the group consisting of submerged cultivation/fermentation, surface cultivation, solid state fermentation, and combinations thereof; wherein the production or cultivation process is carried out under aerobic or anaerobic conditions.

Embodiment 16. The turf grass treatment composition of embodiment 15 wherein the production or cultivation process utilizes food/energy source(s) for microorganism growth.

Embodiment 17. The turf grass treatment composition of embodiment 16 wherein the food/energy source(s) are selected from the group consisting of: carbon sources including carbohydrates, alcohols, organic acids, fats, and oils; and combinations thereof; agro-industrial wastes, vegetable oil mill effluents including coconut oil, canola oil, olive oil, grape seed oil, palm oil, rapeseed oil, sunflower oil, soybean oil; dairy and sugar industry byproducts including buttermilk, whey, molasses; starch industry extract and wastes including corn, potatoes, tapioca, wheat; wherein the food/energy source(s) are genetically-modified (GM) or non-genetically (non-GM) modified.

Embodiment 18. The turf grass treatment composition of embodiment 1 wherein the at least one biosurfactant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

Embodiment 19. The turf grass treatment composition of embodiment 1 wherein the at least one plant health component is selected from the group consisting of a biostimulant, bioenzyme, nutrient(s) for microorganism growth, nutrient(s) for plant growth, fertilizer, pesticide, herbicide, other microorganism based composition(s); and combinations thereof.

Embodiment 20. The turf grass treatment composition of embodiment 1 wherein the at least one plant health component is a biostimulant.

Embodiment 21. The turf grass treatment composition of embodiment 20 wherein the at least one biostimulant is selected from the group consisting of plant hormones, microbes selected from bacteria, yeast, and fungi; humic substances, seaweed extracts, protein hydrolysates, chitosan, inorganic compounds, and metabolites.

Embodiment 22. The turf grass treatment composition of embodiment 20 wherein the at least one biostimulant is selected from the group consisting of humic substances, humins, fulvic acids, fatty acids/lipids, peptides, amino acids, organic acids, carboxyls, B vitamins, protein hydrolysates, plant growth promoting bacteria (PGPR), cytokinins, rhizobium, mycorrhizae, trichoderma, fungi, microbial complex communities/consortia, phytohormones, seaweed/kelp, laminarin, alginates, polysaccharides, polyphenols, botanicals, allelochemicals, organic matter extracts, chitin, chitosan, betaines, polyamines, inorganic salts, proteins, elements selected from silicon (Si), sodium (Na) and cobalt (Co), phosphites, nitrogeneous compounds, and enzymatic extracts.

Embodiment 23. The turf grass treatment composition of embodiment 21 wherein the yeast or fungi are selected from the group consisting of Aureobasidium (e.g., A. pullulans), Blakeslea, Candida (e.g., C. apicola, C. bombicola, C. nodaensis), Cryptococcus, Debaryomyces (e.g., D. hansenii), Entomophthora, Hanseniaspora, (e.g., H. uvarum), Hansenula, Issatchenkia, Kluyveromyces (e.g., K. phaffii), Mortierella, mycorrhizal fungi, Penicillium, Phycomyces, Pichia (e.g., P. anomala, P. guilliermondii, P. occidentalis, P. kudriavzevii), Pleurotus spp. (e.g., P. ostreatus), Pseudozyma (e.g., P. aphidis), Saccharomyces (e.g., S. boulardii sequela, S. cerevisiae, S. torula), Starmerella (e.g., S. bombicola), Torulopsis, Trichoderma (e.g., T. reesei, T. harzianum, T. hamatum, T. viride), Ustilago (e.g., U. maydis), Wickerhamomyces (e.g., W. anomalus), Williopsis (e.g., W. mrakii), and Zygosaccharomyces (e.g., Z. bailii).

Embodiment 24. The turf grass treatment composition of embodiment 21 wherein the bacteria are selected from the group consisting of Gram-positive and Gram-negative bacteria, rhizobacteria, Agrobacterium (e.g., A. radiobacter), Azotobacter (A. vinelandii, A. chroococcum), Azospirillum (e.g., A. brasiliensis), Bacillus (e.g., B. amyloliquifaciens, B. circulans, B. firmus, B. laterosporus, B. licheniformis, B. megaterium, Bacillus mucilaginosus, B. subtilis), Frateuria (e.g., F. aurantia), Microbacterium (e.g., M. laevaniformans), myxobacteria (e.g., Myxococcus xanthus, Stignatella aurantiaca, Sorangium cellulosum, Minicystis rosea), Pantoea (e.g., P. agglomerans), Pseudomonas (e.g., P. aeruginosa, P. chlororaphis subsp. aureofaciens (Kluyver), P. putida), Rhizobium spp., Rhodospirillum (e.g., R. rubrum), Sphingomonas (e.g., S. paucimobilis), and Thiobacillus thiooxidans (Acidothiobacillus thiooxidans).

Embodiment 25. The turf grass treatment composition of embodiment 1 wherein the at least one plant health component is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

Embodiment 26. The turf grass treatment composition of embodiment 1 wherein the weight ratio of the at least one biosurfactant to the at least one plant health component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 27. The turf grass treatment composition of embodiment 1 wherein the at least one synthetic surfactant is selected from the group consisting of anionic surfactants, nonionic surfactants, cationic surfactants, amphoteric or zwitterionic surfactants, and combinations thereof.

Embodiment 28. The turf grass treatment composition of embodiment 27 wherein the nonionic surfactant is selected from the group consisting of polyoxyethylene (POE) surfactants, block copolymer surfactants, straight block copolymer surfactants, reverse block copolymer surfactants, alkyl polyglucoside (APG) surfactants, modified methyl capped block copolymer surfactants, humic substance redistribution molecules, and multibranched regenerating wetting agents.

Embodiment 29. The turf grass treatment composition of embodiment 27 wherein the nonionic surfactant is selected from the group consisting of alkyl polyglucosides (APGs), fatty alcohol ethoxylates, alkyl phenol ethoxylates, fatty acid alkoxylates, and combinations thereof.

Embodiment 30. The turf grass treatment composition of embodiment 27 wherein the nonionic surfactant is selected from the group consisting of alcohol ethoxylates, alkanolamides, alkanolamine condensates, carboxylic acid esters, cetostearyl alcohol, cetyl alcohol, cocamide DEA, dodecyldimethylamine oxides, ethanolamides, ethoxylates of glycerol ester and glycol esters, ethylene oxide polymers, ethylene oxide-propylene oxide copolymers, glucoside alkyl ethers, glycerol alkyl ethers, glycerol esters, glycol alkyl ethers (e.g., polyoxyethylene glycol alkyl ethers, polyoxypropylene glycol alkyl ethers), glycol alkylphenol ethers (e.g., polyoxyethylene glycol alkylphenol ethers,), glycol esters, monolaurin, pentaethylene glycol monododecyl ethers, poloxamer, polyamines, polyglycerol polyricinoleate, polysorbate, polyoxyethylenated fatty acids, polyoxyethylenated mercaptans, polyoxyethylenated polyoxyproylene glycols, polyoxyethylene glycol sorbitan alkyl esters, polyethylene glycol-polypropylene glycol copolymers, polyoxyethylene glycol octylphenol ethers, polyvinyl pynolidones, sugar-based alkyl polyglycosides, sulfoanylamides, sorbitan fatty acid alcohol ethoxylates, sorbitan fatty acid ester ethoxylates, sorbitan fatty acid ester, and tertiary acetylenic glycols.

Embodiment 31. The turf grass treatment composition of embodiment 27 wherein the anionic surfactant is selected from the group consisting of alkyl carboxylates (e.g., sodium stearate), alkyl sulfates (e.g., alkyl lauryl sulfate, sodium lauryl sulfate), alkyl ether sulfates, alkyl amido ether sulfates, alkyl aryl polyether sulfates, alkyl aryl sulfates, alkyl aryl sulfonates, alkyl sulfonates, alkyl amide sulfonates, alkyl aryl sulfonates, alkyl benzene sulfonates, alkyl diphenyloxide sulfonate, alpha-olefin sulfonates, alkyl naphthalene sulfonates, paraffin sulfonates, alkyl sulfosuccinates, alkyl ether sulfosuccinates, alkylamide sulfosuccinates, alkyl sulfosuccinamates, alkyl sulfoacetates, alkyl phosphates, alkyl ether phosphates, acyl sarconsinates, acyl isethionates, N-acyl taurates, N-acyl-N-alkyltaurates, benzene sulfonates, cumene sulfonates, dioctyl sodium sulfosuccinate, ethoxylated sulfosuccinates, lignin sulfonates, linear alkylbenzene sulfonates, monoglyceride sulfates, perfluorobutanesulfonate, perfluorooctanesulfonate, phosphate ester, styrene acrylic polymers, toluene sulfonates, and xylene sulfonates.

Embodiment 32. The turf grass treatment composition of embodiment 27 wherein the cationic surfactant is selected from the group consisting of alkyltrimethylammonium salts (e.g., cetyl trimethylammonium bromide, cetyl trimethylammonium chloride), cetylpyridinium chloride, benzalkonium chloride, benzethonium chloride, 5-bromo-5-nitro-1,3-dioxane, dimethyldioctadecylammonium chloride, cetrimonium bromide, dioctadecyldimethylammonium bromide, and octenidine dihydrochloride.

Embodiment 33. The turf grass treatment composition of embodiment 27 wherein the amphoteric or zwitterionic surfactant is selected from the group consisting of 3 [(3-cholamidopropyl)dimethylammonio]-1-propanesulfonate, cocamidopropyl betaine, cocamidopropyl hydroxysultaine, phosphatidylserine, phosphatidylethanolamine, phosphatidylcholine, and sphingomyelins.

Embodiment 34. The turf grass treatment composition of embodiment 1 wherein the at least one synthetic surfactant is from a naturally-derived source.

Embodiment 35. The turf grass treatment composition of embodiment 1 wherein the at least one synthetic surfactant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the turf grass treatment composition.

Embodiment 36. The turf grass treatment composition of embodiment 1 wherein the weight ratio of the at least one biosurfactant to the at least one synthetic surfactant is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 37. The turf grass treatment composition of embodiment 1 wherein the weight ratio of the at least one plant health component to the at least one synthetic surfactant is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 38. The turf grass treatment composition of embodiment 1 further comprising at least one inert component.

Embodiment 39. The turf grass treatment composition of embodiment 38 wherein the at least one inert component comprises water.

Embodiment 40. The turf grass treatment composition of embodiment 38 wherein the at least one inert component is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the turf grass treatment composition.

Embodiment 41. The turf grass treatment composition of embodiment 38 wherein the weight ratio of the at least one biosurfactant to the at least one inert component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 42. The turf grass treatment composition of embodiment 38 wherein the weight ratio of the at least one synthetic surfactant to the at least one inert component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 43. The turf grass treatment composition of embodiment 38 wherein the weight ratio of the at least one plant health component to the at least one inert component is about 1:100, or about 1:90, or about 1:80, or about 1:70, or about 1:60, or about 1:50, or about 1:40, or about 1:30, or about 1:20, or about 1:10, or about 10:1, or about 20:1, or about 30:1, or about 40:1, or about 50:1, or about 60:1, or about 70:1, or about 80:1, or about 90:1, or about 100:1.

Embodiment 44. The turf grass treatment composition of embodiment 19 wherein the bioenzyme is selected from the group consisting of hydrolases, oxidoreductases, lyases, transferases, ligases, isomerases, and combinations thereof.

Embodiment 45. The turf grass treatment composition of embodiment 44 wherein a cofactor is associated with the bioenzyme.

Embodiment 46. The turf grass treatment composition of embodiment 45 wherein the cofactor is selected from the group consisting of prosthetic groups, coenzymes, metal ions, and combinations thereof.

Embodiment 47. The turf grass treatment of embodiment 1, which when applied to turf grass, or to roots of the turf grass, or to soil in which the turf grass grows, is effective for promoting or enhancing at least one of bioenzyme activity and bioenzyme production in the turf grass.

Embodiment 48. The turf grass treatment composition of embodiment 1 which, when applied to turf grass, or to roots of the turf grass, or to soil in which the turf grass grows, enhances quality of the turf grass by enhancing initial water uptake or wetting, rewetting and/or water retention over time of said turf grass.

Embodiment 49. The turf grass treatment composition of embodiment 1 which, when applied to turf grass, or to roots of the turf grass, or to soil in which the turf grass grows, enhances quality of the turf grass by enhancing surface tension reduction, increasing speed to wet, increasing water retention, and/or increasing time to dry between watering events.

Embodiment 50. The turf grass treatment composition of embodiment 1 which, when applied to turf grass, or to roots of the turf grass, or to soil in which the turf grass grows, enhances quality of the turf grass by enhancing root structure and growth, nutrient use efficiency, water use efficiency, stress tolerance, disease tolerance, and/or inducing systemic resistance.

Embodiment 51. The turf grass treatment composition of embodiment 1 which, when applied to turf grass, or to roots of the turf grass, or to soil in which the turf grass grows, enhances quality of the turf grass by enhancing strength of the turf grass roots by increasing root density, increasing root diameter, and/or increasing root depth.

Embodiment 52. The turf grass treatment composition of embodiment 1 which, when applied to turf grass, or to roots of the turf grass, or to soil in which the turf grass grows, enhances quality of the turf grass by increasing or enhancing photosynthesis; photochemical activity; root enzyme activity; root mass; stress tolerance due to the production of superoxide dismutase enzymes; cytokinin activity under drying conditions to stimulate cell division; leaf moisture; a-tocopherol (vitamin E) and ascorbic acid (vitamin C) antioxidants found in chloroplasts; chlorophyll content; root length; shoot growth; phosphorus uptake; salt tolerance; leaf tissue nitrogen (N), phosphorus (P), potassium (K) and iron (Fe); soil moisture; and/or microbiome.

Embodiment 53. The turf grass treatment composition of embodiment 1 which, when applied to turf grass, or to roots of the turf grass, or to soil in which the turf grass grows, enhances quality of the turf grass by making the nutrients far more recognizable to the turf grass; limiting temperature stress, drought stress, heavy metal stress, and low mowing heights; amino acid proline scavenges hydroxyl radicals by increasing superoxide dismutase (SOD); protein biosynthesis improvement; increasing chlorophyll content; increasing germination; stimulating carbon and nitrogen metabolism; and/or stimulating turf grass microbiomes.

Embodiment 54. The turf grass treatment composition of embodiment 1 which, when applied to turf grass, or to roots of the turf grass, or to soil in which the turf grass grows, enhances quality of the turf grass by increasing or enhancing leaf count, amino acid proline scavenges hydroxyl radicals by increasing superoxide dismutase (SOD); proline dehydrogenase production/stress adaption; chlorophyll content; germination; and/or vertical leaf growth.

Embodiment 55. The turf grass treatment composition of embodiment 1 which, when applied to turf grass, or to roots of the turf grass, or to soil in which the turf grass grows, enhances quality of the turf grass by strengthening cell walls by silica deposits; promoting turf grass growth; inducing tolerance to abiotic stress (drought, salinity, cold stress); inducing cell wall rigidification, osmoregulation, reducing transpiration; influencing osmotic, pH, and redox homeostasis; and/or influencing hormone signaling and enzymes involved in stress response.

Embodiment 56. The turf grass treatment composition of embodiment 1 which, when applied to turf grass, or to roots of the turf grass, or to soil in which the turf grass grows, enhances quality of the turf grass by providing defense against abiotic stress; leaf and stem strength through deposition in the cuticle; maintaining cell wall polysaccharide and lignin polymersproline; wear resistance; heat and drought stressed resistance; growth and establishment; water use efficiency; salt stress tolerance; leaf blade stiffness; and/or better ball roll.

Embodiment 57. The turf grass treatment composition of embodiment 1 which, when applied to turf grass, or to roots of the turf grass, or to soil in which the turf grass grows, enhances quality of the turf grass by increasing or enhancing uptake of macro- and micronutrients; root mass and surface area; cytokinin content; drought stress tolerance; arbuscule-forming mycorrhiza fungal may reduce Poa annua on golf greens; chlorophyll content; absorption of mineral elements such as phosphorus (P), iron (Fe), copper (Cu), magnesium (Mg), potassium (K), boron (B), silicon (Si), sulfur(S), and nitrogen (N); above ground biomass; water use efficiency; less irrigation in summer; and/or less artificial fertilizer for the same results.

Embodiment 58. The turf grass treatment composition of embodiment 1 which, when applied to turf grass, or to roots of the turf grass, or to soil in which the turf grass grows, enhances quality of the turf grass by enhancing health, growth and/or sturdiness of the turf grass.

Embodiment 59. The turf grass treatment composition of embodiment 1 which, when applied to turf grass, or to roots of the turf grass, or to soil in which the turf grass grows, enhances quality of the turf grass by enhancing turf grass color, turf grass shoot density, and/or turf grass greenness.

Embodiment 60. The turf grass treatment composition of embodiment 1 which is a synergistic turf grass treatment composition.

Embodiment 61. The turf grass treatment composition of embodiment 60 wherein the synergistic turf grass treatment composition comprising at least one biosurfactant, at least one plant health component, and at least one synthetic surfactant, produces, when applied to turf grass, or to roots of the turf grass, or to soil in which the turf grass grows, a combined turf grass quality effect, greater than the sum of the separate turf grass quality effects, at essentially the same concentrations.

Embodiment 62. The turf grass treatment composition of embodiment 60 wherein the synergistic turf grass treatment composition comprising at least one biosurfactant, at least one plant health component, and at least one synthetic surfactant, produces, when applied to turf grass, or to roots of the turf grass, or to soil in which the turf grass grows, a combined promoting or enhancing effect of at least one of bioenzyme activity and bioenzyme production in the turf grass, greater than the sum of the separate promoting or enhancing effects of at least one of bioenzyme activity and bioenzyme production in the turf grass, at essentially the same concentrations.

Embodiment 63. The turf grass treatment composition of embodiment 1 wherein the turf grass is selected from the group consisting of: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); zoysia grass (Zoysia spp.); Bahia grass (Paspalum notatum); carpet grass (Axonopus affinis); centipede grass (Eremochloa ophiuroides); kikuyu grass (Pennisetum clandesinum); seashore paspalum (Paspalum vaginatum); floratam (Stenotaphrum secundatum “Floratam”); blue gramma (Bouteloua gracilis); buffalo grass (Buchloe dactyloids); and/or sideoats gramma (Bouteloua curtipendula).

Embodiment 64. The turf grass treatment composition of embodiment 1 which is applied to turf grass using an irrigation system.

Embodiment 65. The turf grass treatment composition of embodiment 1 which is applied to turf grass using a manual spreader, said spreader comprising a broadcast spreader, a drop spreader, a handheld spreader, or a handheld sprayer.

Embodiment 66. The turf grass treatment composition of embodiment 1 wherein the turf grass is in the form of sod comprising turf grass and a layer of soil held together by the roots of the turf grass and forming a sheet.

Embodiment 67. The turf grass treatment composition of embodiment 1 wherein the composition is applied to a field or pitch planted with the turf grass.

Embodiment 68. The turf grass treatment composition of embodiment 67 wherein the field is used for athletics and/or recreation.

Embodiment 69. The turf grass treatment composition of embodiment 67 wherein the field is a park, campground, amphitheater, golf course, horse track, soccer field, football field, lacrosse field, field hockey field, cricket field, rugby field, polo field, softball field or baseball field.

Embodiment 70. The turf grass treatment composition of embodiment 1 which, when applied to turf grass, or to roots of the turf grass, or to soil in which the turf grass grows, helps prevent the occurrence of holes and/or divots in the field as a result of athletic or recreational use.

Embodiment 71. The turf grass treatment composition of embodiment 1 which, when applied to turf grass, or to roots of the turf grass, or to soil in which the turf grass grows, increases safety of participating in athletics or recreation on the field by preventing injuries caused by stepping in a hole and/or divot.

Embodiment 72. The turf grass treatment composition of embodiment 1 which is a microbe-based composition.

Embodiment 73. A turf grass treatment composition comprising at least one biosurfactant, at least one plant health component, at least one synthetic surfactant, and at least one inert component.

Embodiment 74. The turf grass treatment composition of embodiment 73 wherein the at least one plant health component is a biostimulant.

Embodiment 75. The turf grass treatment composition of embodiment 73 wherein the at least one biosurfactant is rhamnolipid, the at least one biostimulant is seaweed/kelp, the at least one synthetic surfactant is alkyl polyglucoside (APG), and at least one inert component is water.

Embodiment 76. The turf grass treatment composition of embodiment 73 which is a synergistic turf grass treatment composition.

Embodiment 77. The turf grass treatment composition of embodiment 76 wherein the synergistic turf grass treatment composition comprising at least one biosurfactant, at least one plant health component, and at least one synthetic surfactant, produces, when applied to turf grass, or to roots of the turf grass, or to soil in which the turf grass grows, a combined turf grass quality effect, greater than the sum of the separate turf grass quality effects, at essentially the same concentrations.

Embodiment 78. The turf grass treatment composition of embodiment 77 wherein the synergistic turf grass treatment composition comprising at least one biosurfactant, at least one plant health component, and at least one synthetic surfactant, produces, when applied to turf grass, or to roots of the turf grass, or to soil in which the turf grass grows, a combined promoting or enhancing effect of at least one of bioenzyme activity and bioenzyme production in the turf grass, greater than the sum of the separate promoting or enhancing effects of at least one of bioenzyme activity and bioenzyme production in the turf grass, at essentially the same concentrations.

Embodiment 79. The turf grass treatment composition of embodiment 1 which is applied to the turf grass, or to roots of the turf grass, or to soil in which the turf grass grows, at a treatment rate from about 0.5 oz./1000 sq. ft. monthly to about 12 oz./1000 sq. ft. monthly, or from about 1.0 oz./1000 sq. ft. monthly to about 10 oz./1000 sq. ft. monthly, or from about 2.0 oz./1000 sq. ft. monthly to about 8 oz./1000 sq. ft. monthly.

Embodiment 80. The turf grass treatment composition of embodiment 47 wherein promoting or enhancing at least one of bioenzyme activity and bioenzyme production in the turf grass is measured by high-performance liquid chromatography-mass spectrometry (HPLC-MS).

Embodiment 81. A method of promoting or enhancing quality of turf grass, said method comprising: applying to the turf grass, or to roots of the turf grass, or to soil in which the turf grass grows, a composition comprising at least one biosurfactant, at least one plant health component, and at least one synthetic surfactant; wherein the composition, when applied to turf grass, or to roots of the turf grass, or to soil in which the turf grass grows, is effective for promoting or enhancing quality of the turf grass.

Embodiment 82. The method of embodiment 81 wherein the composition is a synergistic turf grass treatment composition comprising at least one biosurfactant, at least one plant health component, and at least one synthetic surfactant, that produces, when applied to turf grass, or to roots of the turf grass, or to soil in which the turf grass grows, a combined turf grass quality effect, greater than the sum of the separate turf grass quality effects, at essentially the same concentrations.

Embodiment 83. The method of embodiment 81 wherein the composition, when applied to turf grass, or to roots of the turf grass, or to soil in which the turf grass grows, is effective for promoting or enhancing at least one of bioenzyme activity and bioenzyme production in the turf grass.

Ranges provided herein are understood to be shorthand for all of the values within the range. For example, a range of 1 to 20 is understood to include any number, combination of numbers, or sub-range from the group consisting of 1, 2, 3, 4, 5, 6, 7, 8, 9, 10, 11, 12, 13, 14, 15, 16, 17, 18, 19, 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of′ the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

While the present disclosure has been described with reference to one or more exemplary embodiments, it will be understood by those skilled in the art, that various changes can be made, and equivalents can be substituted for elements thereof without departing from the scope of the present disclosure. In addition, many modifications can be made to adapt a particular situation or material to the teachings of the present disclosure without departing from the scope thereof. Therefore, it is intended that the present disclosure will not be limited to the particular embodiments disclosed herein, but that the disclosure will include all aspects falling within the scope of a fair reading of appended claims.

The following examples are only to illustrate embodiments according to the disclosure. The disclosure is not limited thereto.

### EXAMPLES

### Evaluation of Efficacy of Formulations in Creeping Bentgrass Under Drought Stress

Applications rates were Zipline 8 oz/1000ft² and Astria 4 oz/1000ft², each monthly. Zipline is a commercially available turf grass treatment composition outside the scope of this disclosure. Zipline was used for comparative purposes. Astria is a turf grass treatment composition of this disclosure.

These experiments were conducted to evaluate the effects of formulations of this disclosure on turf quality and physiological fitness in creeping bentgrass under drought stress and post-drought recovery conditions.

Mature ‘A4’ creeping bentgrass plugs (4″ diameter) were harvested from field plots and transplanted into 6 inch pots filled with USGA sand mixed with 10% calcinated clay. The bentgrass was maintained at 15 mm tall and fertilized at 0.21b/1000ft² at transplanting and then 0.15 lb N/1000ft² biweekly after. After about four weeks of non-stressed growth with optimum temperature, water, fertilizer and light, the pots were placed in a controlled environment growth chamber at 22° C. day (12h)/18° C. night, light intensity at 400 μmol/m2s, 12h photoperiod, and 65% RH. The grass was watered daily to maintain adequate soil moisture level. 6 treatments, replicated 3 times, were tested. The treatment solutions from each formulation as listed below were applied to the canopy uniformly and the same amount of water was applied to the control.

Beginning at day 31 after initial application, the grass was subjected to drought stress treatment through deficit irrigation. Water was replaced 5 times weekly at 45-55% of measured evapotranspiration (ET) from day 31 through day 60. Beginning at day 61, the grass was well watered to allow post-drought recovery. The trial was completed at day 90. Measurements were taken at days 0, 14, 28, 42, 56, 70 and 90. The treatments were Astria (2.0 fl oz/1000 ft² every 14 days), Zipline (3.5 fl oz/1000 ft² every 14 days), and untreated (control).

### Turf Quality

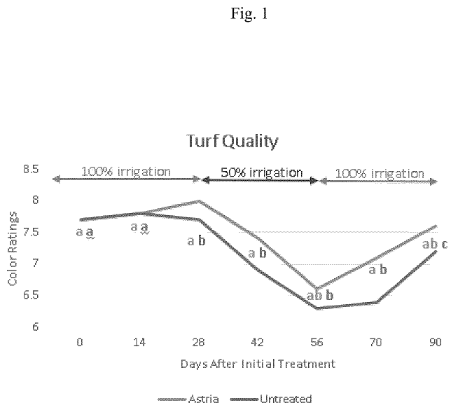

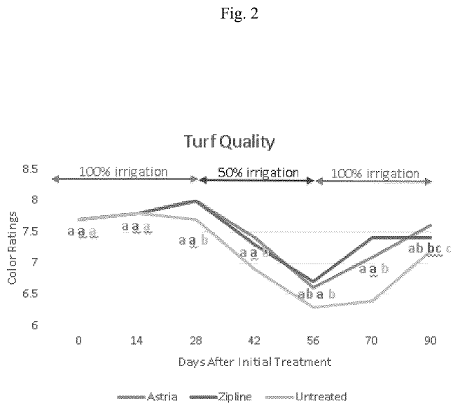

In FIGS. 1 and 2, turf quality was rated on a visual 1-9 scale, with 1 indicating complete senescence/brown color and 9 indicating the best quality. No consistent difference in turf quality was found among the formulations.

### Leaf Color

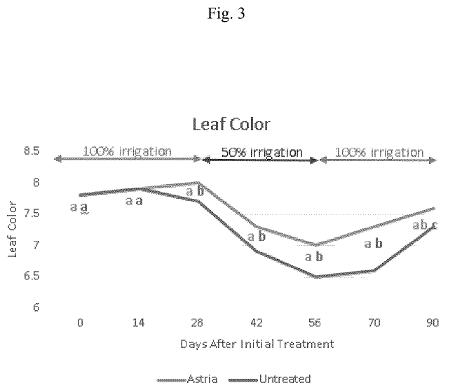

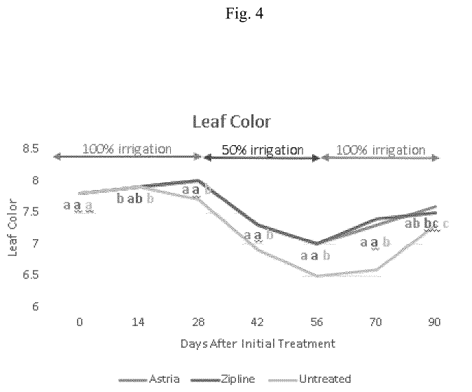

In FIGS. 3 and 4, leaf color was rated on a visual scale of 1 to 9 with 1 indicating brown color and 9 indicating dark green color. Astria tended to have better leaf color ratings relative to other treatments as measured at the end of the trial.

### Normalized Difference Vegetation Index (NDVI)

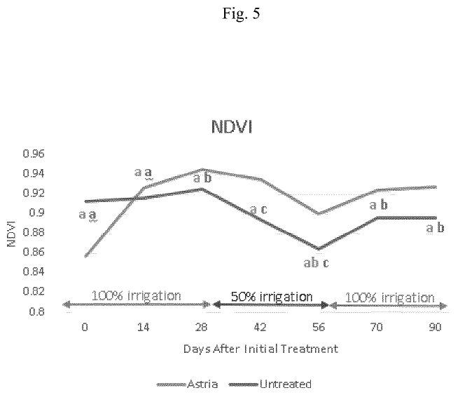

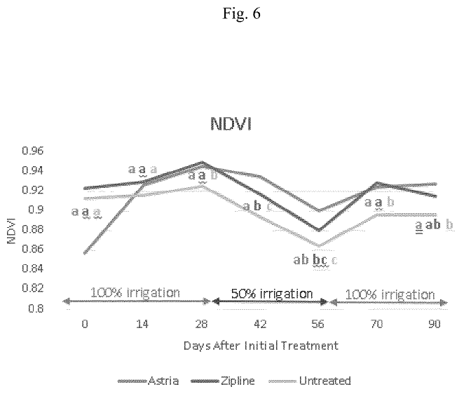

In FIGS. 5 and 6, NDVI was measured with Crop circle NDVI meter (Model ACS-430, Holland Scientific). About 40 readings were collected from each plot and the average was used for statistical analysis. All products increased NDVI when compared to the control as measured from day 28 through day 90, especially during mild drought stress period (day 42) and post-drought period. Astria increased NDVI relative to the control as measured at the end of the trial.

### SuperOxide Dismutase Activity (SOD)

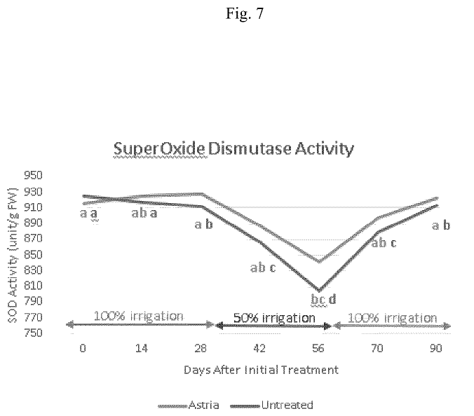

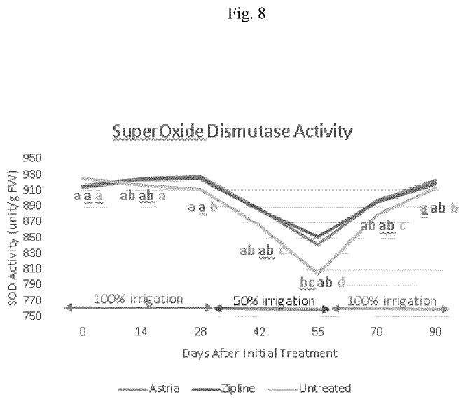

In FIGS. 7 and 8, leaf antioxidant SOD activity was determined. During the drought stress period all products enhanced SOD activity compared to the control.

### Volumetric Water Content (VWC)

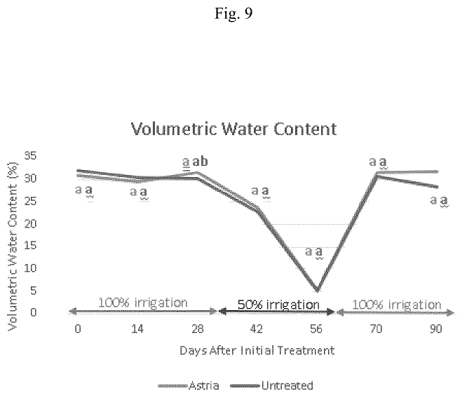

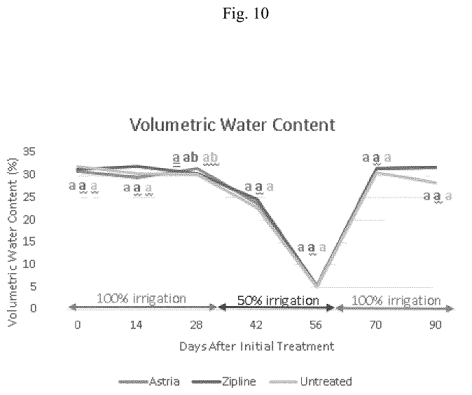

In FIGS. 9 and 10, soil moisture content was measured with a TRC-300 meter. Three readings were collected from each pot and the average was used for statistical analysis. No consistent difference in VWC was found among the treatments during the trial

### Leaf Abscisic Acid

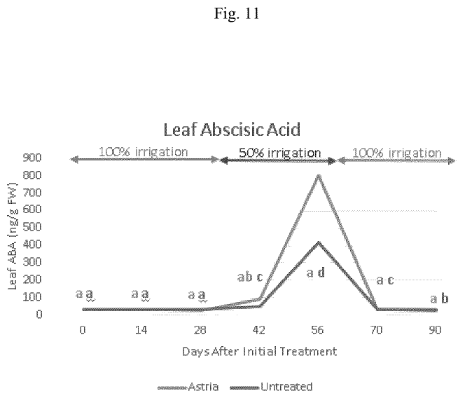

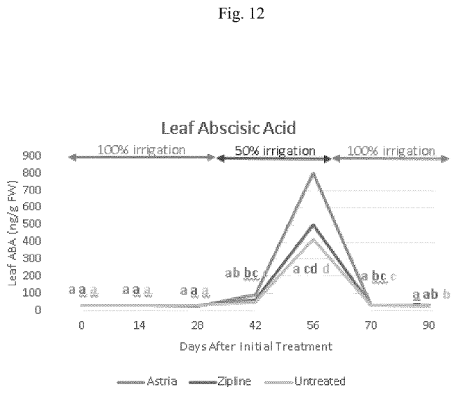

In FIGS. 11 and 12, leaf abscisic acid was extracted and determined by using LC-MS/MS with indole-3-acetic acid-C13 as an internal standard. During severe drought stress conditions, Astria had higher leaf ABA level relative to the untreated control. Leaf ABA is closely associated with plant drought tolerance due to its role in regulating stomatal closing/opening to survive drought stress.

### Leaf Cytokinin (Cis-Zeatin Riboside)

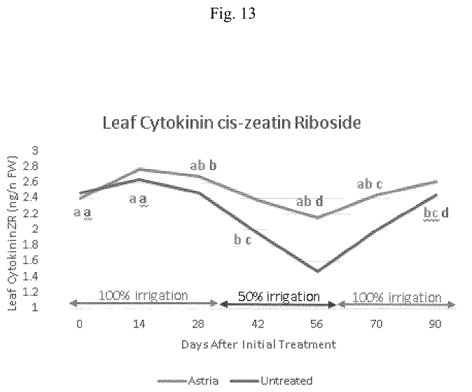

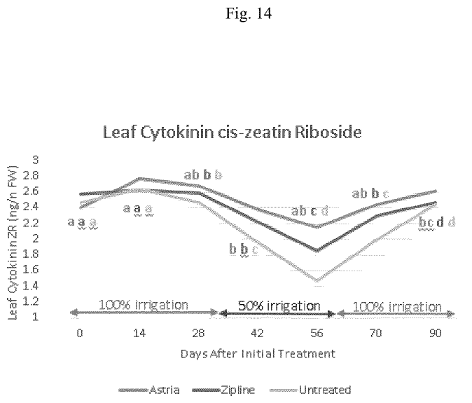

In FIGS. 13 and 14, leaf cytokinin was extracted and determined by using LC-MS/MS with indole-3-acetic acid-C13 as an internal standard. During severe drought stress conditions, Astria had greatest leaf cytokinin content relative to the control, therefore having greater effects on enhancing cytokinin content than Zipline. Cytokinin delays leaf senescence and protects photosynthetic apparatus. Astria can improve leaf cytokinin level and thus visual quality of creeping bentgrass under drought stress and post-drought recovery periods.

The present disclosure is not to be limited in scope by the specific embodiments described herein. Indeed, various modifications of the disclosure in addition to those described herein will become apparent to those skilled in the art from the foregoing description. Such modifications are intended to fall within the scope of the appended claims.

What is claimed is:

1. A turf grass treatment composition comprising at least one biosurfactant, at least one plant health component, and at least one synthetic surfactant; wherein the turf grass treatment composition, when applied to turf grass, or to roots of the turf grass, or to soil in which the turf grass grows, is effective for promoting or enhancing quality of the turf grass.

2. The turf grass treatment composition of claim 1 wherein the at least one biosurfactant is a growth byproduct of a microorganism.

3. The turf grass treatment composition of claim 1 wherein the at least one biosurfactant is selected from the group consisting of glycolipids, lipopeptides, phospholipids, fatty acids, and polymeric surfactants.

4. The turf grass treatment composition of claim 1 wherein the at least one biosurfactant is a glycolipid.

5. The turf grass treatment composition of claim 1 wherein the at least one biosurfactant is a glycolipid selected from the group consisting of rhamnolipid, sophorolipid, mannosylerythritol lipid, and trehalose lipid.

6. The turf grass treatment composition of claim 1 wherein the at least one biosurfactant is rhamnolipid.

7. The turf grass treatment composition of claim 1 wherein the at least one biosurfactant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

8. The turf grass treatment composition of claim 1 wherein the at least one plant health component is selected from the group consisting of a biostimulant, bioenzyme, nutrient(s) for microorganism growth, nutrient(s) for plant growth, fertilizer, pesticide, herbicide, other microorganism based composition(s); and combinations thereof.

9. The turf grass treatment composition of claim 1 wherein the at least one plant health component is a biostimulant.

10. The turf grass treatment composition of claim 9 wherein the at least one biostimulant is selected from the group consisting of humic substances, humins, fulvic acids, fatty acids/lipids, peptides, amino acids, organic acids, carboxyls, B vitamins, protein hydrolysates, plant growth promoting bacteria (PGPR), cytokinins, rhizobium, mycorrhizae, trichoderma, fungi, microbial complex communities/consortia, phytohormones, seaweed/kelp, laminarin, alginates, polysaccharides, polyphenols, botanicals, allelochemicals, organic matter extracts, chitin, chitosan, betaines, polyamines, inorganic salts, proteins, elements selected from silicon (Si), sodium (Na) and cobalt (Co), phosphites, nitrogeneous compounds, and enzymatic extracts.

11. The turf grass treatment composition of claim 10 wherein the at least one biostimulant is seaweed/kelp.

12. The turf grass treatment composition of claim 1 wherein the at least one plant health component is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

13. The turf grass treatment composition of claim 1 wherein the at least one synthetic surfactant is selected from the group consisting of anionic surfactants, nonionic surfactants, cationic surfactants, amphoteric or zwitterionic surfactants, and combinations thereof.

14. The turf grass treatment composition of claim 13 wherein the nonionic surfactant is selected from the group consisting of alkyl polyglucosides (APGs), fatty alcohol ethoxylates, alkyl phenol ethoxylates, fatty acid alkoxylates, and combinations thereof.

15. The turf grass treatment composition of claim 1 wherein the at least one synthetic surfactant is an alkyl polyglucosides (APGs).

16. The turf grass treatment composition of claim 1 wherein the at least one synthetic surfactant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the turf grass treatment composition.

17. The turf grass treatment composition of claim 1 further comprising at least one inert component.

18. The turf grass treatment composition of claim 17 wherein the at least one inert component comprises water.

19. The turf grass treatment of claim 1, which when applied to turf grass, or to roots of the turf grass, or to soil in which the turf grass grows, is effective for promoting or enhancing at least one of bioenzyme activity and bioenzyme production in the turf grass.

20. The turf grass treatment composition of claim 1 which, when applied to turf grass, or to roots of the turf grass, or to soil in which the turf grass grows, enhances quality of the turf grass by enhancing initial water uptake or wetting, rewetting and/or water retention over time of said turf grass, or
by enhancing surface tension reduction, increasing speed to wet, increasing water retention, and/or increasing time to dry between watering events, or
by enhancing root structure and growth, nutrient use efficiency, water use efficiency, stress tolerance, disease tolerance, and/or inducing systemic resistance, or
by enhancing strength of the turf grass roots by increasing root density, increasing root diameter, and/or increasing root depth, or
by increasing or enhancing photosynthesis; photochemical activity; root enzyme activity; root mass; stress tolerance due to the production of superoxide dismutase enzymes; cytokinin activity under drying conditions to stimulate cell division; leaf moisture; a-tocopherol (vitamin E) and ascorbic acid (vitamin C) antioxidants found in chloroplasts; chlorophyll content; root length; shoot growth; phosphorus uptake; salt tolerance; leaf tissue nitrogen (N), phosphorus (P), potassium (K) and iron (Fe); soil moisture; and/or microbiome, or by making the nutrients far more recognizable to the turf grass; limiting temperature stress, drought stress, heavy metal stress, and low mowing heights; amino acid proline scavenges hydroxyl radicals by increasing superoxide dismutase (SOD); protein biosynthesis improvement; increasing chlorophyll content; increasing germination; stimulating carbon and nitrogen metabolism; and/or stimulating turf grass microbiomes, or
by increasing or enhancing leaf count, amino acid proline scavenges hydroxyl radicals by increasing superoxide dismutase (SOD); proline dehydrogenase production/stress adaption;
chlorophyll content; germination; and/or vertical leaf growth, or
by strengthening cell walls by silica deposits; promoting turf grass growth; inducing tolerance to abiotic stress (drought, salinity, cold stress); inducing cell wall rigidification, osmoregulation, reducing transpiration; influencing osmotic, pH, and redox homeostasis; and/or influencing hormone signaling and enzymes involved in stress response, or
by providing defense against abiotic stress; leaf and stem strength through deposition in the cuticle;
maintaining cell wall polysaccharide and lignin polymersproline; wear resistance; heat and drought stressed resistance; growth and establishment; water use efficiency; salt stress tolerance; leaf blade stiffness; and/or better ball roll, or
by increasing or enhancing uptake of macro- and micronutrients; root mass and surface area;
cytokinin content; drought stress tolerance; arbuscule-forming mycorrhiza fungal may reduce Poa annua on golf greens; chlorophyll content; absorption of mineral elements such as phosphorus (P), iron (Fe), copper (Cu), magnesium (Mg), potassium (K), boron (B), silicon (Si), sulfur(S), and nitrogen (N); above ground biomass; water use efficiency; less irrigation in summer; and/or less artificial fertilizer for the same results, or
by enhancing health, growth and/or sturdiness of the turf grass, or
by enhancing turf grass color, turf grass shoot density, and/or turf grass greenness.
